(19) United States
(12) Patent Application Publication
(10) Pub. No.: US 2016/0365006 A1
(43) Pub. Date: Dec. 15, 2016

(54) Quantified Well-Being Evaluations, Improvement Programs and Scientific Wellness Video Games

(71) Applicant: Paul Ash Minturn, La Jolla, CA (US)

(72) Inventor: Paul Ash Minturn, La Jolla, CA (US)

(21) Appl. No.: 14/737,452

(22) Filed: Jun. 11, 2015

(51) Int. Cl. G09B 23/28; G09B 5/00; G06F 19/00

(52) U.S. Cl. CPC G09B 23/28; G06F 19/322; G06F 19/366; G06F 19/3431; G06F 19/3487; G09B 5/00

(57) ABSTRACT

This invention has three parts; Quantifiable Well Being Evaluations, Improvement Programs and Scientific Wellness Video Games. The new/novel embodiments go beyond optimal weight/ideal fitness levels and preventing health crises by continuously evaluating each individual towards special “Super Healthy Human Measurements” (15+ years without illness), correlating them to a series of “10” Point Scales. Quantifiable Well-Being/Scientific Wellness is an improved “Well-Being Paradigm” from the standard “2” point medical scale (“normal/abnormal”). Individuals achieve higher scores of personal “Well-Being” (8-10) with new follow-up interventions and self-educating video games, which dramatize realistic consequences for lifestyle choices, through virtual adventures. These videos are customized according to quantifiable evaluations based on their current measurements of the “10” Point Scales. This educates individuals on what choices will create the highest scores of Well-Being (happy, healthy, loving, successful, fulfilled, able to handle stressors, as they continuously follow their individual life purpose/mission).

### BRIEF SUMMARY OF THE NEW INNOVATIVE NOVEL NON-OBVIOUS IMPROVED INVENTION

### Objects of the Innovative Improved Scientific Wellness Quantifiable Well-Being Invention

Accordingly, it is an important object of the present novel innovative improved invention to provide a completely brand new, actuarially, mathematically, scientifically objective, improved, updated and adjusted data analysis that is based upon continuous ever increasing stringent well-being algorithms and scientific wellness research on living super-healthy humans (as defined herein), which is capable of quantifying, verifying and validating pre-determined specified advanced and more stringent optimal well-being rankings according to the invention's improved and advanced methods for assessing, measuring, evaluating, analyzing, interpreting, quantifying and frequent repeated tracking of small incremental documented changes in optimal measurable quantifiable well-being, super-health and complete wellness indicators, total fitness levels as well as risk-related medical conditions and risk factors (if any).

It is further an object of the present new innovative improved updated invention to provide a completely brand new, actuarially, mathematically, scientifically objective, improved, updated, quantifiably verified/validated and advanced method for assessing, measuring, evaluating, analyzing, interpreting, quantifying and repeated tracking of small incremental changes in personal well-being, and/or optimal wellness, as well as any major and minor health risks and deteriorating or debilitating changes in the human cardiovascular and/or immune systems.

It is also an object of the present novel invention to encourage and facilitate a maximum number of participants in making positive quantifiable improvements in their measured levels of optimal well-being, total wellness, personal health/fitness levels and through making consistent changes in life purpose/mission choices, outlooks and attitudes, basic core beliefs, nurturing/healthy/happy relationships, increased self-love, improved mental/emotional health and balance, healthier eating and drinking behaviors that are combined with frequent gentle fun non-stressful movement and exercise habits including other important improvements in one's lifestyle choices and behaviors.

It is an additional object of the present new objective innovative improved invention to provide a completely brand new, actuarially, mathematically, scientifically objective, improved, updated, quantifiably verified/validated and advanced method for assessing, measuring, evaluating, analyzing, interpreting, quantifying and repeated tracking of small incremental changes wherein the subject matter of the areas of assessment, evaluation and quantification are expanded to include measurements and evaluations of the most important attitudinal, life purpose/mission, spiritual, psychological, emotional, social, bio-physiological, immuno-virility, stress reduction, nutritional and laboratory wellness parameters utilizing many modern advanced high-tech data and information gathering devices, documents, smart phone apps, forms and sources of data collection and pertinent information collected through advanced self-administered bio-physiological measurements or those taken by trained and certified wellness/well-being technicians/professionals, objective laboratory blood and urine analyses, all of which are compared to scientifically weighted, quantified and validated wellness parameters, categories and data bases which measure, evaluate, compare, correlate, interpret, quantify and track up to approximately 40+ factors of quantifiable well-being, optimal wellness, super-health and/or total fitness in order to provide a more objective and comprehensive variety of valuable and reliable analytic information and data for informed lifestyle choices.

Another object of the present novel, improved and updated invention is to provide a new, objective, improved, quantifiable, validated and advanced method for assessing, measuring, evaluating, interpreting, quantifying and tracking small incremental changes in nutritional, dietary, eating and drinking habits that are actuarially cross-correlated to the bio-physiological and scientifically validated laboratory tests and measurements of quantifiable well-being, super-health, optimal scientific wellness, total fitness levels and optimum brain function.

A further object of the present novel, improved and updated invention is to provide a new, objective, improved, quantifiable, validated and advanced method for assessing, measuring, evaluating, interpreting, quantifying and tracking small incremental changes in physical exercise, gentle body movement, flexibility, other physical activities and fulfilling hobbies.

Still another object of the present invention is to provide a new, objective, improved, quantifiable, validated and advanced system and method for measuring, evaluating, interpreting, quantifying and tracking small incremental changes in the attitudinal, spiritual, psychological, physiological and biochemical effects of successfully reducing and managing life's stressors plus any changes in the sources, intensity levels and coping skills of the participant with regards to relaxation abilities, stress reduction or management skills and/or reducing high levels of extreme lifestyle and occupational pressures as well as life's uncontrollable distresses.

An extremely important and vital object of the present invention is to provide participants with valuable information in a new, objective, improved, quantifiable, validated and advanced way and method for measuring, evaluating, interpreting, quantifying and tracking small incremental changes in quantifiable well-being, optimal wellness and total health or fitness levels by means of cross-correlating the different expanded areas of investigative tests and measurements and the resulting information so that the participating individual can clearly understand the often unknown and undetected hidden risk factors that are caused by unhealthy eating and drinking habits, certain self-destructive behaviors, poor stress management skills and mental attitudes as well as one's core beliefs, and/or a highly sedentary lifestyle, the lack of an important life purpose and no regular consistent gentle cardiovascular exercises.

Another valuable object of this invention includes comparing and contrasting self-reported subjective information with objective data that has been collected by a certified wellness technician and scientifically verified lab analyzed data of body fluids. The knowledge and data that comes from these three types of individual assessments are mathematically and actuarially correlated inside a computerized quantifiable well-being and scientific wellness database in order to create a unique series of individualized detailed output reports and visually accented graphs with graduated ranking numerical scales based on 10-Point Quantifiable Well-Being and Scientific Wellness Scales and Factoring Formuli that also includes quantifiable evaluations, suggestions for improvement, recommendations and proven protocols for interventions, and risk reduction strategies for improving a person's scientific wellness rankings.

Thus this method includes scientifically accurate evaluative commentary and improvement suggestions and intervention protocols so the participant can be informed of and directed to specific causative categories that have been identified and taken into consideration as conditions outside of such categories but which have an actual impact upon the evaluative commentary and suggestions given to the participant. It is also an object of this invention to create a unique series of individualized detailed output reports and visually accented graphs with graduated ranking numerical scales based on actuarially, mathematically, scientifically objective, improved, updated and adjusted data analyzes that is used to continuously update the ever increasing stringent well-being algorithms and scientific wellness research over the past several decades on living super-healthy humans (as defined herein), in order to update and revise the unique 10-Point Quantifiable Well-Being and Scientific Wellness Scaling and Factoring Formuli including quantifiable evaluations, complete with suggestions for improvement, recommendations and protocols for interventions, and customized follow-up user friendly educational programs specifically created for each individual's quantifiable personal well-being needs and potentially achievable outcomes and benefits.

It is a further object of the present invention to provide a new, objective, improved, quantifiable, validated and advanced method for measuring, evaluating, interpreting, quantifying and tracking small incremental changes in quantifiable well-being, optimal wellness and total health or fitness levels by means of cross-correlating the different expanded areas of investigative tests and measurements and the resulting information so that the evaluative commentary and improvement suggestions and protocols to the participant are directed to specific causative categories that have been identified and taken into consideration as conditions outside of such categories but which have an actual impact upon the evaluative commentary and suggestions given to the participant.

Still another object of the present invention is aimed at assisting the participant to understand the purpose, meaning and importance of the unique Quantifiable Well-Being and Scientific Wellness Evaluation Procedures, the reasons for the comprehensive battery of tests and measurements that are utilized to determine individual levels of super-health, optimal wellness, achievable well-being and total fitness and the reasons for combining attitudinal, spiritual, emotional, psychological, bio-physiological and laboratory assessments of endocrine wellness for greater accuracy and objectivity in analyses, interpreting and tracking of both positive and negative small incremental changes in major wellness, well-being, super-health, total fitness and/or any potentially serious health risks.

Further included among the objects of the present invention is a method to provide objective, improved, quantifiably validated and advanced measuring, evaluating, interpreting, quantifying and tracking small incremental changes in optimal wellness, health and ideal fitness which includes a well-designed graphically pleasing persuasively presented personal report in a manner such that the participant need have no knowledge or appreciation of the sophisticated data gathering devices, methods, phone apps, forms, questionnaires, documents or sources of information and/or the computerized suggestions but need only be capable of understanding the meaning of the simple 10-Point Quantifiable Well-Being and Scientific Wellness Scales and the reading of simple, easy to comprehend, laymanlike non-medical language and figures, brought to the participant's attention in a graphic fashion which itself is designed and formulated to have a positive and persuasive effect upon the quantifiable improvement and ultimate dedication towards improvement and compliance of the participant.

It is a further object of the present invention to help each participant understand the meaning of pending and potentially serious health risks taking into consideration the correlations and relationships to one's personal life-style choices and consistent poor health habits and any negative behavior patterns which can ultimately lead to catastrophic morbidity or mortality. In this manner, the invention helps the participant realize that such avoidable risks can apply to the participant, which indicates by the commentary and improvement suggestions the relative importance of the measurements of quantifiable well-being and scientific wellness, including evaluations of poor health and lifestyle risks, thereby enabling the participant to be able to make wise and informed choices as to which chronic habits, unhealthy behaviors and risky habits to eliminate; which by commentary and improvement suggestions and protocols convey a sense of urgency to assist in motivating the individual to make positive and measurable improvement changes, and which provides a bench mark process for observing on-going positive incremental measurement of improved overall wellness and total well-being levels and observable reductions in major risk factors if certain poor and/or dangerous health attitudes, choices and bad habits are altered or eliminated.

An additional object of the present invention is designed to show a person that how one lives, believes and behaves often become determinant and causative factors leading to most of the debilitating or catastrophic diseases experienced by many dumb humans and/or how the person may die; which demonstrates through awareness concepts the importance of risk reduction/management and the ultimate effects and outcomes of risk-taking, showing that personal unhealthy habits and behavioral risks not only add to one's painful problems and stresses, but compound one another; which personalizes the information in the quantifiable well-being and scientific wellness methods for achieving and maintaining optimal health through consistent healthy lifestyle outlooks/habits and the reduction of any preventable risks.

A new and important object and feature of the present invention is a high-tech customized computer generated virtual reality program that is a unique optional follow-up improvement game oriented intervention application for PCs, tablets, smart phones and/or copied to a DVD format. This customized “Virtual Reality Scientifically Accurate Customized Fun Well-Being and Scientific Wellness Computerized Video (3D) Games, related to this category” allows a participant to become involved in a series of games that uniquely and graphically demonstrate to the participant the probable and/or guaranteed realistic outcomes and consequences of either “positive” self-improvement or “negative” self-destructive lifestyle choices specifically related to the empirical collected data and measurements taken by a certified wellness technician, plus the self-reported subjective information of the participant and the objective lab evaluations of body fluids and their associated “Validated Quantifiable Well-Being and Scientific Wellness Scales.”

It a further object of this invention to design the “Virtual Reality Games” in such a manner that they can help self-educate truly smart individuals as they play the games, by experimentation with the various intervention protocols to create new and improved ways to cope with life's many surprises and unprecedented challenges.

Additionally, another object of this invention is aimed at helping participants learn valuable information from the adventurous “Virtual Reality Games” by following the probable scenarios of alternatively choosing apparent positive and/or clearly negative choices in the game's adventures which can then lead to realistic probable outcomes and consequences plus many personal well-being and scientific wellness rewards. The beauty of the custom virtual reality self-educational games is that a person can explore realistic life experiences and dramas and their probable outcomes and consequences without any serious, painful or devastating personal well-being and/or scientific wellness damages. Over time, one can learn to improve their own personal well-being and scientific wellness scores to the point that they can share their successes with family, friends and business associates.

With these and other objects in view, the present new improved novel invention consists of the arrangement and combination of the various Quantifiable Well-Being and Scientific Wellness Tests and Measurements providing raw data which is inputted into a phone app, tablet device, PC or kiosk computer screen which when connected to the Internet can transmit said data to a processing computer which then assesses, evaluates, compares and contrasts the data to the quantified, correlated, validated and frequently updated and revised proprietary ideal wellness, total well-being, optimal health and fitness databases, resulting in an individualized output report which graphically indicates each rank and rating of comprehensive self-reported and/or certified wellness technician measured quantifiable well-being and optimal wellness levels on a series of up to 40 or more 10-Point Quantifiable Well-Being and Scientific Wellness Scales with simple graphics, appropriately ranked personalized evaluative comments and suggestions in laymanlike language and figures, brought to the participant's attention in a easily understood fashion which itself is designed and formulated to have an ever increasing positive and persuasive effect upon the ultimate compliance of the participant together with other aspects of the method, serving as an example only of one or more embodiments of the invention, whereby the objects contemplated are attained, as hereinafter disclosed in the specifications, and pointed out in the appended claims.

### Urgent Need for this Invention

### There Is A Critical Need For This New Innovative and Improved Invention and Method For Quantifying Optimal Well-Being Mathematically Against A New More Stringent Data Base of

### Super-Healthy People Exhibiting Over 15+ Years Without Any Illness Or Need For Any Medications That Have Been Evaluated Utilizing The Actuarially Designed Quantified Optimal Well-Being and Scientific Wellness Assessments, Questionnaires, Apps, Evaluations, Scales, Algorithms and Specialized Unique Customized Improvement and Intervention Protocols

This new novel non-obvious innovative improved invention may soon become the most reliable source or repository of Valuable Scientifically Accurate Personal Well-Being, Total Self-Care Information and Non-Political Resources for a guaranteed Sustainable Global Healthy Future and Ecological Balanced Environment for the smart super-healthy, fulfilled, functional and peak performing survivors of the human race. The innovative technologies of the present invention are a quantum paradigm shift from the disastrous limited conventional practices of diagnosis and treatment of diseases because the current technologies and procedures of traditional medicine primarily focus on the economics of identifying and treating symptoms with little or no attention given to the causative factors. All too often, the discovery or diagnosis of the symptoms comes long after serious preventable damage(s) to the human organism has occurred. We live in a modern age where technological advances could easily eliminate chronic, catastrophic diseases and premature deaths. However, just the opposite is happening around the world. Instead of the elimination of preventable illnesses, there is a rapidly escalating global increase in preventable cardiovascular diseases, diabetes, cancers, obesity, strokes, autism, untreatable super-bugs that keep mutating faster than new medicines can be invented, and many catastrophic/debilitating pandemics and health crises that are largely a result of unethical and criminal economic agendas, regardless of exciting high-tech sophisticated smart phone apps, technologically advanced scanners and one drop improved lab analyses of body fluids. Since the turn of the century, the need for natural organic toxic chemical and GMO free foods has dramatically increased creating larger chains of mega health food stores eager to profit from servicing the needs of the smarter individuals who are passionately dedicated to optimal health and fitness. During these same years, however, the number of idiots/dummies who consume fast, junk, processed, chemically preserved and taste enhanced foods has grown at even a faster rate. There has been an even greater astronomical increase in the global masses of people who are blindly consuming GMO and toxic chemically laced eats and drinks, regardless of any future health risks. These are the billions of people who ignorantly depend entirely on the illness industry to replace their worn out body parts with organ transplants or computer 3D printed plastic parts, just like one replaces worn out parts on our computers, vehicles, appliances and airplanes. Consequently, the modern news media has a never ending lucrative source of tragic, dramatic and tear jerking stories related to the expanding global health crises. The typical narrow and limited approach in modern medicine is not prevention based or proactive and may be likened to flying an aircraft or driving land vehicles without any lubricating oil in the engine long after the warning lights or gauges on the dash board have indicated a serious problem that needs immediate attention.

In sharp contrast, the new innovative paradigm of the present invention and its methods instead focus on early identification of causative factors as well as on achieving and maintaining measureable optimal human wellness and quantifiable total well-being. This new novel unique and advanced invention also takes advantage of new technological advances in one drop lab analyses of body fluids and the many new devices that can assist the smart proactive fitness oriented people with smart watches, sophisticated phones, tablets, PCs and computerized Apps that provide valuable information without needing to book an appointment with a health professional or conventional doctor or visit a lab for a prescribed medical test. Instead of focusing entirely on preventing or even early-detection of major risks or poor health conditions leading to debilitating or catastrophic diseases, this new innovative paradigm of the present invention assists individuals in being able to go way beyond just “average ordinary health and functionality.” This invention's method and applications of simply, empirically, scientifically and objectively quantifying important basic health, well-being and scientific wellness parameters is based on assessing, correlating and comparing certain empirical measurements, subjective information and scientifically objective lab analyzes to quantify a person's present level of optimal well-being and scientific wellness and any potential risk factors. The measurements, assessments and lab analyzes comprise a variety of accurate data gathering methods, including: bio-physiological pulses, BMI, standard blood pressures, circulation cardio-efficiency and environmental pulmonary wellness measurements with objective customized assessments of life purposes and missions, personal outlooks and core beliefs, lifestyle attitudes and habits, spiritual values, nutritional eating and drinking habits, movement and physical exercise behaviors, relationship wellness dynamics and then contrasting such data to vital scientific and quantifiable accurate laboratory evaluations of immuno-vitality, urine, endocrine health, important blood lipids, sugars (glucose), hormones, and other biological and physio-chemistries as needed on an even more stringent definition criteria of a “super-healthy individual” (as set forth herein) that was never available in the past. This invention is routinely capable of providing any participant with vital optimal well-being and valuable prevention information of deteriorating hidden health conditions through a series of more stringent 10-Point Quantifiable Well-Being and Scientific Wellness Scaling and Factoring Formuli that was not available or known heretofore long before a crisis situation exists.

The data generated by this invention is invaluable to the rapidly growing number of smart people who are sick and tired of the limited self-serving inhumane disease oriented economic agendas, mind-sets and limited paradigms of the standard traditional illness industries. This new invention also provides alternative answers, options and realistic solutions to the billions of dummies that currently rely only upon the poorly trained health professionals who are solely focused on diagnosing and treating symptoms, without considering the causative factors or the inevitable consequences of unhealthy lifestyle choices, such as: pigging out on convenient fast, junk, highly processed or GMO foods and drinks laced with numerous toxic chemicals, preservatives, MSG, pesticides, dangerous artificial sweeteners, disease or cancer causing hormones, and other substances that are known to be carcinogenic or illness causing ingredients. Many proactive optimal health and fitness minded intelligent individuals that are dedicated to the current challenge of achieving and maintaining the high-levels of peak physical and mental performance through self-health and well-being technologies will welcome, study, utilize and celebrate this new well-researched, validated and documented advancements in the computer generated follow-up improvement programs and intervention protocols that are inherent in the quantifiable well-being, scientific total wellness, optimal health and ideal fitness methods. In addition, the invention also contains advanced major risk factor warnings, quantification, interpretation, early detection, correlation and tracking methods complete with output reports, and follow-up customized “Take Charge of Your Own Well-Being Programs” as well as the user friendly summaries of present and impending hidden conditions and any health risk factors that normally go undetected until one suffers a serious disease or even worse a catastrophic meltdown or death. These new unique computer driven technologies take full advantage of recent progressive technologies and advancements that can mathematically determine and actuarially validate objective human total well-being and health measurements with graduated ranking numerical scales based on the 10-Point Quantifiable Well-Being and Scientific Wellness Scaling and Factoring Formuli.

In stark contrast unique “10-Point Scales” of this invention, the illness industries are limited to only 2-Point Evaluation Scales (“Normal” or “Abnormal”).
NOTE: “Normal” is a useful cycle on a washing machine, but only indicates “average to poor health” in a human being, which can be quite limiting and not very exciting.

The present invention has no such ambiguous limitations, due to the broad range of specified rankings in its 10-Point Scales. An integral part of this new innovative invention includes user friendly data gathering smart phones, tablets, kiosk computerized Apps, plus convenient Internet access to valuable and unique Innovative Novel Non-Obvious Improved Quantifiable Well-Being and Scientific Wellness Information and Special Customized Improvement Intervention Protocols, computerized forms, high-tech measurements and tracking devices, documents, resources and questionnaires that are divided into different categories of total well-being, scientific wellness, optimal health, complete ideal human fitness and preventable risk factors which affect participants arranged so that the data gathered is ranked in an easy to understand graduated numerical scores with specified rankings in the 10-Point Scales. The invention's computerized analyzes. quantifications, interpretations, correlations, rankings, trackings and appropriate improvement intervention programs are presented for computer smart phones and touch screen Apps or on printed forms for the respective categories in a manner comparing total quantifiable well-being, ideal scientific wellness and ultra-low-risk conditions against empirical bio-physiological assessment tests and measurements taken by well trained and certified wellness technicians, plus actual subjective self-reported conditions of the individual combined with the objective scientific evaluations by a lab. The evaluations, assessments and measurements are graduated and correlated to the scores on the 10-Point Quantifiable Well-Being and Scientific Wellness Scales selected from a data bank according to the scores. Each of the customized improvement programs, intervention protocols and output reports, follow-up improvement programs are computerized and color-accented with numerically comparative graphics showing how the total well-being, optimal health, scientific wellness and comprehensive fitness and risk ratings of the participant compares to the respective categories of optimal wellness and total well-being ratings and ranking levels portrayed respectively at levels identified as: Excellent (9 and 10), Good (7 and 8), Average (4 through 6), Poor (2 and 3), or Dangerous (0 and 1). Additionally, the present invention also includes proven cost containment and risk reduction strategies that make it possible to finally manage worker health-care costs in a proactive way for those smart and/or self-insured entities who can appreciate the usefulness, intrinsic value and economic benefits of the scientifically actuarially cross-correlated and weighted scores on each of the 10-Point Quantifiable Well-Being and Scientific Wellness Measurement Scales and Mathematically Validated Categories.

A recent new and exciting high-tech feature that is an integrated part of the follow-up improvement programs and intervention protocol strategies of the present invention is the inclusion of customized “Virtual Reality Scientifically Accurate Customized Fun Well-Being and Scientific Wellness Computerized Video (even 3D) Games” allow participants to become involved in a series of virtual reality games that uniquely and graphically demonstrate to the viewing participant the probable and/or guaranteed realistic outcomes and the consequences of either self-improvement or self-destructive lifestyle choices specifically related to their assessments, measurements or lab analyzed evaluations. By taking full advantage of the measuring and improvement programs of this invention and the customized information provided through the “Validated Quantifiable Well-Being and Scientific Wellness Scales” a truly smart individual can self-educate themselves by experimentation utilizing the various improvement programs and intervention protocols to create new and improved ways to cope with life's many surprises and unprecedented challenges.

Additionally, participants can learn from the new, exciting adventurous discoveries inherent in the “Virtual Reality Scientifically Accurate Customized Fun Well-Being and Scientific Wellness Computerized Video (3D) Games” that are a key embodiment of this invention. By following the probable scenarios of alternatively choosing “positive” options and/or clearly “negative” choices in the game's adventures and dramas, the participant can safely explore their own future realistic probable outcomes and consequences. Taking full advantage of this high-tech self-educational system that has been researched, designed and developed by scientifically trained well-being/wellness and longevity experts will ultimately result in many exciting personal well-being and scientific wellness rewards. The intrinsic beauty of the virtual reality experiences create enjoyable, fun as well as some potentially scary self-educational games that let a person safely explore realistic life experiences and dramas and their probable outcomes and consequences without any serious or devastating personal well-being and/or scientific wellness damages. Over time, a participant can learn how to improve their own personal optimal well-being levels and scientific wellness scores to the point that they can share their successes with family, friends and business associates.

### Definitions of Terms Embodied in this Invention

NOTE: A special glossary and definition of terms and criteria for identifying super-healthy individuals as used in this application is included herewith in order to fully explain the unique and specialized meanings of both the new as well as some of the terms that are used with different meanings from their common general usage in the health industry for this application and invention. These specialized uses and meanings of these terms are incorporated as an integral part of the “Specifications” and “Claims” for this new advanced technology and art. For any person with ordinary skills in the art, the present invention uses special specific terms and language as defined in this glossary which are set forth herein and which are included in the preferred specifications, associated definitions, embodiments and claims. It nevertheless should be understood, by anyone with experience and expertise in the art, that no limitation of the scope of the invention is hereby intended.

### Glossary and Definition of Terms in This Application

### Custom Definition of Super-Healthy Human Beings That Are Illness Free For Over 15+ Years

### Definition and Descriptions of Measured, Evaluated and Quantified Super-Healthy Humans

### Alive Super-Healthy Models of Quantification of Optimal Wellness/Well-Being Scores of 8s-10s

One of the most key, restrictive, important and distinctive features of the present invention is its unique and proprietary group of measured, tested, quantified, evaluated, assessed and correlated “super-healthy people” as defined herein. This slowly growing group of unusually “well” individuals (due to the extremely stringent quantifiable and validated well-being and scientific wellness requirements) enables the organizers and scientific researchers managing the “quantifiable well-being and scientific wellness database” (closely associated with this novel invention) to update and improve the ratings and rankings of the integrated categories that scientifically allows participants to take the guess work out of achieving and maintaining optimal well-being and scientific wellness. The strict criteria that quantifies any “super-healthy human” is foundational to the restrictive and definitive criteria that clearly identifies and sets apart (from the average functional people) certain individuals as “measured and quantified super-healthy humans.” These evaluated optimally healthy people have made significant contributions to the proprietary quantifiable well-being and scientific wellness measurement data base for the highest ranges of “Optimal Wellness and Total Well-Being Scores of 8s, 9s and 10s” as set forth herein that is embodied in this new unique invention. The minimal criteria that set these “super-healthy people” apart from the average functional addictive masses included the assessment and quantification of their life-style choices, bio-physiological parameters and a full battery of important lab measurements as significant examples of “super-healthy humans.” The following extremely stringent criteria was used to define and identify qualified numerous individuals (many thousands) as measureable models and examples of “super-healthy individuals.” This measured criteria included the following documented and verifiable ideal scientific wellness and quantifiable well-being attributes: consistently vibrant, loving, positive, happy and fulfilled super-healthy, self-healing humans who have verified at least 15 to 20 years of making consistent optimal lifestyle choices plus a clean super-healthy personal medical history without ever experiencing any minor or major illnesses and/or diseases including no serious or chronic pains or symptoms. This means that all of the select “super-healthy individuals” never experienced even a common cold or flu; and never ingested or were injected (by a health professional and/or self-injected) with any modern medications or shots, prescription or illegal drugs, and who have not been seriously exposed to any toxic substances, environmental chemicals or disease causing (carcinogenic) residues from private or commercial exterminator treatment(s) of any unwanted pests, bugs (including termites), etc. Also, these qualified individuals never consumed any foods laced with preservatives, GMOs, artificial sweeteners, hormones, pesticides, fertilizers, or toxic harvest enhancing chemicals. During these 15 to 20 years of optimal healthy life-style choices, these model “super-healthy people” also did not take or use any OTC or RX medicines; and, they only had minimal or zero use of any natural nontoxic herbs, meds, no digestive aides or med treatments, and they experienced no loss of vitality or compromised health even when exposed to deadly pathogenic super-bugs! The stringent criteria which identifies anyone as belonging to this mathematically defined set or group of “super-healthy individuals” generally eliminates over 96% of functional people. In the past, a “Super-Healthy Human Being” was identified mathematically and actuarially and defined as any individual who consistently over ten years of time measured “8s,” “9s” or “10s” on 90% of the original patented Scientific Wellness Scales (see U.S. Pat. No. 5,692,501). However, now the criteria for this novel invention is even more important to note since the new and improved present invention has extended the disease and symptom free time period to over 15 years as the minimal criteria for identifying and defining the selective research group of “super-healthy humans” that is embodied in this new unique invention.

### Specialized And New Terms and Meanings Used in This Invention

Accurate—refers to verified and validated data, information, measurements, tests, evaluations, questionnaires, or anything else that is important for comparisons or cross-correlations.

Actuarially—refers to a stringent mathematical analysis of extremely large amounts of data or information that achieves high statistical probabilities

Adrenal Well-Being—Balanced optimal functioning of the adrenal system which will maintain a joyful stress response; including a perfectly rebalanced heart rate, blood pressure, food assimilation, mineral levels, and helps create healthy stress responses and reactions.

Aflatoxin—Common food mold present in most processed starchy foods such as breads, pastas and cereals; this is a deadly neurotoxin which causes neurodegenerative disease processes; major contributor to autism, ADD, ADHD, and all other neurotransmitter imbalances. Note: It is not found in Mexican baked goods that are not wrapped in plastic.

Air pollution—causes headaches, fatigue, respiratory illness, cardiovascular disease, and inflammatory disease processes.

Algorithms—refers to specialized mathematical formulas utilized to quantify, analyze or correlate corresponding groups or sets of data and/or information.

Ammonia—Is a product resulting from metabolism of dietary proteins. High levels in the bloodstream, in a patient who does not work with pesticides or fertilizer, indicates a positive CBS/BHMT genetic defect causing a transulfuration problem (meaning excess sulfate or sulfites).This sets you up for neurological. psychological, and cardiovascular disease states. Sulfites and sulfur are neurotoxic.

Apps—refers to any application or special program designed and programmed to be used on a smart phone, tablet, PC or other computer device.

Application—refers to a series of simple steps, applications, procedures and/or protocols that can be utilized by a person with ordinary skills in the art to implement the innovative and novel restrictive preferred embodiments of this invention in measuring, quantifying, evaluating the preferred levels of optimal well-being mathematically utilizing actuarially based scientific wellness evaluations.

Arsenic—Common soil contaminate, significant amounts of this toxic metal are found in all forms of rice throughout the world.

Aspartame (now neotame) as the patent ran out on aspartame and another chemical was added, making it sweeter and more toxic. This is owned by Monsanto. The lawyer, Michael Taylor, who works for Monsanto was appointed to FDA by Pres Obama and he decided this does not have to be on any food labels. Thus it is put in A LOT of prepared foods (more everyday) as well as can be hidden even in CERTIFIED ORGANIC foods. It is also in animal flesh we are fed—indirectly—as the animals are fed an even more toxic form of this; named “sweetos.” This is put into the rancid feed that the animals would normally reject, to disguise the taste of the rotten food they are fed. These are very neurotoxic and immunotoxic elements as they develop substances in the body that turn into formaldehyde and damage the nerves. Note—since 1940 the level of neurotoxins in our food supply has doubled EACH year.

Assessments—refers to any type of evaluation instrument, questionnaire, measurement, tests, analysis or assessing of available information.

Autism—mental syndrome that often presents with symptoms of introversion, behaviors called “stims”, among other behaviors.

Autoimmunity—Condition where self-antigens are perceived as foreign cells and are attacked, resulting in inflammation and destruction of tissues.

Balanced organic vs lab produced foods/drugs and medicines—Ability of the body to recognize the difference from the toxic lab produced foods, drugs and medicines, vs proper assimilation of the natural herb, or food product, at a cellular level.

BHMT—Betaine Homocysteine Methyl Transferase. A methyl cycle pathway, serves as a “backdoor” pathway to pull homocysteine away from the CBS sulfate drain.

Bio-Available—refers to the biological availability of a substance, particle or organism that is not attached, bonded or controlled by any other agent, organism or substance in an ecological balanced super-healthy environment.

Bio-Energetics—Pertaining to all energy fields and dynamic functions of healing as they relate to all systems and pathways of the energy bodies (non-physical manifestation). Includes transformation and interaction of energies internal or external to the living body and it's processes. Any type of electrical, electromagnetic, or subtle energetic forces which are generated by living organisms.

Bio-energetic electronics—Life force/energies and variances in and around electronics or technical equipment and tools, which effect the subtle energies of one's functionality. i.e, electro magnetic field. Any type of electrical, electromagnetic or subtle energy forces which are generated by electronics.

Bio-Physical—Aspect of life force (as manifested in physical structure), pertaining to a fitness oriented lifestyle. Bio-physical means any biological fitness parameters that can be or are integrative and interconnected with any correlations to optimal health and wellness

Bio-physical ecological health—One's level of fitness in relation to the immediate environment. One's physically manifested life force energy as it relates and connects to natural forces and the immediate environment.

Bio-Physiological—Life processes and systems as they appear in their divinely ordered (and orchestrated) physical states, pertaining to constant movement of internal and external processes to maintain equilibrium of the natural and original state.

Bio-physiological ecology—Can be defined as optimal healthy functioning factors and peak performance in all measurable total parameters of the human being such as: biological, physiological, psychological, mental, emotional, intellectual, spiritual, social, intimate and friendship relationships, with heart connections to others.

Bio-psychological well-being—Wholeness as evidenced by how one lives their life. “Well-being” as evidenced by desire to live one's divine “purpose” on earth. The bio-psychological level of achievable wellness, via thru thought, then manifested as behaviors.

Biological and Physio-Chemistry—refers to a combination of biological and physiological processes within the human organism.

Body Fat Composition—refers to Body Fat Composition which is a calculation of the percentage of body fat compared to body muscle or mass ratio similar to Body Mass Index (BMI) which is also expressed as a ratio.

BMI—refers to Body Mass Index which is a calculation of the percentage of body fat compared to body muscle or mass ratio similar to Body Fat Composition which is also expressed as a ratio.

Carcinogens—environmental toxics which lead to cancerous conditions in humans and lab animals.

Carcinogenic substances—Common environmental toxins. Example: BHA, BHT as food preservatives.

CBS genetic defect—Over 90% of those people with chronic or untreatable conditions have the CBS(Crystathione Beta Synthase) type genetic defect, which means that homocysteine and methylcycle precursors are pulled down the CBS drain, producing toxic levels of sulfate, glutamate and ammonia. In addition, these genetically defenseless people have an overabundance of heavy metals and toxins that they cannot clear, and they have built up faster than usual, so we now see “older people's degenerative diseases” in the young, such as fibromyalgia, chronic fatigue, coronary artery disease, cardiomyopathy, Parkinson's, and dementia, and of course it can go the other way as we also see adult onset autism Mercury in the gut creates brain damage, as the gut produces most of the neurotransmitters that we need for proper brain functioning. The gut is always partially blocked with the CBS defect, so elimination must always be a priority. Glutamate/gaba balance is the goal and strict dietary limitations and supplements must be used. There is a deficiency in the calming amino acid, gaba (Gamma-Aminobutyric Acid) which functions as a neurotransmitter in the human brain). The strict dietary protocol is observed so that the sulfate stores in tissues will be released, and glutamate, ammonia levels will be decreased down to a normal level.

Chemtrails—highly toxic chemicals which are hormone disrupters and immune system disruptors, and they decrease brain function. Aluminum is one of the biggest ones used.

Chronic Disease States—These involve methylation, therefore, they cannot detoxify pesticides, hydrocarbon pollutants, medications, smoke, environmental pollutants in general, even emotional stresses, certain foods, all other stressors, including lack of “proper” exercise, and anything else that would imbalance the natural glutamate/gaba balance.

Commitment to Self-Worth—An intense dedication to high self-esteem with a strong commitment to achieving self-love for one's divine life purpose in all areas of one's attitudes, core beliefs, outlooks, personality, emphasizing preservation, growth and protection of one's self as the divine vehicle.

Common Environmental Toxins—There are greater than 3,000 substances added to foods for preservation coloring, texture, and flavor that are legal but have not been tested for use in combinations or for safety in the long term. Even the way things are processed are vital; as many are using deadly poisons, such as, formaldehyde or chlorine to disinfect equipment that food goes thru. Other toxins are present in our pollution, water, soil, cleaning supplies, fabrics, cosmetics, personal care products, canned goods, food containers (especially plastics),cookware, dishwashers, laundry machines, carpets, air conditioning, central heat, adhesives, sportswear, furniture, lubricants, dental fillings, industrial toxicants, power lines, electro and magnetic fields, cell phones, hazardous waste, nanomaterials, heavy metals, dental fillings, radon, pesticides, even infant formula, baby foods, toys, and child car seats. Basically anything manmade is suspect, even those labeled as certified organic.

Connection to source and management of life purpose and fusion with one's mission=The ability to experience connection/management/fusion as manifested by one primary intense desire (above all other needs) to be of divine service, for the greatest good; i.e., to give one's life up to divine purpose, making use of one's inherent gifts, to that end.

Constipation—Any difficulty with elimination or low frequency (less than once after every meal), or feeling of incomplete emptying of bowel contents. Commonly occurs chronically in the autistic and those with neurotransmitter/dysbiosis diseases, and CBS/BHMT genetic defects. Many of these cases are not able to tolerate milk products, even after control of constipation has been achieved. This is due to pathogens (parasites in milk products).

Conventional Practices—refers to common, conformist, wide spread or generally conservative or orthodox practices, habits or procedures.

Critical—refers to an urgent crisis or desperate need for change that may be time sensitive.

Cross-Correlated Actuarially and Integrated Scales—Means double correlations between related categories and then re-calibration of all mathematically and systematically designed internal and external scales for the purpose of the highest and most accurate quantification and measurements attainable. This assures accuracy and highest percentage of management and “re-learning” of behaviors necessary for optimal well-being.

Detox Competency—Proficient ability of the human physiological bodily systems to detoxify through all necessary methylation pathways for proper functioning of the entire organism.

Detoxification—Process to remove toxins, heavy metals, organic materials and any other undesirable substances.

Dis-eases—A frequently used term for illness. It implies that sickness is the result of the individual being at “ill ease” with some aspect of his or her higher consciousness.

Disastrous—refers to tragic, terrible, dreadful, ruinous, catastrophic outcomes and conditions due to global toxic, inhumane and non-sustainable practices, policies and procedures.

DNA Disruptors—These toxins(scramble the chromosomes of the grandchildren, in lab mice!) and cause genetic defects in humans, for future generations as well. These are one of the biggest factors for the rising rates in autism, cancers, decreased brain function, autoimmune diseases, chronic inflammation, sterility, behavior problems and all chronic disease states.

Dysbiosis—A prevalent condition of unbalanced bowel flora, (see leaky gut), chronic inflammation, toxins, immune diseases and neurotransmitter diseases (such as autism). Multiple causes include use of antibiotics (destroys good bacteria), poor diet and exposure to common environmental toxins/pollutants and pathogens (i.e.: parasites). Method of transmission is most commonly thru swallowing of pathogens (in air, foods or other methods of oral or topical ingestion) Pathogens adhere to toxins, metals, chemicals, and other foreign substances.

Ecological Balanced Environment—refers to any environment (such as inside the healthy human body) that remains natural and maintains nature's balances of organisms and life forms (including microorganisms).

Electro Magnetic Field Poisoning—is a common environmental pollutant; thru computers, cell phones and smart meters. Causes negative behaviors, neurotransmitter dysfunction, cancers and other chronic disease.

Emotional well-being—can be defined as the ability of the souls awareness for potential opportunities in one's immediate natural environment for support of one's life purpose and mission, as can be observed by behaviors of calm, loving emotional centeredness, regardless of continuing changes in circumstances. The ability to stay connected to the divine source of nature, regardless of interference.

Endocrine ecology substance IQ=Level of ability to ascertain quality nutritive components from environmental toxins/chemicals which cause negative consequences to the internal terrain and bodily functions, and then making the healthiest choices possible.

Endocrine Disruptors—Toxic substances causing changes to the worlds ecosystem as evidenced by certain forms of wildlife having characteristics of both male and female, and inability to reproduce, and also causing disease conditions in humans (earlier ages of puberty), breast cancers, low sperm counts, interference with fetus development, and severe hormone, neurotransmitter imbalances. Some examples are Bisphenol A (BPA), PFOA, 4-Hexylresorcinol and air pollution. These are found in lots of personal care products, oils, food coloring, pasteurized dairy, soy, plastics, Teflon cookware and have tested positive in over 30 common food additives. Recommendation: Remove all plastics from the home and do not eat any foods which have touched plastic. Eat only organic unprocessed whole foods without any food additives (from a reliable source). Make your own personal care products from trusted pure sources. Never eat any dairy, soy, shellfish. Limit food oils to only coconut oil that is cold processed, organic. Never cook with Teflon and be sure your cooking pots are of the quality that they will not leach any toxins. Make your own natural cleaning products, store all others in unattached garage. Use house plants to improve air quality.

Environmental substances intolerances—Sensitivities to certain chemicals, foods, water, air and multiple other toxic environmental substances. These intolerances will cause chronic disease conditions, usually with small amounts over long periods of time and with certain people over very short period of time., even one exposure for people with leaky gut or CBS genetic defect.

Ethical Financial Wellness=Ethical biz enterprises that contribute to sustainable future world and do not cause harm to Mother Earth or any living organisms. This is the use of financial resources in true alignment with divine love. Prioritizes use of financial resources to further one's life purposes (for the greater good of all), as it pertains to business enterprises that do not hurting anyone or profit from products or services that are toxic to human health or longevity.

Excitotoxins—Glutamate: (as MSG it; is in the form created by a lab), the amounts in our food supply has DOUBLED every year since 1940. These can come in the form of veggie proteins (hydrolyzed also), natural flavors, and spices. Aspartate, (which is nutrasweet) and cysteine. These cause neurodegenerative diseases, (ALS, Parkinsons and Alzheimers).

Factors of “Well-Being”—Includes happiness, as evidenced by optimal peak performance. (highest level of performance attainable), internal perception of wholeness, completeness, freedom and anticipation of a continuously joyful sense of adventure, regardless of circumstances. Can be measured by SWAP and our self help personal request/assessment system, then cross-correlated with the total physical assessments.

Financial Wellness and Independence=One's ability to use financial resources for highest good and life purpose/missions regardless of level of income. You are the same person, regardless of how much money you have, or don't have, and your life purpose (not money) remains the most important focus, regardless of financial changes.

Fitness—this term can be traced to its beginnings to the tragic sudden end of a popular charismatic world leader, the honorable John F. Kennedy, who single handedly spear-headed a new and revolutionary global interest and attention on physical and mental fitness. Millions of people from all walks in life around the world became involved in personal and group activities, college health and sports programs, small health food stores and a new group of business enterprises such as: sports clubs and dance halls. The passions and excitement of the international Olympic Games also contributed to the growing interest in “fitness.” In addition, the positive outcomes and intrinsic health benefits of enhanced physical energy and improved mental functioning that resulted from participating in fitness and wellness activities fueled the world-wide growth of this new paradigm. Since then, the focus on wellness and optimal health has steadily increased until recently when it was politically eliminated from most government and private insurance plans.

Fun Physical Activities and Hobbies—Includes all forms of “play” therapies; such as; dance, theater, and all those artistic endeavors which are physical in nature.

Gaba—The predominant calming neurotransmitter in humans. A low level causes constipation.

Global—refers to anything that may affect the whole world or the entire human race.

Gluten Intolerance—Inability to digest and absorb gliadin, the protein found in wheat, barley, rye and some oats. This undigested gliadin causes damage to the lining of the small intestine, (leaky gut) and malabsorption. These proteins cause significant amounts of inflammation, constipation, weight gain and hypothyroidism.

Glutamate—The predominant stimulatory neurotransmitter in humans. A high level causes overstimulation.

Gut—Refers to the intestine, the largest (of the most frequent paths for elimination) in the body. If elimination here is compromised or incomplete, then detoxification is incomplete. Likewise, if detoxification pathways (defined as methylation) are compromised then intestinal elimination will be compromised as well.

High Mercury Fish—shark, swordfish, kingackeral, tilefish

Homocysteine—An amino acid which is produced in the human blood stream. A high level is associated with atherosclerosis. A low or normal level (in those with chronic disease states) is associated with the CBS genetic defect, as this gets pulled down into the CBS drain.

Homocysteine—An amino acid which is produced in the human blood stream. A high level is associated with atherosclerosis. A low or normal level (in those with chronic disease states) is associated with the CBS genetic defect, as this gets pulled down into the CBS drain.

Hydrocarbon Detoxification—Removal of organic materials such as those accumulated in the human body from smoke, car exhaust, oil spills, petroleum, pesticides, carcinogens, immunotoxins, and endocrine disruptors.

Immunological virility—The functional level of the immune system.

Immunocompetency Functioning—refers to the balanced, efficient and highly competent functioning of the immune system in the presence of stresses, injury, pathogens, toxins and all other challenging events and processes.

Immunological virility—The functional strength of the immune system, to protect and defend.

Immunotoxins—Common environmental substances which damage the immune system and disable it's ability to function properly.

Immuno-Vitality—refers to a vibrantly healthy immune system that is balanced, efficient and highly competent functioning in the presence of stresses, injury, pathogens, toxins and all other challenging events and processes.

Important Blood Lipids—refers to vital blood lipids such as: Cholesterol, Low Density Lipids (LDLs), High Density Lipids (HDLs), Triglycerides, etc.

Improvement Protocols—refers to custom designed scientifically measured, tracked and frequently quantified educational programs with health enhancing suggestions that will help participants make significant changes alterations, or well-being advancements.

Inflammation—One mechanism the body uses to protect itself from invasion of foreign organisms and injury. Can be caused by ingestion of sugar(s), processed refined carbohydrates, and gluten (especially wheat).

Innovative—means brand new, neoteric, creatively different, or otherwise new.

Intervention Protocols—refers to scientifically developed optimal health and well-being improvement practices, procedures and educational programs.

Lactose Intolerance—Inability to digest the predominant sugar in milk. Symptoms include bloating, nausea, cramps, gas and diarrhea which begin after ingesting milk products.

Leaky Gut—a common condition that occurs when the integrity of the bowel is compromised and this means that the gut leaks undigested food byproducts into the blood stream which are then circulated as toxins. This creates a very sensitive framework as these individuals are most sensitive to meds, foods and other pollutants in the environment because they are overloaded with toxins and cannot process them effectively. It creates neurotransmitter imbalances also. Those with methylation genetic defects most commonly present with leaky gut syndrome. They cannot tolerate gluten (the protein from wheat).

Longevity IQ—Describes the measurement of awareness in an intelligent and informed individual with a higher level of understanding and capability to determine those factors, influences and circumstances and the subtle, divine life differences of positive or negative which lead one to the greatest longevity. It is an attribute of a person who is actively pursuing their divine life purpose (length of time on earth).

Mental intellectual stimulation=Anything that is intellectually exciting, enjoyable or challenging to one's brain activity.

Metal Detoxification—Usually needed in cases of CBS genetic defects and other methylation defects, as those people are constantly exposed to sources that their bodies cannot detoxify.

Metametrix—A blood test to measure levels of pollutants

Metal Stores—These are hidden in the body fat tissues i.e., copper from an IUD or birth control pills, causes chronic fatigue and other symptoms for life, if not corrected. This creates an imbalance of copper/zinc—very common with CBS genetic defects. Hidden copper stores are passed onto children, becoming more pronounced with each generation. This is why it is known you should cleanse the pathogens (parasites) from the bowel BEFORE you cleanse from heavy metals, because if you don't, then when the metals are released the parasites combine with them and further spread these thru the body. Parasites, metals and other toxins group together. Heavy metals which are hidden in the tissues do not show when tested for blood levels. See “provocative challenge test”.

Methylation—Natural process in the body to detoxify and process, eliminate. Between 4 am and 10 am is the most effective time to eliminate through-out the bodily systems.

Methyl Cycle analysis/treatment—Genetic assessment and treatment protocols designed to make one become a more efficient detoxifier.

Micro-Nutrient IQ=Ability to determine the subtle divine life differences of positive or negative consequences, effectiveness as well as the subtle, divine life differences of positive or negative consequences, in all ingestible products, nourishing substances, typically utilized for growth and maintenance of life, even very small amounts of nutrients, especially the very smallest of particles, which have the greatest potential for absorption and assimilation.

MSG—Mono Sodium Glutamate which is a toxic disease causing taste enhancing chemical additive found in many commercially processed and restaurant foods.

MTHFR-13 MethyleneTetraHydroFolateReductase, A methyl cycle pathway for methyl-folate generation, this is compromised in those with a positive MTHFR genetic defect, causing many chronic health problems due to inability to detoxify and causing low folate, resulting in neurotransmitter imbalances. MTHFR means many disease states due to not being able to process pesticides, estrogenic substances, and these include thyroid disease (hashimotos, cardiovascular diseases, neurogenerative-ADD-autism, and birth defects-neuraltube-and miscarriages. Also, cannot process certain anesthetics (like laughing gas) in dentistry can actually kill someone with MTHFR. Explanation: CBS up regulation causes a drain of the methyl cycle precursors which are all being drawn down the transulfuration pathway, which generates too much sulfa, sulfite (stimulating stress/cortisol response), excitotoxin activation, too much ammonia, and depletion of BH4 (causing insufficient dopamine, serotonin, and nitric oxide). After diet and supplement treatment has depleted the pools towards normal, THEN you can add, slowly, the methyl supplements (which treat MTHFR). Otherwise, if they are added too soon, then you will simply add to the CBS drain and increase the ammonia, sulfate and alpha-ketoglutarate. This CBS rebalancing takes about 3 or 4 mos.

Natural biological bio-ecological—Natural flow of life processes and energies maintained and interconnected with one's surrounding environment, for greater sustainability and support of one's life purpose.

Natural Medicine—refers to substances and natural, native, indigenous nutritionals that have not lost their natural attributes via commercial processing that have been produced by nature and which may be used as medicines without causing any harm.

Nutritional IQ=A term used to describe a higher level of intelligence about how one's body responds to foods and various nutritionals, and how to manage those to the greatest and highest utilization and absorption for the greatest level of energy possible, without creating immediate or future damage. Measurement of one's ability to choose nutritional substances, (in amounts, timing, and preparation methods) for the highest level of repair, growth and energy possible.

Nutritional Wellness Eating/Drinking Habits—generally means avoiding toxic GMO foods, unhealthy restaurant foods with MSG, highly processed and massively produced foods loaded with preservatives, artificial sweeteners, fast, junk foods and drinks that may become addictive. Nutritional wellness also describes one who eats a purer diet than those who eat unconsciously, the S.A.D. (Standard American Diet).

Natural Native Indigenous Nutritionals—refers to natural, unprocessed nutritional herbs, and foodstuffs; the purest forms of nutritional support, closer to ancient nutritional forms, before the modern industrialized processed foodstuffs and supplements were developed by humans, i.e., Nemenhah (indigenous substances) describes the attributes of the purest forms of nutritional support, unprocessed, and closer to ancient nutritional forms.

Nurturing Relationships Quotient—One's emotional internal terrain as it is affected to its supportive nurturing relationships, in a mathematically assessed quotient.

Organic—Raised or created without the use of drugs, hormones, chemicals, toxins, fertilizers or pesticides. Note: Neurotoxic food chemicals may now be added to certified organic foodstuffs (such as the sweetener “neotame”) and this does not need to be added to the label of ingredients. So, to be sure that the organic foods have been maintained in their unprocessed, pure form without such additives; be sure you know the farmer.

Overmethylation—Characterized sometimes by fatigue, malaise, achiness, headaches, as you are having too many toxins coming out too fast. One of the treatments is to give small amount of niacin and stop the substance contributing to detox. A common reason for overmethylation (or Detox illness) is because the CBS is not healed BEFORE the treating of MTHFR with methyl factors (methylcobalamin, methylfolate, and P-5-P-an active form of B6). In order to heal CBS it is essential that the physical elimination path (the gut) is healed of the inflammation/dysbiosis FIRST, so that there is a clear route for the toxins to pass thru. Dr. Hulda Clark used a bowel cleanse then a parasite cleanse as her FIRST step, along with a nonpolluted diet. (free from molds).

Non-Political Resources—refers to any ethical support, resources, funds, assistance, or help that is resourceful, financial, enabling, empowering and/or any other type of resources that do not ascribe to any political or economic blatant or hidden agendas.

Potential DNA Genetic Micro-Challenges—Factors which have the capacity to change or compromise the DNA structures and interrelated bodily functions, on an internal level. Research has confirmed that these are passed on thru several generations, as evidenced thru periods of famine and periods of other environmental toxins/stressors. I.e.: Bisphenol A and many other common chemicals, pathogens, metals present in processed foods.

Preventable—refers to unwanted diseased conditions that can be forestalled or prevented by reasonable means or by being proactive.

Probiotics—Good bacteria in the gut. Protects from unwanted pathogens.

Provocative Challenge test—IV of metal attractor substance is administered and then urine test is collected 6 hours later which shows the level of heavy metal deposits from the tissues.

Psychophysiological wellness IQ—Measurement of the ability to perceive the internal and external processes and consequences of healthy/unhealthy choices and behaviors leading to various levels of wellness.

Psycho-Spiritual Well-Being—can be defined as continuous reassessment of one's choices and their consequences; as a self-health personal inventory, evaluation, assessment and refinement of one's path in spiritual value principles, beliefs and systems of thinking and functioning in today's world. These terms refer to the wholeness of the interdependent aspects of mind, body, emotion and spirit.

Quantum Energy Management=Management of the smallest independently existing particles and electromagnetic energy processes, including all energetic fields and subtle energies and within their powerful yet subtly hidden, delicate environments for the highest level of wellness possible in the moment.

Quantum Paradigm—refers to global archetypes, model standards, beliefs, patterns, or concepts that are widely ascribed to or commonly held/believed to be true, valid or considered as common theories.

Risk Factor Warnings—refers to any warnings given to participants of potential risks based on empirical measurements, lab evaluations or self-reported data or information of bad habits.

Scaling and Factoring Formuli—refers to mathematical elements, influences, dynamics, considerations, components, formulas and algorithms that relate to the determining the ranges and ranking factors for the 10 Point Scales.

Selective Substance IQ—refers to intelligent informed aware people who wish to avoid the potential negative consequences and toxic reactions from consuming hormone fed animals, neurotoxins, endocrine disruptors, DNA disruptors, carcinogens, immunotoxins, toxic MSG, fast/junk or GMO foods, dangerous processed foods and drinks containing toxic chemicals, pesticides, additives, artificial sweeteners, high fructose or corn sweeteners, gourmet coffees, foodstuffs wrapped in plastics (causing hormone disruption), lozenges, mouthwash, nasal spray, toothpastes, inflammatory foods; including but not limited to; xenoestrogens, inflammatory foodstuffs; negative allergenic reactions to belladonna, nightshade vegetables, wheat, barley, rye grains, and most sugars, homogenized milk products (non-boiled/baked due to parasites), moldy breads, pastas, cereals, arsenic laden rice, medicines with fillers, excipients and colorings or other chemical additives, anything which is reactive and/or creates negative consequences for one's own individual composition and/or digestive challenges and constitution differences, including foods fortified with lab produced vitamins, including mold infected air conditioning systems, electronic components, body care products, electromagnetic field energies from a variety of EMF sources (such as: computers, tablets, microwave radiation from any device, cell phones, mobile Wi-Fi devices, etc.), including non-pure potable water, and some non-pharmaceutical or lab produced nutraceuticals that cause negative or allergic reactions, consequences or un-wanted outcomes.

Soil Contamination—Includes pesticides which cause nausea, cardiovascular illness, headaches, fatigue, digestion illnesses, and autoimmune disease.

Specific Carbohydrate Diet (SCD)—Flours, rice, breads, and potatoes all absorb toxins and pollutants. Avoidance of these foods is the basis of the SCD, which is recommended to control the symptoms of autism. (a neurotransmitter disease).

Spiritual Ecology IQ=Evidenced by the “divinely orchestrated” balance between nature and oneself for the highest good and sustainable future (of all involved parties), as can be observed by behaviors of calm, loving emotional centeredness, regardless of continuing changes in environment and circumstances. The ability to stay connected to the divine source of nature, regardless of interference.

Spiritual, Emotional, Ecological Integration and Balance—denotes connection and integration with balanced natural processes, forms and flow, thru one's higher self, including all spiritual, mental, intellectual, soul, emotional and physical aspects, for the purpose of continuous re-balancing, re-assessing and re-integrating of our vital life force and surrounding environment without disruption of natural rhythm, process or sustainable future.

Spiritual Well-Being=connection to source and management of life purpose and fusion with one's mission. The ability to experience connection/management/fusion as manifested by one primary intense desire (above all other needs) to be of divine service, for the greatest good; i.e.; to give one's life up to divine purpose, making use of one's inherent gifts, to that end.

Stims—Repetitive, uncontrollable behaviors such as head banging, hair pulling and other self-destructive behaviors, (in an effort to decrease anxiety). Often seen with the CBS genetic defect and in autism.

Strep Thermophilus—Present in many probiotic products. Is contraindicated and has ill effects in those with autism or dysbiosis.

Stress Challenge Management—means one's ability to rebalance from critical stressors, resulting in better management skills, creating a higher level of energy, strength and homeostasis.

Stringent—refers to any type of rigorous, tough, rigid or severe criteria or evaluational procedures for analyzing data or information.

Sulfites—Common neurotoxic food additives. To decrease sulfites in foods (for ALL people, but especially important for those with the common genetic defect: CBS).

Super-Bugs, i.e., Resistant Strains of Mutated Pathogenic Organisms—refers to any microbial pathogenic organism that develops and replicates into mutant strains that are multi-drug and methylcillin resistant organisms (such as: strains of bacteria, viruses, mold and fungi).

Super-Loving and Healthy Individuals—happy fulfilled capable of healing, having lived as humans 15 years without any illnesses and diseases symptoms including the common cold or flu, has not digested or ingested with any meds, drugs, toxic chemicals, hormones, GMOS, pesticides, fertilizers, harvest enhancers, no OTC or RX only minimally use only natural nontoxic herbs, meds, no digestive aides or other med treatments, no loss of vitality even when exposed to super-bugs!!!

Sustainable Future—Any development that meets the needs of the present without compromising the health, ecological environment, well-being of living organisms or the ability of future generation to meet their own needs. Can also refer to the endurance of systems and processes. Sustainable development has four domains: ecology, economics, politics, and environmental science.

Symptoms and diseases associated with CBS—Due to sulfur overload, adults present with anxiety and insomnia and in children; “stims” behaviors such as hair pulling, head banging and other autistic behavior are seen. In a broader sense, the high ammonia and glutamate will also cause a stimulated stress/cortisol response (fight or flight), excitotoxicity, high levels of calcium in cells (which cause neurodegenerative damage), brain fog, sugar control problems, low energy, chronic toxicity, chronic infections, neurotransmitter dysfunction (low dopamine and low serotonin), ADHD, autism, and other neurological and psychological diseases, cardiovascular diseases, hypertension, and inflammatory disease states. ALL patients with chronic or untreatable/unexplained disease processes have been found (via research studies) to have the CBS genetic defect. In CBS, the enzyme systems that would normally convert glutamate into gaba are compromised by lead and mercury.

Take Charge of Your Own Well-Being Programs—refers to customized follow-up improvement educational intervention optimal health programs.

Technologies—refers to advancements in sophisticated devices, phones, computers, gadgets, software, Apps, etc.

Toxic—Means the commonly accepted meaning of anything (substance or element) that causes either short or long-term harm, diseases, death, or simply unwanted biological and/or chemical changes.

Transformative Pain Management—Skillful management of pain via mental focusing on one's higher life purposes and goals to further one's life mission.

Valuable—refers to anything that has informational or economic importance.

Vegan Diet—Diet of fruits, and vegetables, and other carbohydrates, without milk, meat or fish or eggs. Can show a false negative for patients with a CBS defect (no sulfur in the urine). This diet will help those individuals feel better, as it leaches out the high amounts of sulfur in the body.

Water pollution—Bacteria, parasites, toxic chemicals. Causes neurodegenerative diseases, endocrine disruption, cancers, cardiovascular illness, metal poisoning, and chronic fatigue states.

Wellness—refers to a popular “Wellness Movement” that dates back to the early 1980s that coincides with the invention of the personal computer (PC). Since then, the growth of wellness and optimal health enterprises has steadily increased until recently when the increased health and longevity benefits of these technologies was politically eliminated from most government and private insurance plans. Wellness is a term referring to health, happiness, vitality and wholeness of the entire mind/body/spirit complex. A state of balanced health which is reflected in continued learning, growth and on going creative expression.

### End of Specialized Terms in the Embodiments/Specifications/Claims of the Invention

The preceding glossary and definitions of terms used in this application have unique and specialized meanings of both the new terms as well as some terms with different meanings for this application and invention that are used differently from their common general usage in the health industry. The following general and common terms related to this application are included herewith having the same meanings as their common general usage in the health industry. For anyone with ordinary skills in the art, the present invention uses the general common terms and language as defined in the glossary and set forth herein. It nevertheless should be understood, by a person with experience and expertise in the art, that no limitation of the scope of the invention is hereby intended.

### General or Commonly Used Terms Related to this Application

Non-Physical Lifestyle Habits “Outlooks/Attitudes and Behaviors”

What you think, and believe creates actions that become habits. This self-assessment measures those and how they affect your level of optimal wellness and total well-being. What we focus on is what we create, so to make healthy choices you must have a determined intention to use your body for the highest fulfilling life purpose, at all times. This outlook will create healthy behavioral patterns as you trial and error each life-style choice you make, against the immediate or long-term consequences and learn how well it can support your life purposes!

Non-Physical Lifestyle Habits “Commitment to Wellness”

This self-assessment scores how determined you are to achieve and maintain a high level of optimal wellness and total well-being. As you focus on your life purposes, creating exciting new possibilities for the future, you will notice that you are becoming more and more committed to higher levels of wellness, as you reap what you have earned, from the consistent healthy choices that you make!

Non-Physical Lifestyle Habits “Eating/Drinking Habits”

This self-assessment evaluates your regular eating and drinking behaviors and how they affect your level of optimal wellness total well-being. Through trial and error, (your body gives the feedback) we learn what to eat/drink, when and how much, paying attention to details such as any additives (read all labels), eating out, vs home prepared or cooked meals, and what kinds of foods work best to achieve the highest level of brain and body functioning, to support your life's mission and purposes!

Physical Lifestyle Habits “Activity/Exercise Habits”

This self-assessment tool will measure your level of activity/exercise and how it contributes to your level of optimal wellness and total well-being. Make it a daily discipline to gentle aerobic movement; out in nature, dance, or other forms that you enjoy, to keep these behaviors a high priority. This life-style habit will continue to reinforce your commitment to wellness, as you will see the many positive benefits, in mood, energy, focus and vitality to support your mission and life purposes!

Non-Physical Lifestyle Habits “Environmental Habits”

This test will measure your choice of work/home/play environments and show how those affect your level of optimal wellness and total well-being. The choice of where you live and work is most critical to a high level of optimal wellness and total well-being. Pay careful attention to the air quality, water quality (including pipes), radiation, EMF (Wi Fi), noise level, temperature, and the many environmental toxins (pesticides, smoke, lighting, A/C conditioners with hidden molds, toxic plastic cookware, negative people, etc.). Be sure to get out in the fresh air high in oxygen of natural surroundings as much as possible. These choices are necessary to reduce the amount of environmental stress on your body, in order to attain and keep the highest level of functioning for support of your mission and life purposes!

Non-Physical Lifestyle Habits “Nutritional Supplemental Habits”

This self-assessment test will determine how your supplements have affected your level of optimal wellness and total well-being. Choosing the correct supplements that best nurture your unique biochemistry and physiology in the right amounts/timing/processing methods and form is a delicate balance for most people, but it can be an extremely efficient way to reach a higher level of functioning for support of your mission and life purposes. It is wise to choose those without any fillers of additives (certain companies will provide) and try to cap up your own (avoiding capsules with bulk dried, organic herbs). Take the time to self-educate which herbs will benefit you the most, to keep all body systems functioning in a light detox, keeping elimination at a high level, and nutritionally supporting optimal health of the body's organs. These habits will most definitely add good fodder to your life purposes fire!

Non-Physical Lifestyle Habits “Medication Habits”

This self-assessment tool shows how your choice of medicines may have changed your level of optimal wellness and total well-being. Choosing medications only when in need and at the correct amounts and timing will definitely set you apart from those who have no discernment for what works to support a high level of functioning for your mission and exciting life purposes.

Non-Physical Lifestyle Habits “Personal, Medical, Health and Fitness Histories”

This self-assessment will determine how your personal medical, health and fitness history has shaped your level of optimal wellness and total well-being. These are indicative of how you have functioned in the past, and should help you to define where you need to go in your present and future lifestyle choices in order to support the highest level of functioning for your mission and life purposes!

Non-Physical Lifestyle Habits “Family Medical/Immune Histories”

This self-assessment tool shows how those in your immediate family have affected your current levels of optimal wellness and total well-being. This will show you how your inherited habits, genetics and familial environmental circumstances might be contributing to your lifestyle choices and what you may need to change in order to strengthen your body, soul, mind and heart (loving connections to others) to support your mission and life purposes!

Non-Physical Lifestyle Habits “Immune System History”

This self-assessment test will determine how your choices in eating, resting, de-stressing, taking immune building supplements, environmental toxins, are contributing to your level of wellness/well-being. As the toxins in our environment increase with every year, it becomes more and more important to keep a vigilant assessment of what nutritional foods, quality supplements, cleaner environments, daily de-stressing activities, quality and quantity of sleep, are necessary to keep a level of balance to support and enhance the immune system. This will affect your attitudes and commitment towards supporting your mission and life purposes!

Objective Physiological Tests/Measurements “Systolic Blood Pressure”

The Systolic Blood Pressure; is the first number of the reading and it measures as the heart is pumping blood, so it can be affected by situations such as strong emotions, therefore, is not a very good indicator of wellness.

Objective Physiological Tests/Measurements “Diastolic Blood Pressure”

The Diastolic Blood Pressure; is the last number of the reading and does indicate wellness. It measures the health of the internal condition of the cardiovascular system, and is a true indicator of how a person has been living their life and shows results from their habits, over a long period of time.

Objective Physiological Tests/Measurements “Resting Heart Rate”

Sedentary Beats Per Minute

Objective Physiological Tests/Measurements “Stress Measurement”

A Stress Dot which evaluates the temperature at the extremities.

Objective Physiological Tests/Measurements “Body Fat Composition”

A simple assessment of the amount of adipose tissue on your body measured by calipers.

Objective Physiological Tests/Measurements “Height and Weight Ratio”

The ratio of the weight you have created by your lifestyle habits, to your height.

Objective Physiological Tests/Measurements “Urine Analysis”

Urine evaluations done by a lab that may indicate needed changes in lifestyle.

Objective Physiological Tests/Measurements “Sputum Analysis”

Saliva test to determine hormonal levels and may indicate needed changes in lifestyle.

Objective Physiological Tests/Measurements “Blood Cell Analysis”

Blood evaluations done by a lab which may indicate a need for changes in lifestyle.

Laboratory Analysis “Blood Liver Analysis”

Blood test to measure the health of your liver and may indicate a need for changes in lifestyle.

Laboratory Analysis “Total Blood Triglycerides”

Blood tests to determine blood lipids and may indicate a need for changes in lifestyle.

Laboratory Analysis “Total Blood Cholesterol”

Blood lipid testing which may indicate a need for changes in lifestyle.

Laboratory Analysis “Total Blood HDLS”

Blood lipid tests to indicate a possible needed change in lifestyle.

Laboratory Analysis “Total Blood LDL to HDL Ratio”

Blood test to determine ratio of bad cholesterol to good cholesterol which may indicate a need for change in lifestyle.

Laboratory Analysis “Immunocompetency Evaluation”

Blood tests to determine immune system functioning which may indicate a need for changes in lifestyle.

Laboratory Analysis “Immune System (NK) Activity Level”

Blood test to determine effectiveness of the natural killer cells in your body and may indicate a need for lifestyle changes.

Laboratory Analysis “Autoimmunology NK, B, T-Cell Counts”

Blood tests to determine certain levels of immune functioning which may indicate a need for lifestyle changes.

Laboratory Analysis “Immune T-Cell Helper/Suppressor Ratio”

Blood test to determine certain components of immune cell functioning which may indicate a need for changes in lifestyle.

The preceding glossary and definitions of terms used in this application may have unique and specialized meanings or applications for this invention in that they may be used differently from their common general usage in the health industry. The previous general/common terms related to this application are included herewith generally having the same meanings as their common ordinary usage in the health industry. For anyone with ordinary skills in the art, the present invention uses the general common terms and language as defined in this glossary and set forth herein. It nevertheless should be understood, by a person with ordinary experience and expertise in the art, that no limitation of the scope of the invention is hereby intended.

### BRIEF DESCRIPTION OF THE NEW IMPROVED EMBODIED DRAWINGS

The present new objective innovative improved invention is described in greater detail in the following descriptions and examples embodying the specifications and best mode of the invention, taken in conjunction with the drawing figures, in which:

FIG. 1 is a block diagram illustrating the combined sources of input data, followed by the comprehensive evaluation processes, plus the individualized and group customized output reports that are the preferred forms of the new and improved invention,

FIG. 2 is a comprehensive schematic diagram showing the method according to the invention including the interconnections and comparative correlations of the various aspects of the new and improved invention,

FIGS. 3A through 3E illustrate new, updated and improved examples of self-scored or certified wellness technician administered clinical certain bio-physiological pulses, BMI, standard blood pressures, circulation cardio-efficiency and environmental pulmonary wellness measurements of scientifically measured optimal wellness levels and any inherited genetic and/or medical risk-related conditions and risk factors (if any) combined with unique quantifiable well-being parameters,

FIGS. 4A through 4G illustrate new, updated and improved examples of self-reported actuarially adjusted objective customized life-style assessments of life purposes and missions, personal outlooks and core beliefs, lifestyle attitudes and habits, spiritual values, nutritional eating and drinking habits, movement and physical exercise behaviors, relationship wellness dynamics as well as other lifestyle indicators of scientifically measured and validated wellness and ideal fitness as well as any inherited genetic and/or medical risk-related conditions and risk factors (if any) combined with unique quantifiable updated total well-being parameters,

FIGS. 5A through 5F illustrate new, updated and improved examples of validated laboratory Biological and Physio-Chemically analyzed body fluids that are scientifically measured and evaluated for determining optimal wellness levels combined with unique updated quantifiable well-being parameters.

FIG. 6 is a new and improved example of a portion of an individualized Quantifiable Well-Being and Scientific Optimal Wellness Summary Chart with simple, appropriately ranked personalized summaries and evaluations in the quantified categories and rankings according to the unique, updated and improved comprehensive 10-Point Quantifiable Well-Being and Scientific Wellness Scales in a simple to understand graphically illustrated chart.

### DESCRIPTION OF THE EXAMPLES EMBODYING THE BEST MODE OF THE NEW INVENTION

The new updated and improved quantifiable well-being and scientific wellness method offers the following unique features:

It allows an individual to be compared and correlated to a more stringent, advanced and updated optimal criteria of “super-healthy individuals and groups” (as set forth herein) of measured and assessed living examples of optimal quantifiable well-being and “scientifically validated super-wellness people” as described herein.

It emphasizes the key positive benefits and major “longevity/staying well” contributions of knowing and following an exciting life purpose and important mission combining super-healthy lifestyle choices, spiritual and mental outlooks as important causative factors that result in achieving and maintaining optimal “quantifiable well-being” as well as “scientifically validated super-wellness” including the realistic potential goal of completely reducing and/or eliminating most major predictors of diseases or catastrophic health risks.

It contains updated, improved, actuarially determined important global categories of quantifiable well-being status, optimal health and fitness, and attainable levels of scientific wellness, making it among the first and most complete, validated, accurate and comprehensive method of “staying well” in use today.

It continues to motivate participants in a positive direction by encouraging frequent re-testing and measurements of the on-going negative impacts of stress, unhealthy habits and poor lifestyle choices on the spiritual, intellectual, emotional, mental, psycho-physiological systems of the body/mind/soul/spirit human organism, including quantifiable devastating effects on the cardio-vascular and immune systems.

It allows participants the opportunity to take the guesswork out of proactively managing one's levels of quantifiable well-being status, optimal health and fitness, and attainable levels of scientific wellness as described herein.

It provides on-going invaluable data and information that dramatically improves the ability of smart people to predict and quantify their own future levels of quantifiable well-being status, optimal health and fitness, and attainable levels of scientific wellness, potential medical utilization and resulting predictable, quantifiable and trackable benefits from any well-being, optimal health and ideal fitness improvement programs.

It offers a new and exciting high-tech adventure through individualized and customized (to the actual expressed goals, empirically measured physical and nutritional needs and challenges of the person) novel series of custom computer generated “Virtual Reality Games” whereby a smart participant can study his or her “Quantifiable Well-Being and Scientific Optimal Wellness Output Reports” and then explore in a safe virtual world the probable outcomes and consequences of making either “GOOD” (wellness improving choices) or “bad” (addictive, selfish, self-destructive, potentially harmful or disease causing choices and outlooks/attitudes). These customized computer generated “Virtual Reality Games” will be so factual and realistic (based on the actual empirical data and measurements taken by a certified wellness technician, the self-reporting subjective information provided by said participant, and the scientifically objective lab analyzes of body fluids) that these adventure filled “Virtual Games” are very likely to become a powerful motivating positive influence towards consistently making “beneficial” lifestyle choices the gradually improve a person's rankings on the “Quantifiable Well-Being and Scientific Optimal Wellness Scales” which can easily improve a person's mathematical chances of healthy-aging, increased wellness and well being plus an exciting high-quality future life purpose and mission complete with increased longevity potential.

### Global Categories

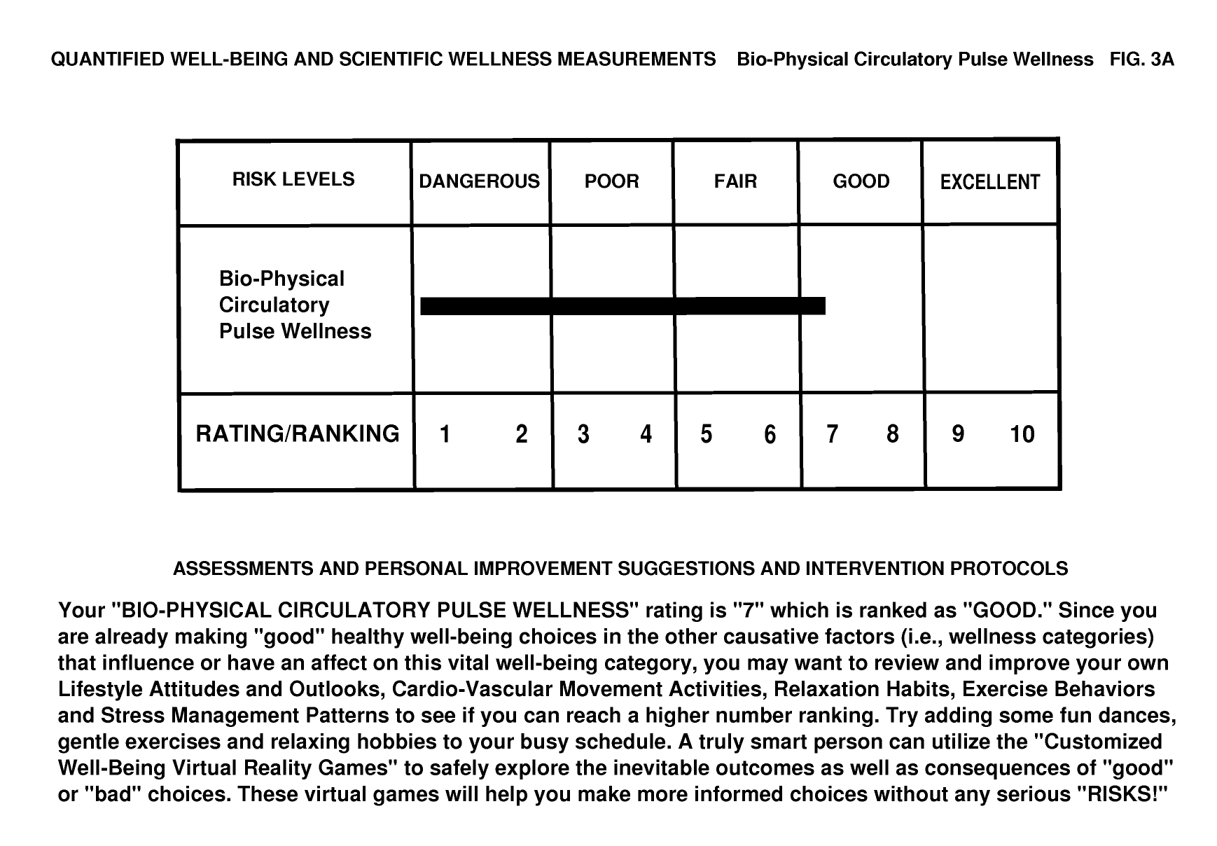

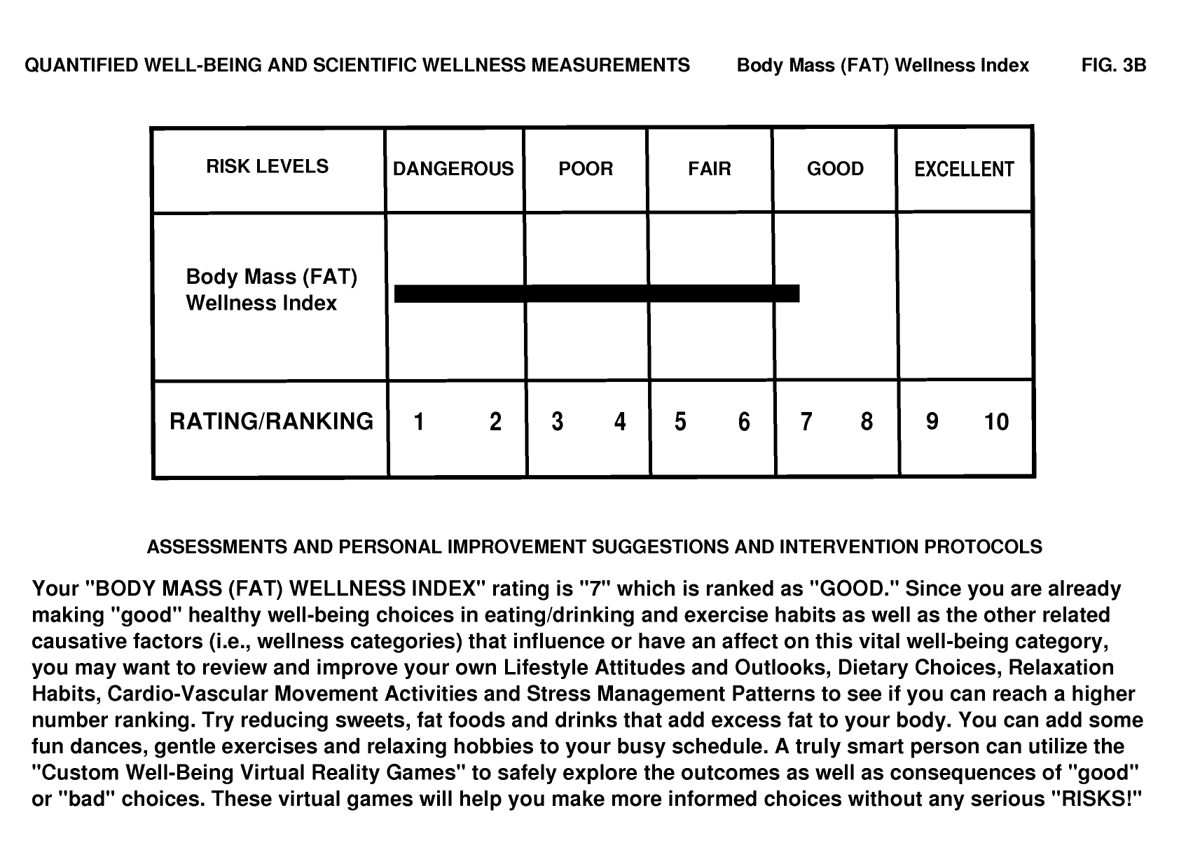

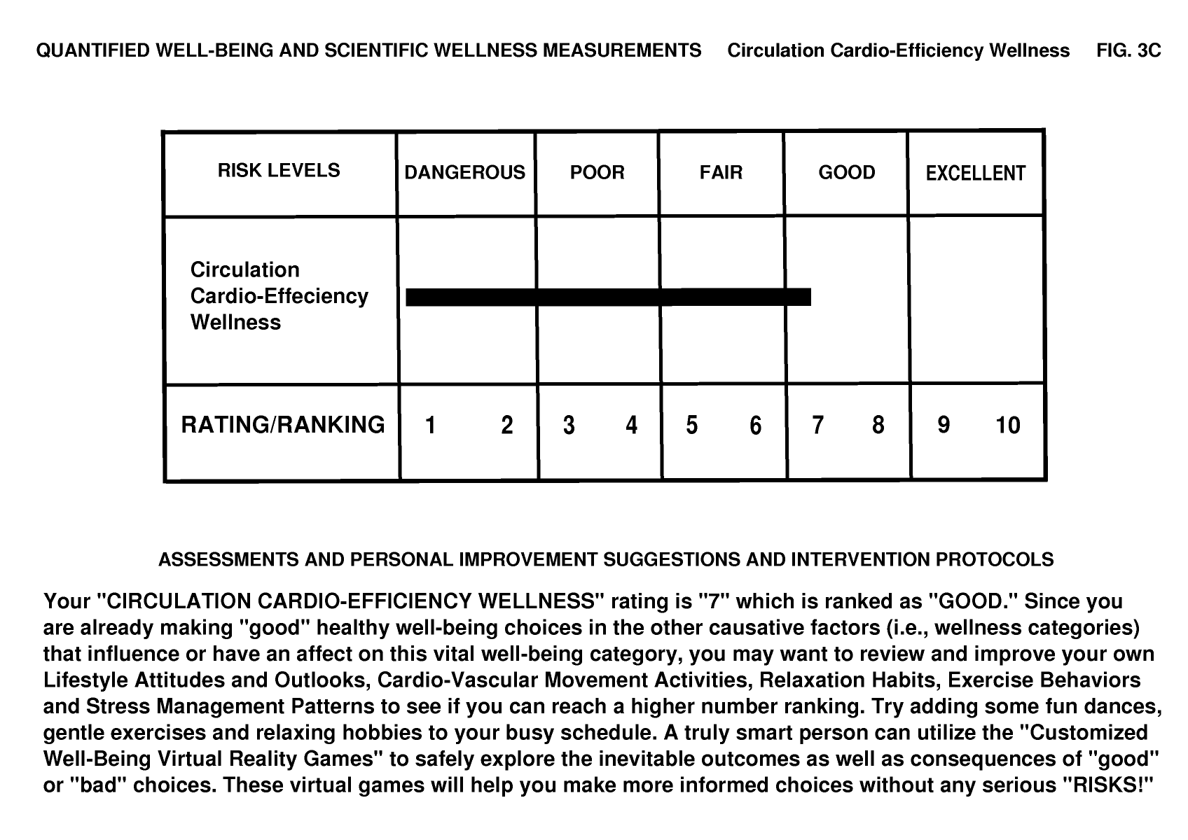

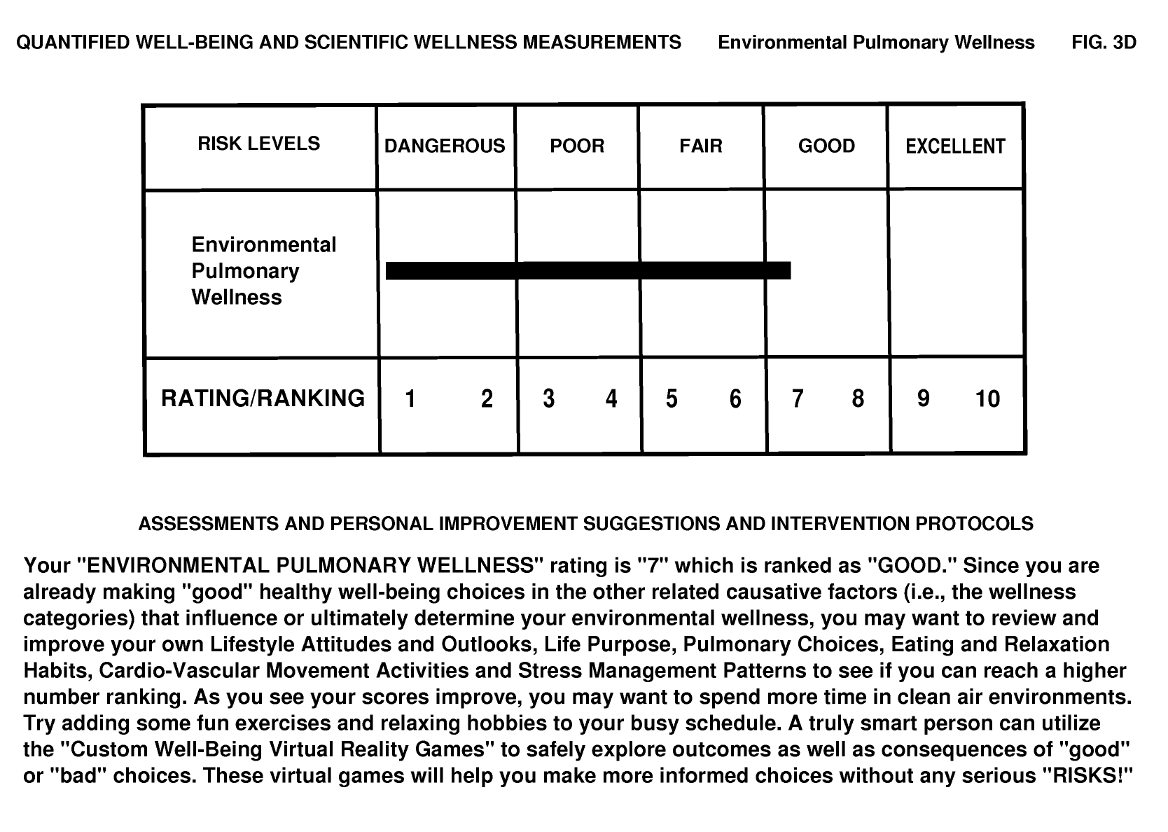

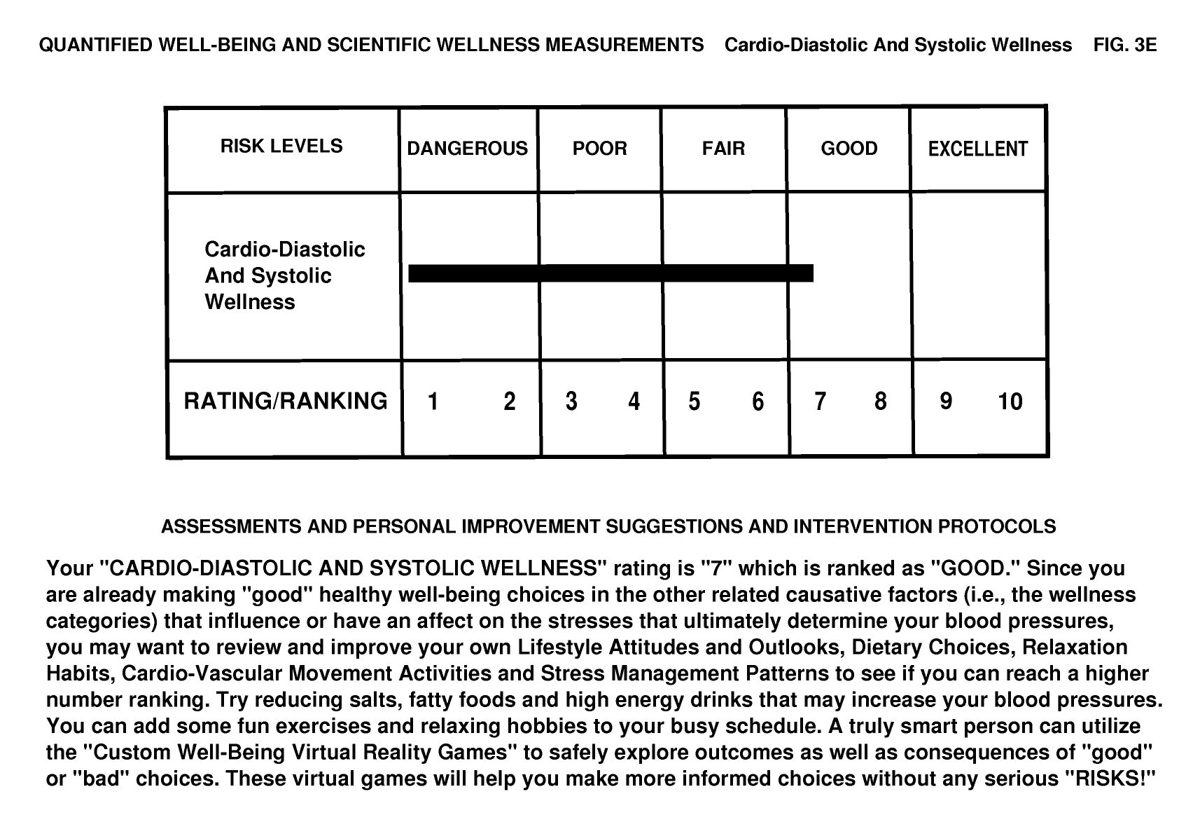

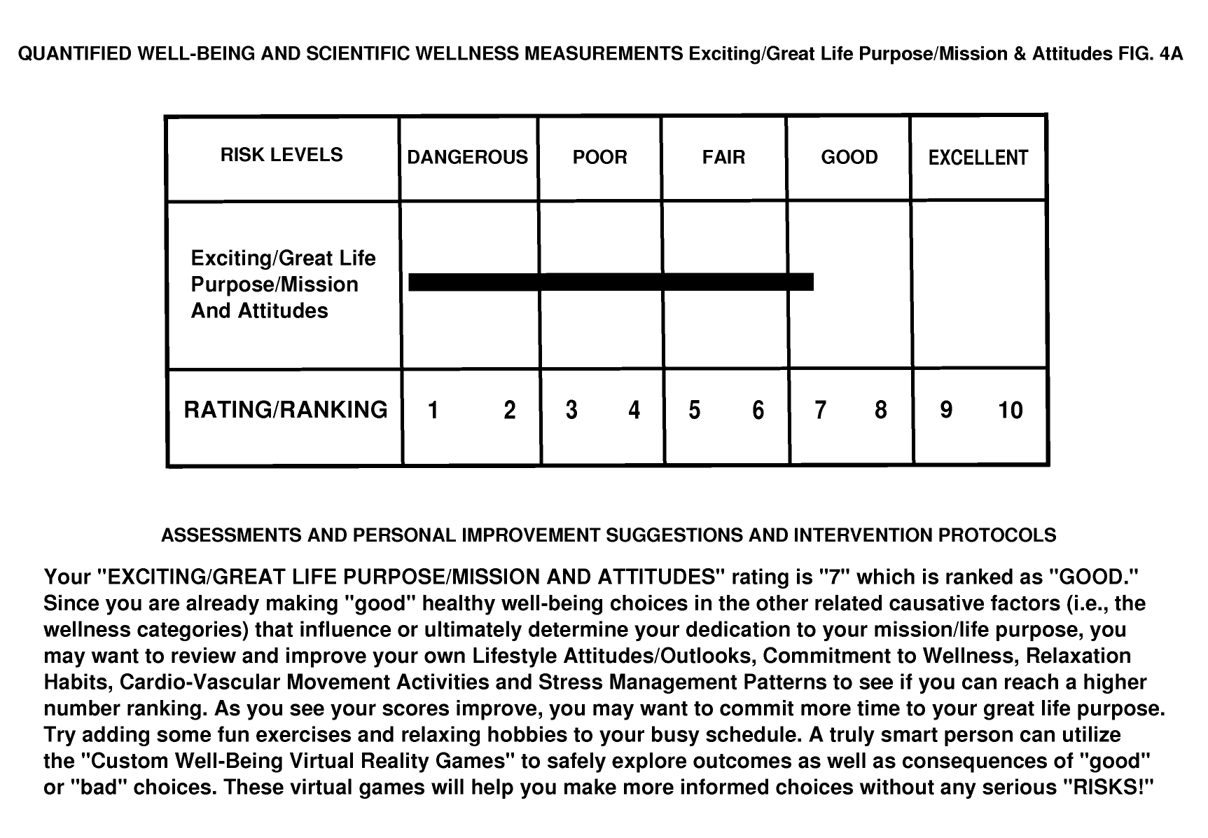

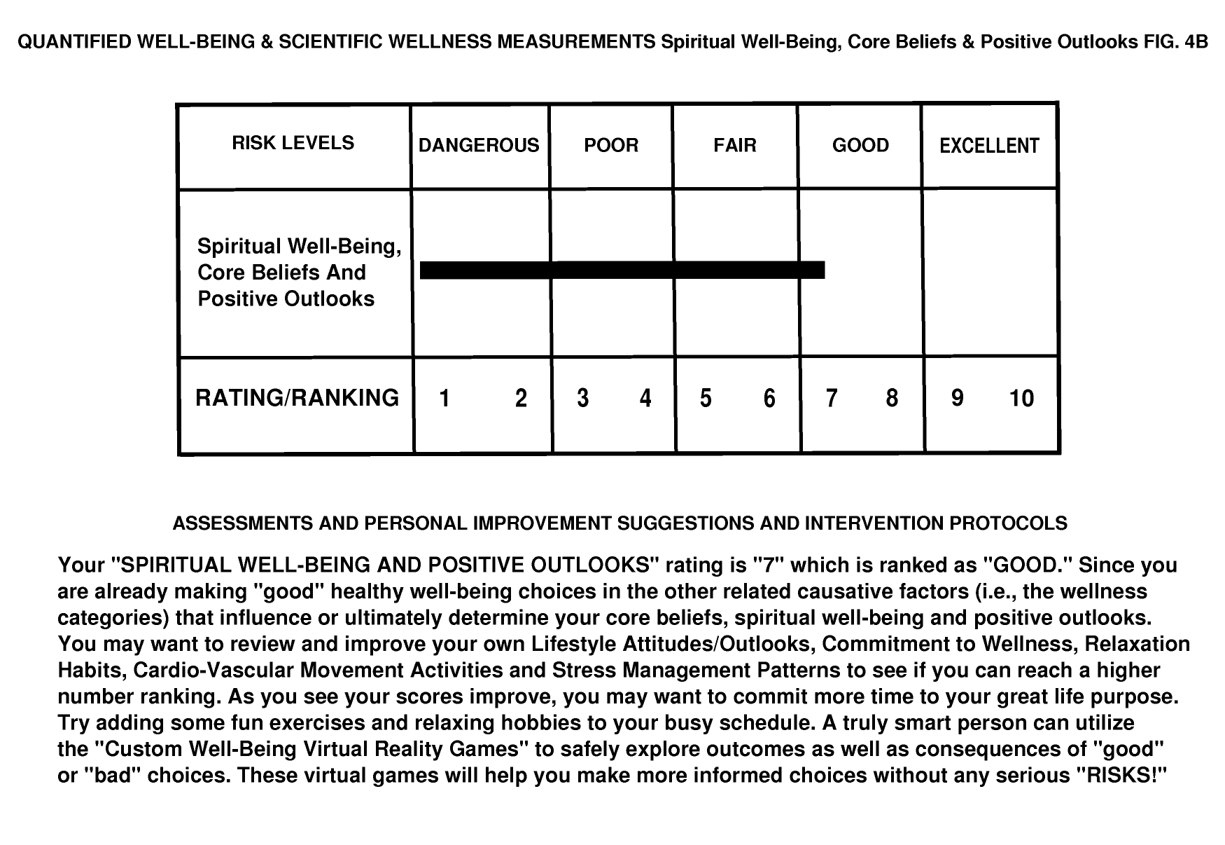

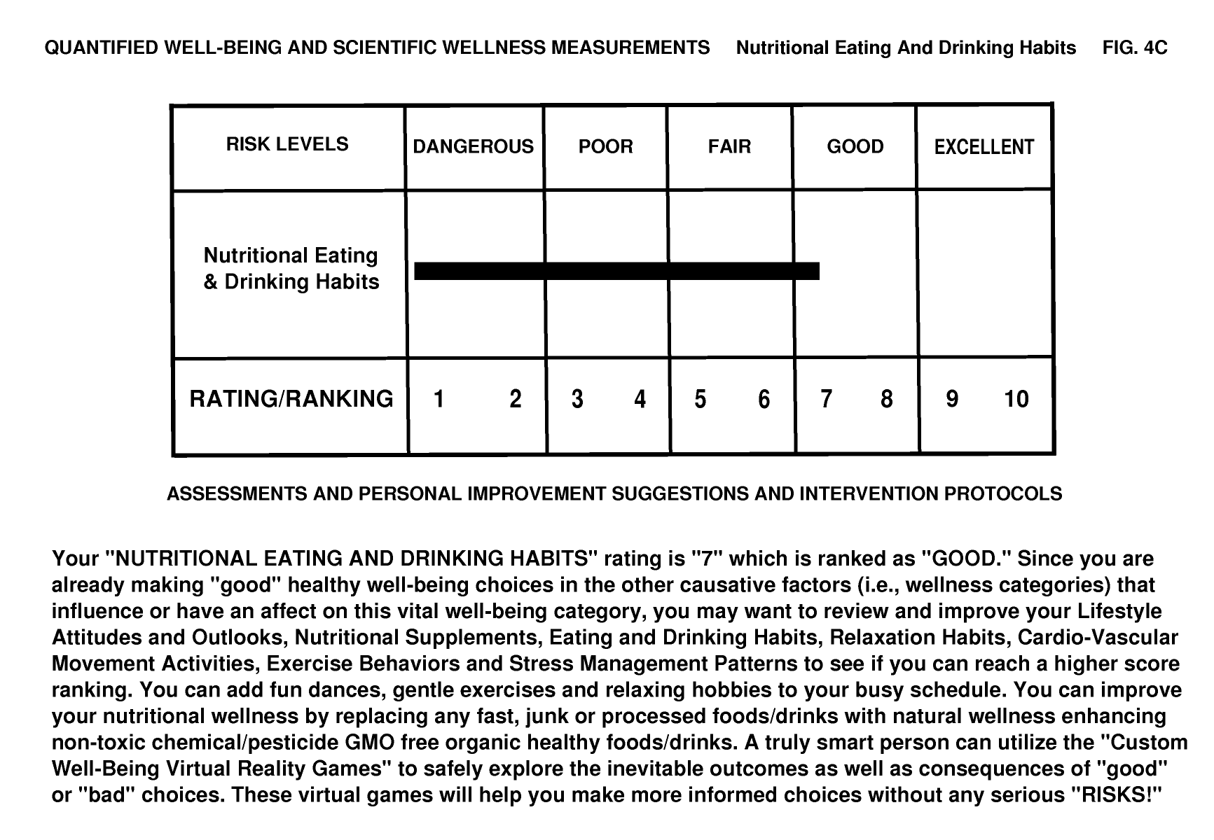

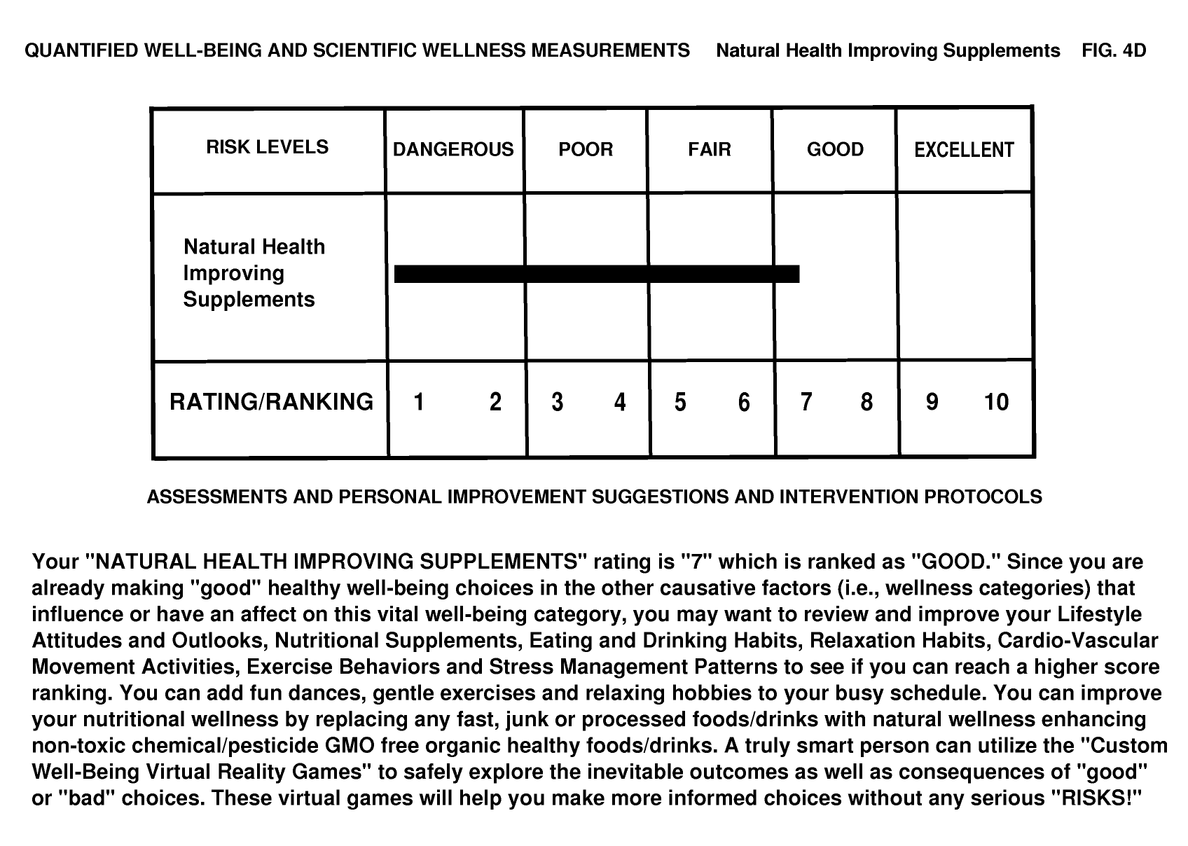

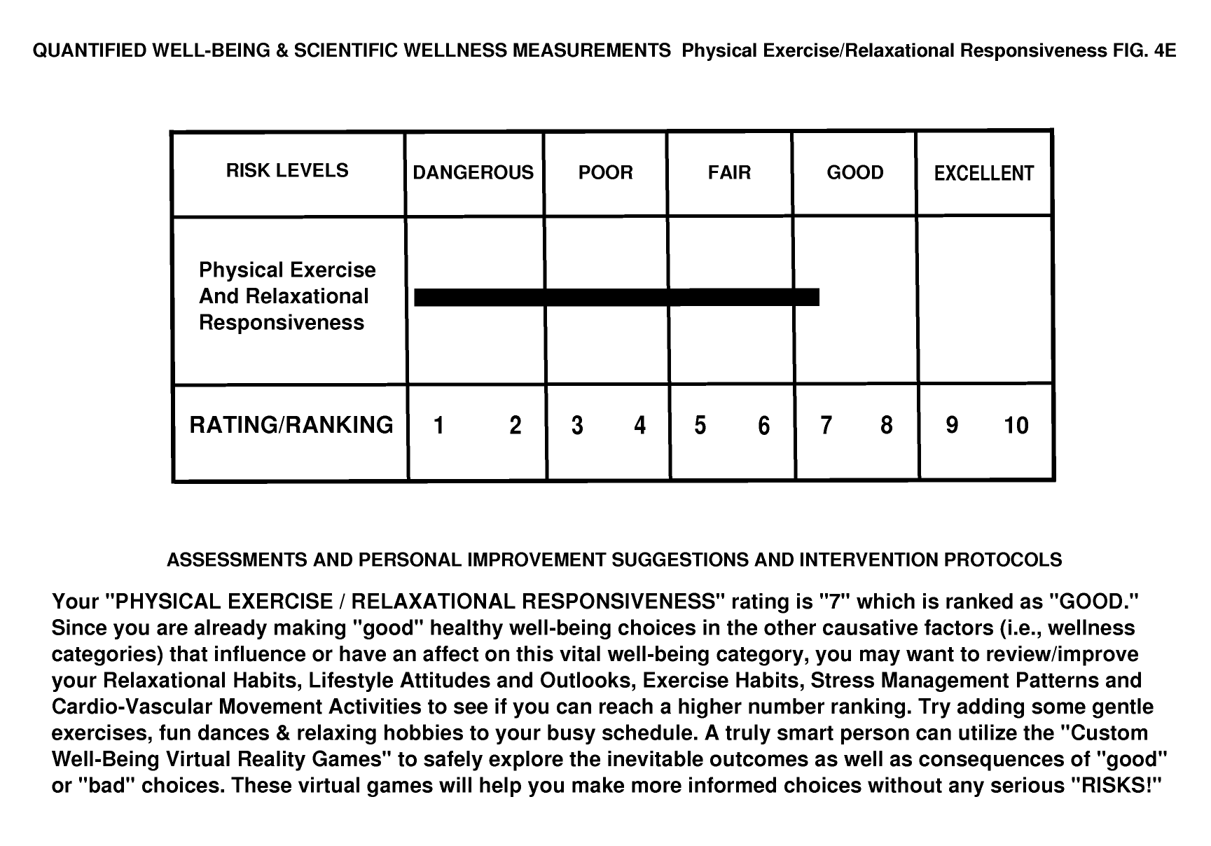

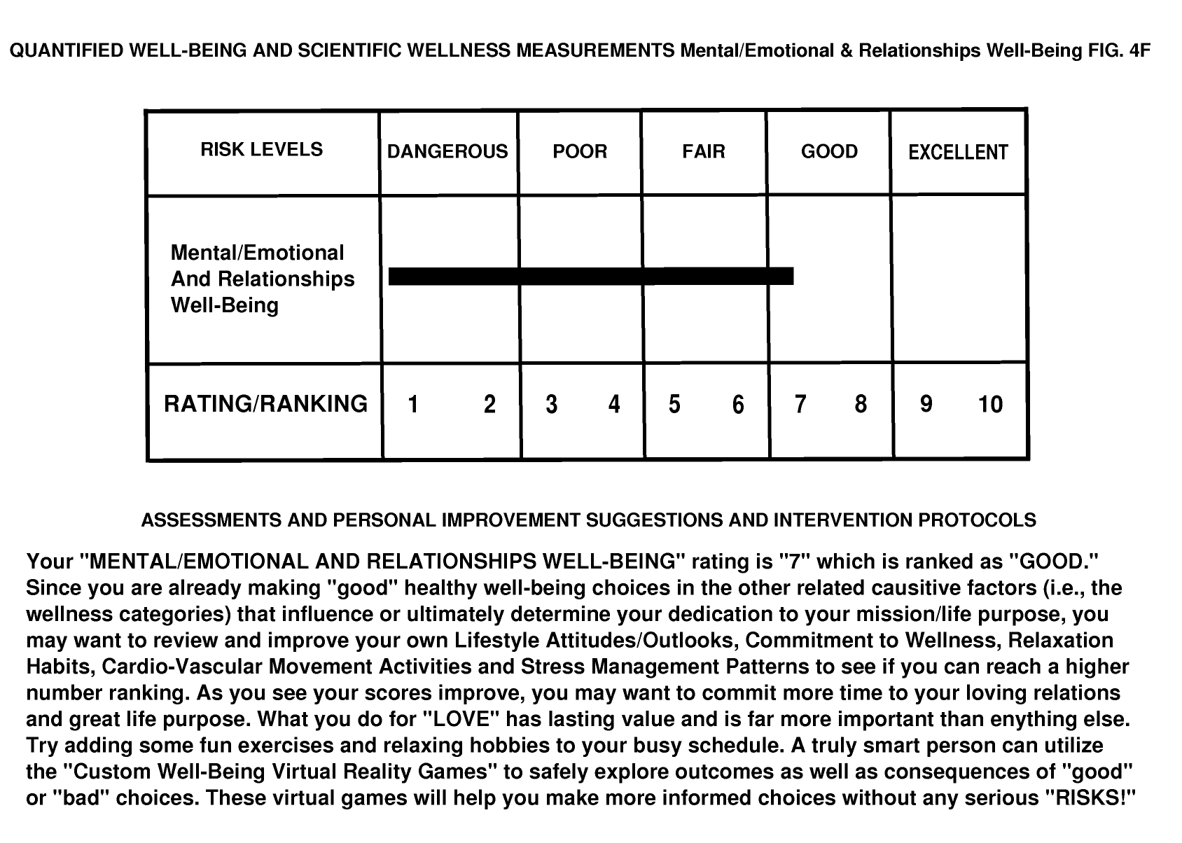

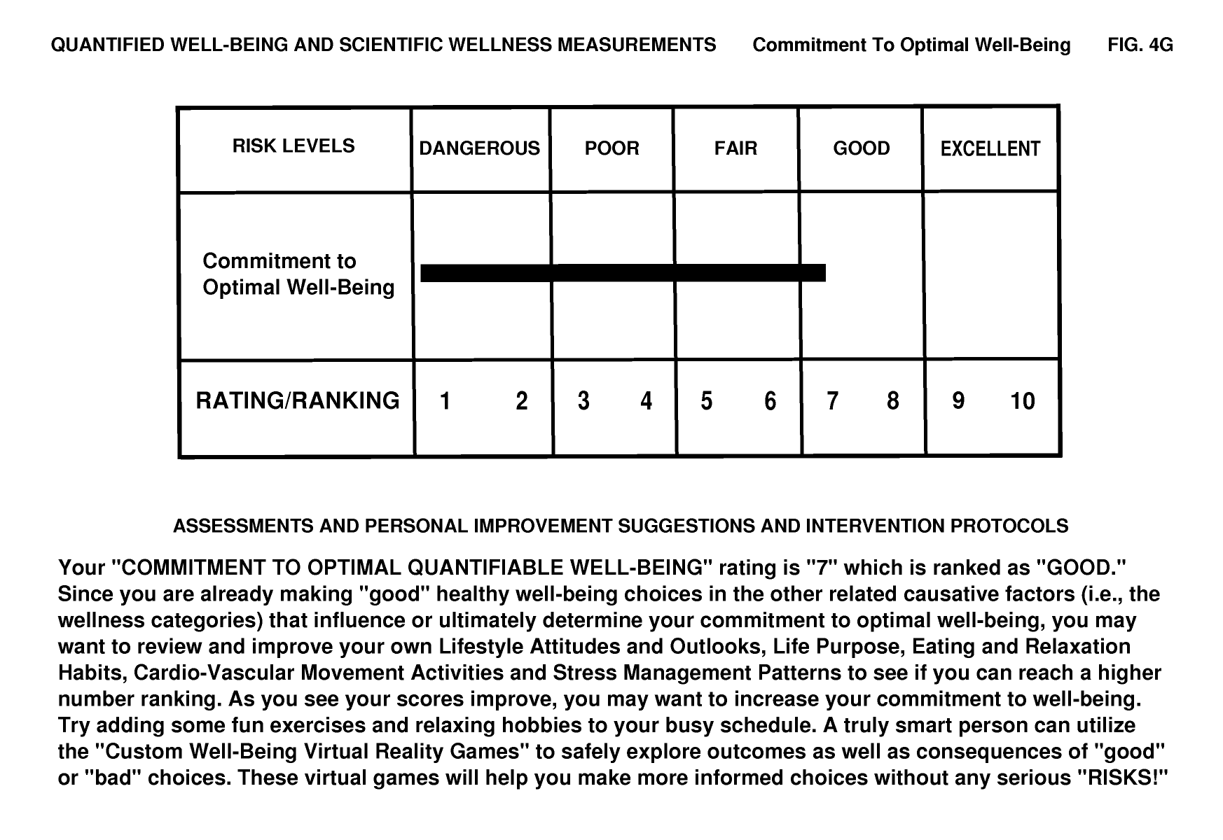

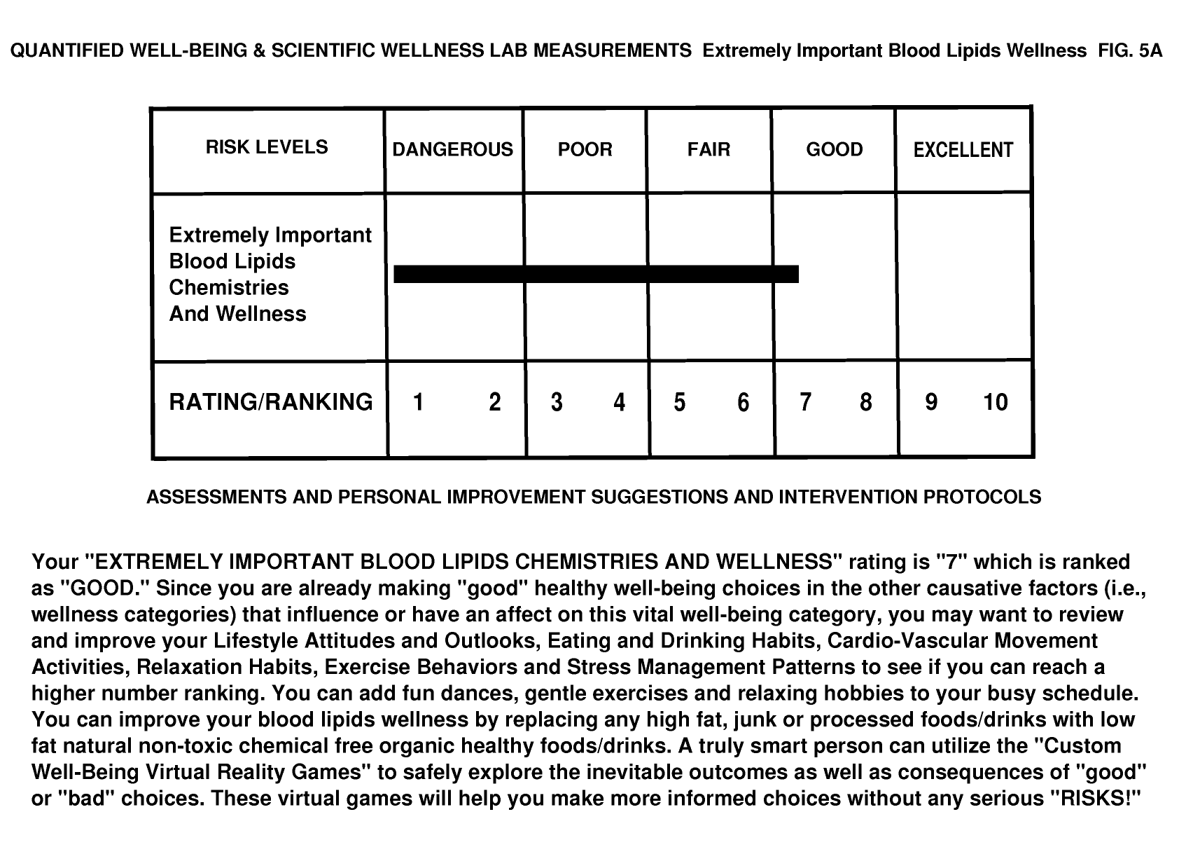

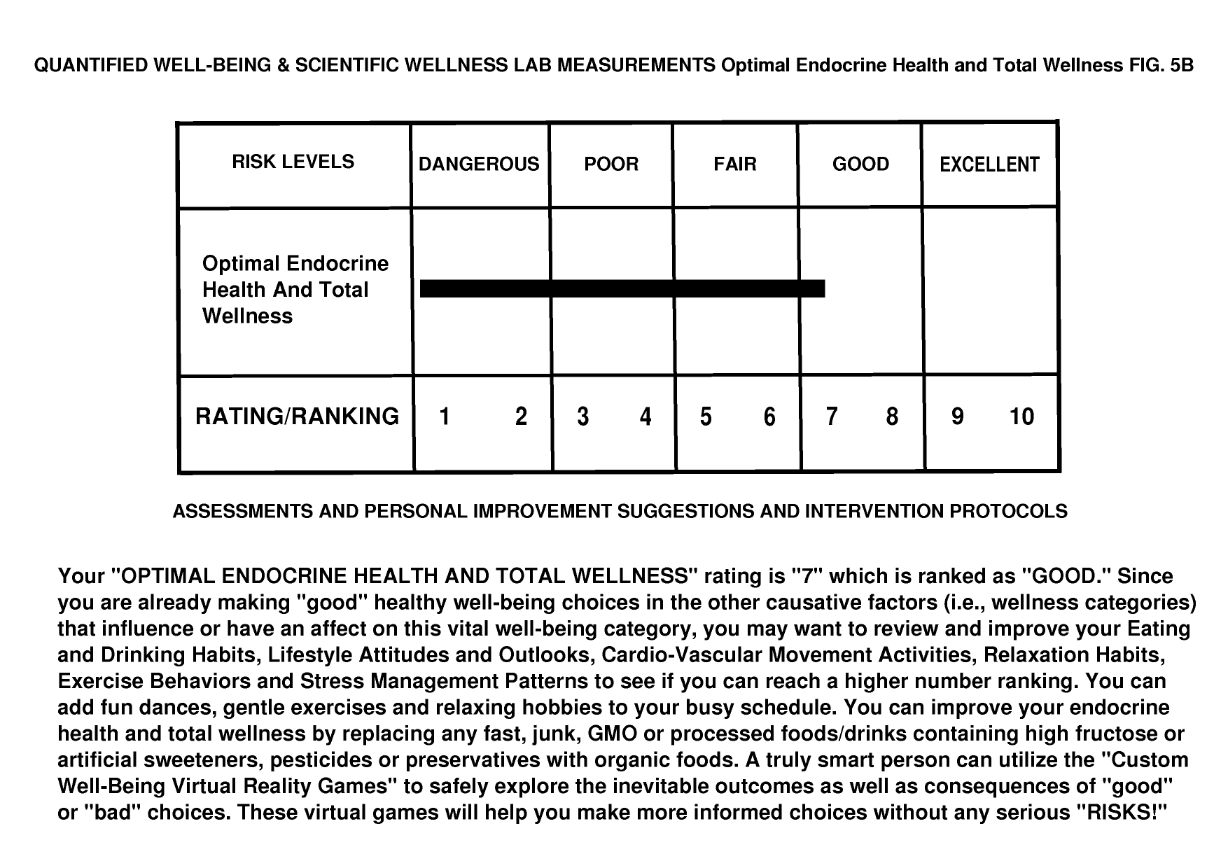

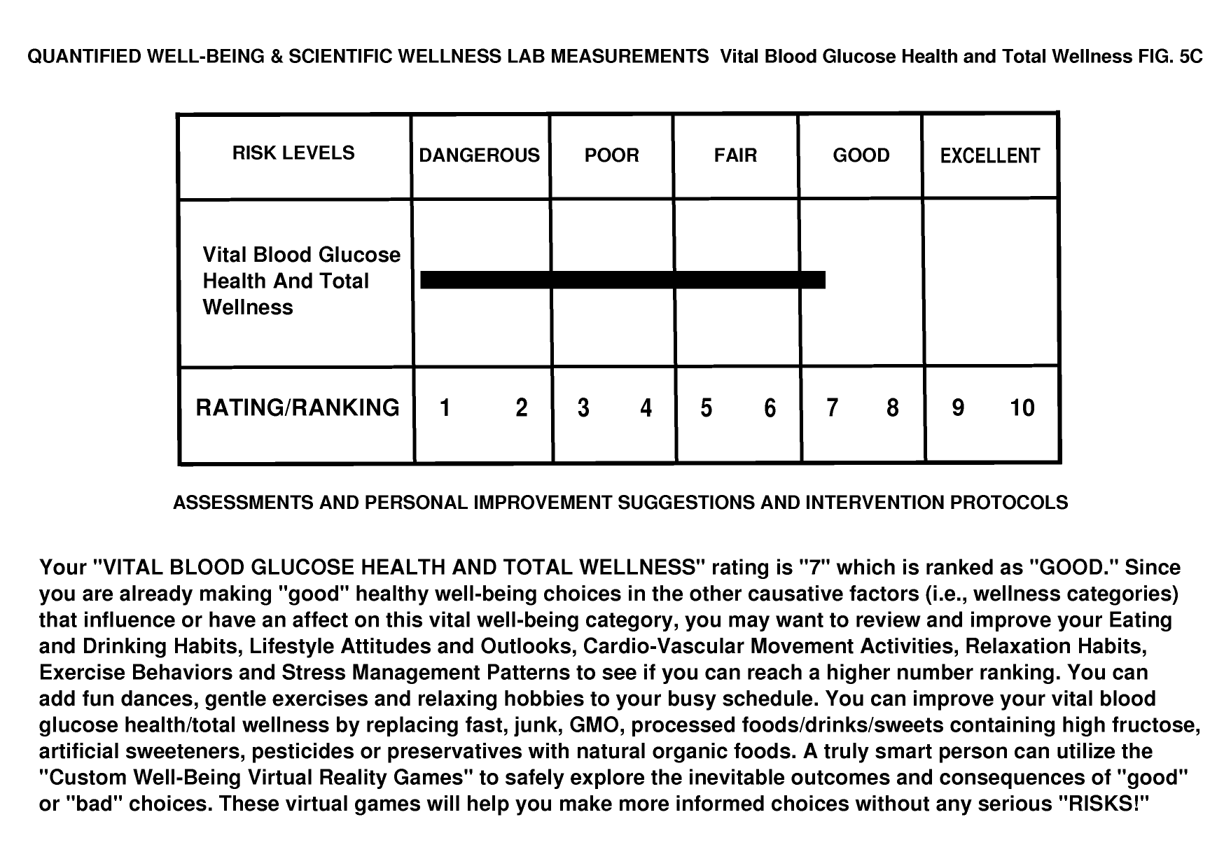

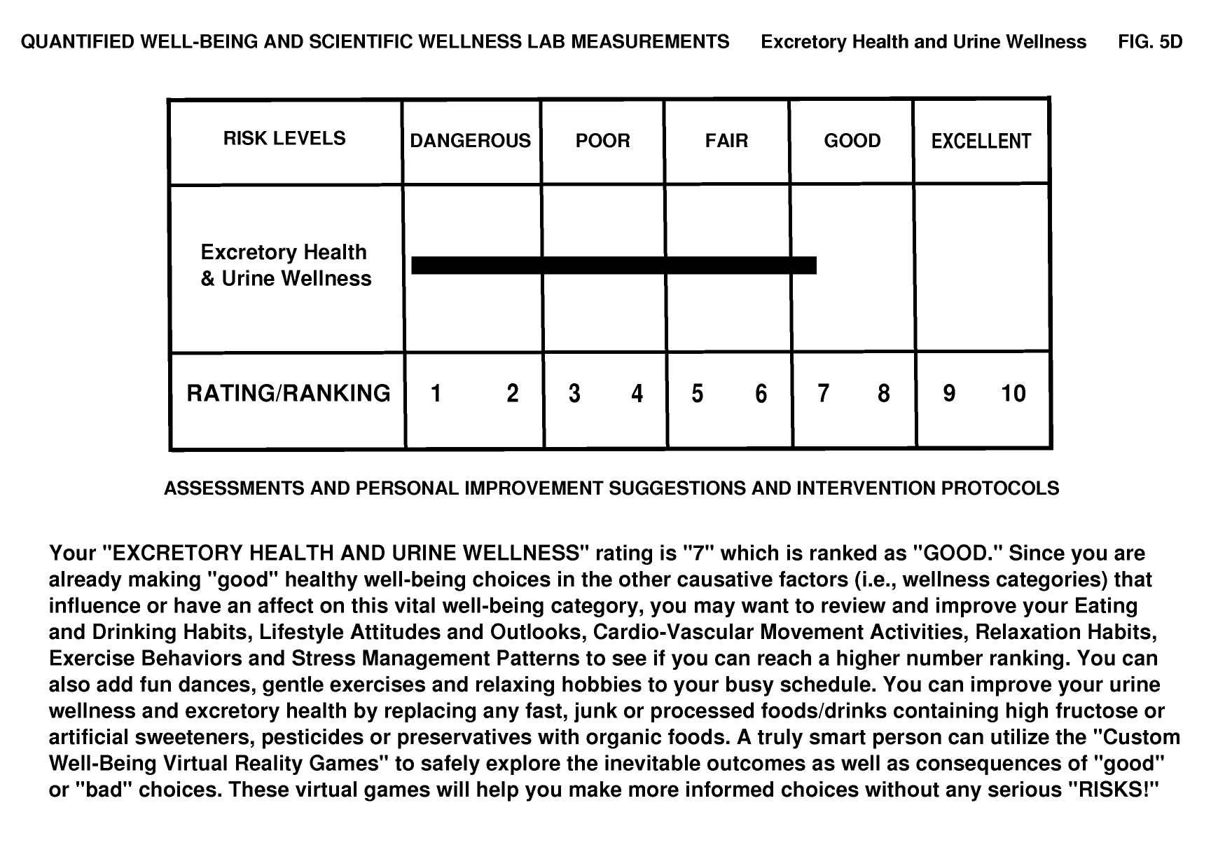

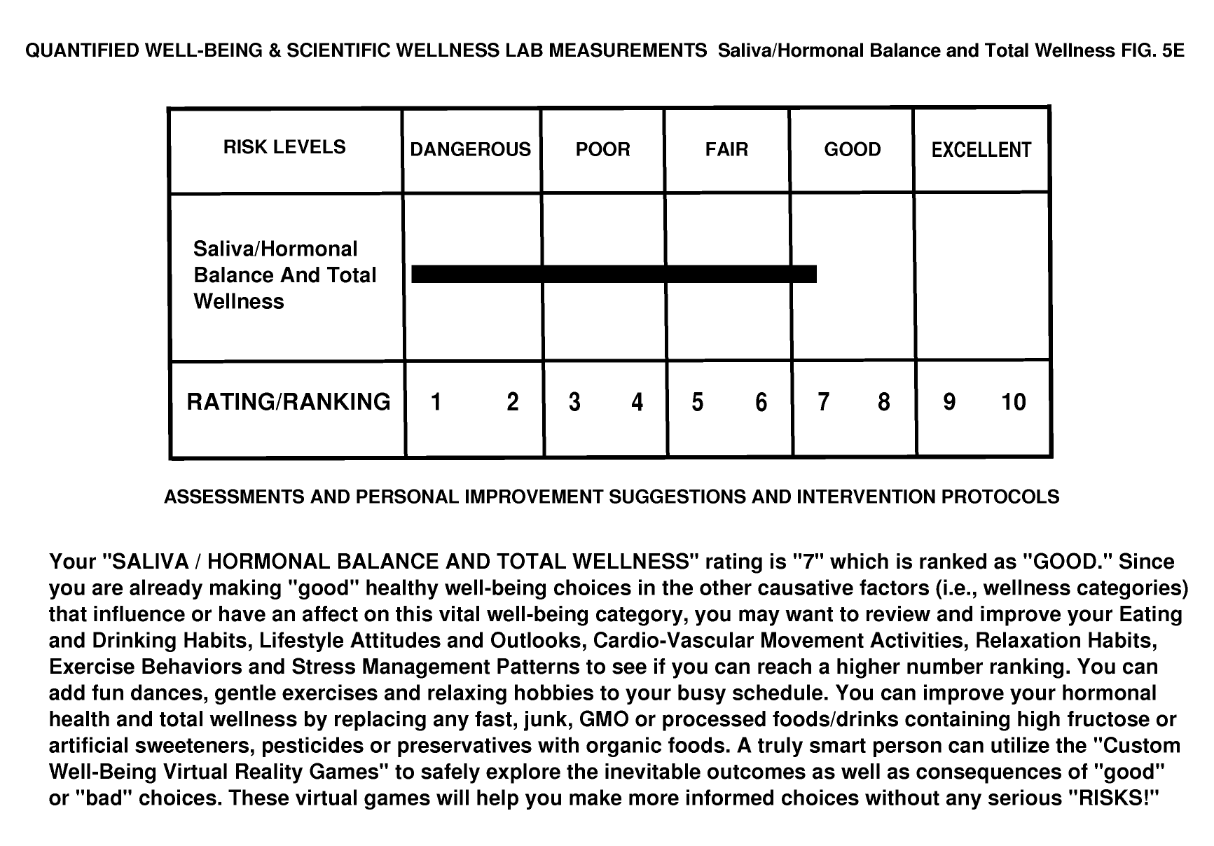

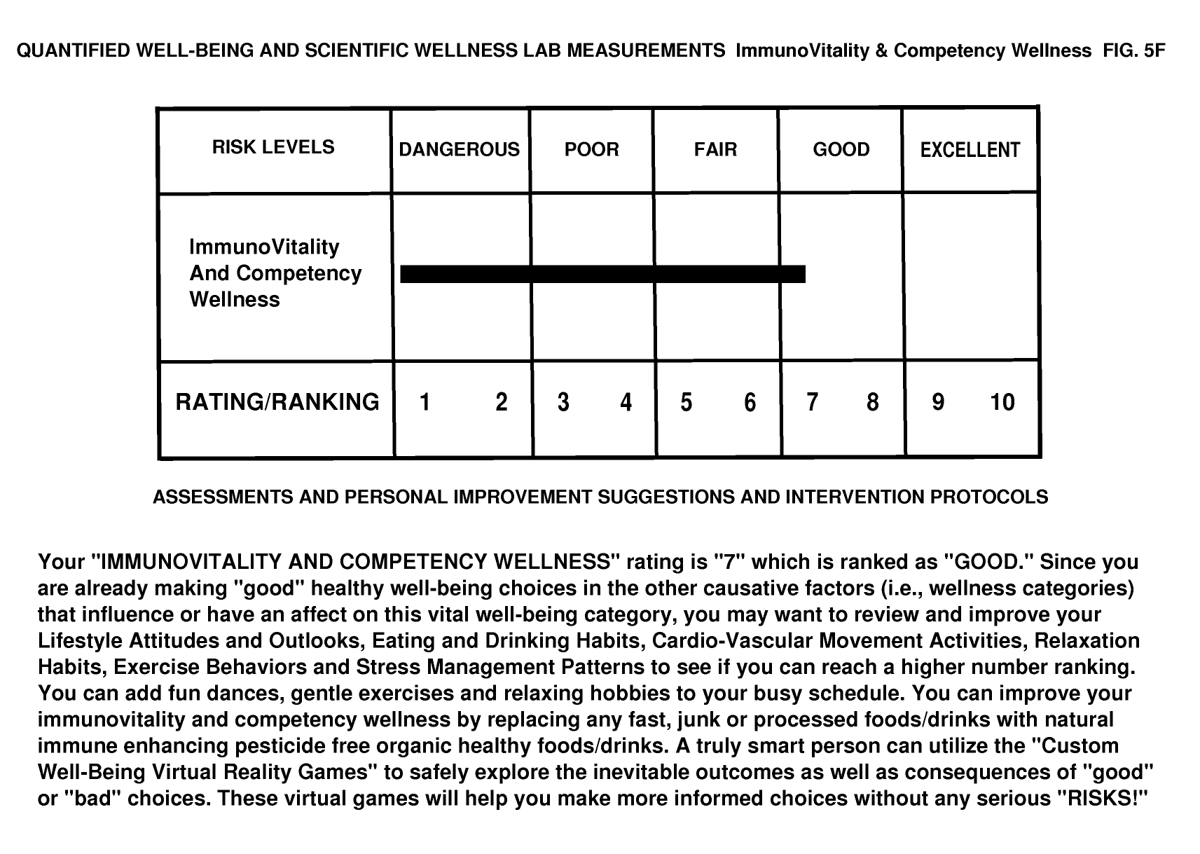

i. Bio-Physical Circulatory Pulse Wellness=FIG. 3A,
ii. Body Mass (FAT) Index=FIG. 38,
iii. Circulation Cardio-Efficiency and Wellness=FIG. 3C,
iv. Environmental Pulmonary Wellness=FIG. 3D,
v. Cardio-Diastolic and Systolic Well-Being=FIG. 3E,
vi. Great Exciting Life Purpose/Mission, Basic Attitudes and Self-Love=FIG. 4A,
vii. Spiritual Well-Being, Core Beliefs and Positive Outlooks=FIG. 4B,
viii. Nutritional Eating and Drinking Habits=FIG. 4C,
ix. Natural Health Improving Supplements=FIG. 4D,
x. Physical Exercise and Relaxational Responsiveness=FIG. 4E,
xi. Mental/Emotional, Nurturing Relationship(s) Well-Being=FIG. 4F,
xii. Commitment to Optimal Quantifiable Well-Being=FIG. 4G,
xiii. Extremely Important Blood Lipid Chemistries=FIG. 5A,
xiv. Optimal Endocrine Health and Total Wellness=FIG. 5B,
xv. Vital Blood Glucose Health and Total Wellness=FIG. 5C,
xvi. Excretory Health and Urine Wellness=FIG. 5D,
xvii. Saliva and Hormonal Balance and Total Wellness,=FIG. 5E, and
xviii. Immuno-Vitality and Competency Wellness=FIG. 5F.

New Updated Quantifiable Well-Being & Scientific Wellness Global Categories

Verifiable scientifically quantified results from a certified wellness technician's measurements, combined with an individual's self-reported assessments, and objective accurate laboratory evaluations are actuarially and mathematically compared to a unique quantifiable well-being, scientific wellness and optimal fitness database that has been updated with improved and more stringent ratings and rankings based on continued studies and assessments of modern and ancient living super-healthy longevity humans (as defined herein). This comparison objectively measures and quantifies all significant categories of quantifiable well-being and scientific wellness as well as most important pre-determined optimal ranges of validated quantifiable well-being, scientific wellness, optimal health and fitness, and/or any associated genetic and/or medical risk-related knowledge and levels on a series of new stringent improved and updated 10-Point Scales. Only the bottom three rankings (“1”-“3”) of the 10-Point Scales are related to illness, diseased or deadly (morbidity or mortality) conditions. The middle four ranking points (“4”-“7”) are linked to average functional people, but the top three super-well-being points (“8”-“10”) are only related to validated quantifiable well-being, scientific wellness, optimal health and ideal fitness levels.

The new, updated and improved invention has added some additional assessment categories to more accurately and better quantify the most important categories and creative vital aspects of this innovative invention so that it is able to provide a more complete and comprehensive report with validated and verified interpretations, pertinent improvement suggestions, associated recommendations and follow-up interventions that can be computer generated and then downloaded and/or communicated to the individual highlighting specific areas and categories of quantifiable well-being and measurable scientific wellness which can be gradually improved in spite of any identifiable inherited genetic and/or medical risk-related conditions and risk factors (if any), plus pertinent reasonable choices, options and customized recommended corrective measureable improvement strategies.

In addition, the new, innovative, novel, updated and improved embodiments of the present invention provide participants with new, innovative, novel, updated and improved “Virtual Reality Scientifically Accurate Customized Fun Well-Being and Scientific Wellness Computerized Video (3D) Games” that allow participants to become involved in a series of games that uniquely and graphically demonstrate to the viewing participant the probable or guaranteed outcomes and consequences of either self-improvement or self-destructive lifestyle choices. By taking full advantage of the measuring and improvement suggestions and the customized information provided through the “Validated Quantifiable Well-Being and Scientific Wellness Scales” a truly smart individual can self-educate themselves by experimentation utilizing the various intervention protocols to create new and improved ways to cope with life's many surprises and unprecedented challenges. Additionally, participants can learn from the new, exciting adventurous “Virtual Reality Scientifically Accurate Customized Fun Well-Being and Scientific Wellness Computerized Video (3D) Games” that are a key embodiment of this invention by following the probable scenarios of alternatively choosing apparent positive and/or clearly negative choices in the game's adventures (dramas) which can lead to realistic probable outcomes and consequences. Smart people can take advantage of this new high-tech self-educational system that was researched, designed and developed by scientifically trained well-being/wellness and longevity experts will ultimately result in many personal well-being and scientific wellness rewards. The intrinsic beauty of this new virtual reality self-educational game is that a person can explore realistic life experiences and dramas and their probable outcomes and consequences without any serious or devastating personal well-being and/or scientific wellness damages. Over time, one can learn to improve their own personal well-being and scientific wellness scores to the point that they can share their successes with family, friends and business associates.

This new, novel, unusual and innovative unique embodiment of the present invention provides the participant with one of the most powerful and safe, motivating educational experiences possible in this high-tech world of virtual reality games (that are generally mainly focused on extremely negative killing and destroying activities, skills, choices and actions rather than any positive constructive, building, nurturing or loving actions and choices). This gaming feature of the present invention will set it apart from most of the “Destructive Killer-Rewarded Virtual Reality Games” currently popular and available in the lucrative world gaming markets. The positive impact potential that the present invention has on future generations of impressionable young minds and hearts is both exciting and awesome. The present invention has the realistic potential of reprogramming the ugly, psychologically dangerous influences that the present negative-oriented video games have on young or mature minds to a more positive mind set for a future sustainable environment and world. Many of the all too frequent prime time negative news stories that report on the modern scary destructive frightening actions and behaviors of crazed, dangerous and evil murders, killers, rapists, suicide bombers, terrorists, insane perpetrators of hideous crimes against others, may be a serious contributing factor to the increasing incidents of such crimes against humanity. Numerous researchers are convinced that involvement in these dark, negative rewarding video games is a major contributing educational factor that provides the criminal viewer with many creative murderous ideas that can be directly correlated to the individual's exposure to and involvement in such destructive killer-oriented video games and Internet Apps. The fact that the super-hero may be a good guy that is usually depicted as a valiant warrior and person trying to save the world becomes insignificant because even his creative and superior abilities to kill the targeted enemy have little redeeming value when one considers the consequences of exposing a sick devious criminal mind to any ingenious killer tactics that might be used by the terrorist against his perceived, real or imaginary enemies. It is a most unfortunate, alarming and sad observation of the wide spread social illnesses in our war oriented world to realize that most of the biggest profits in these high-tech video games go to the popular geeks, developers and production companies of the most insidious killer video games on the market. Except for the insane criminal terrorists and religious fanatics, there are very few global problems that can be realistically solved by more and more wars or better and more deadly weapons of destruction.

The benefits of tracking measurable quantifiable, well-being improvements, scientific wellness levels and/or positive changes in measured levels of any potential identifiable inherited genetic and/or medical risk-related conditions and risk factors (if any), at set intervals allows smart, proactive people a consistent and unique objective measurement and tracking system for many years of both positive improvements and any deteriorating negative changes in medical risk levels long before any such hidden or pending risks become dangerous or life threatening.

### Updated Improved Descriptions of the Drawings Embodied in this Invention

The new, updated and improved invention is further described in detail and pointed out with particularity in the appended claims. However, other advanced unique features of the invention will be best understood and appreciated by referring to the following detailed descriptions of the preferred drawing embodiments.

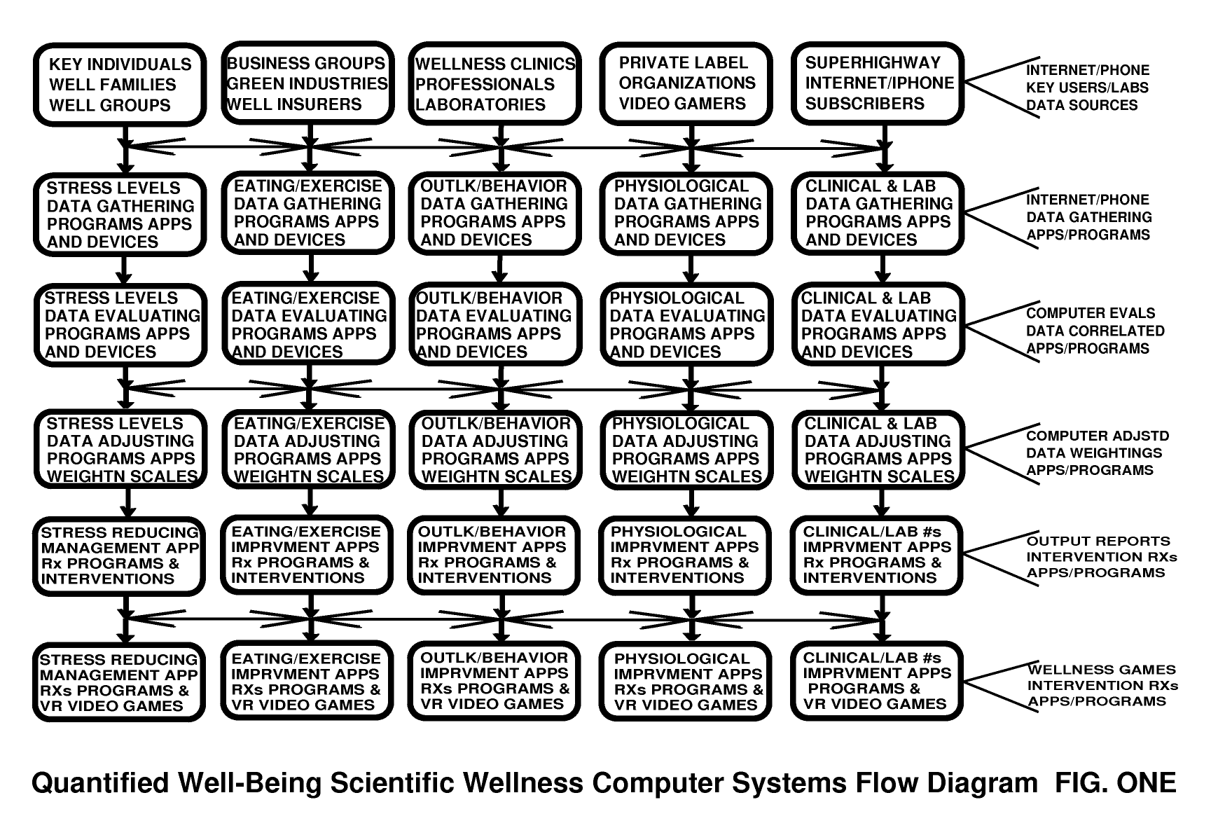

FIG. 1 is a graphic and comprehensive schematic diagram of the various input data sources, the internal computerized evaluations, comparisons, cross-correlated dynamics and components, the system and programs showing the interconnections and the unique comparative evaluative correlations between each category required by the updated/improved and more stringent quantifiable well-being and measurable scientific wellness measuring and tracking systems. In this FIG. 1 depiction, an embodiment of the invention has been chosen for the purpose of illustration only, the methods of preparing the more stringent quantifiable well-being and measurable scientific wellness assessments involves the integration and employment of many different data gathering sources, devices, apps, Internet downloads, forms, questionnaires, documents and sources of stringent quantifiable well-being and measurable scientific wellness information and any potential identifiable inherited genetic and/or medical risk-related conditions and risk factors (if any) or data. These contrasting correlations and comparisons begin with a pre-determined battery of lifestyle evaluations of certain technician administered bio-physiological pulses, body mass index (BMI), standard blood pressures, circulation cardio-efficiency and environmental pulmonary wellness measurements of scientifically measured technician administered clinical bio-physiological pulse, BMI, standard blood pressures, circulation cardio-efficiency and environmental pulmonary wellness measurements of scientifically measured optimal wellness levels and any inherited genetic and/or medical risk-related conditions and risk factors (if any), combined with unique updated improved and more stringent quantifiable well-being parameters, including customized lifestyle assessments of life purposes and missions, personal outlooks and core beliefs, lifestyle attitudes and habits, spiritual values, nutritional eating and drinking habits, movement and physical exercise behaviors, relationship wellness dynamics as well as other lifestyle indicators of scientifically measured and validated wellness and ideal fitness as well as any inherited genetic and/or medical risk-related conditions and risk factors (if any) combined with unique quantifiable, updated total well-being parameters, psychological behaviors and habits.

The data from the unique updated improved and more stringent quantifiable well-being parameters, including customized lifestyle assessments of life purposes and missions, personal outlooks and core beliefs, lifestyle attitudes and habits, spiritual values, nutritional eating and drinking habits, movement and physical exercise behaviors, relationship wellness dynamics as well as other lifestyle indicators and parameters can be collected from a series of new, novel and advanced data gathering phone apps, tablets, PCs, Internet connections, forms, devices and documents. The subjective unique updated improved and more stringent quantifiable well-being parameters, including customized lifestyle assessments of life purposes and missions, personal outlooks and core beliefs, lifestyle attitudes and habits, spiritual values, nutritional eating and drinking habits, movement and physical exercise behaviors, relationship wellness dynamics as well as other lifestyle indicators and parameters of data is then combined with the more scientific objective measured data collected from a series of validated laboratory objective internal Biological and Physio-Chemically analyzed body fluids, including: Extremely Important Blood Lipid Chemistries, Total Endocrine Health and Well-Being, Vital Blood Glucose Wellness, Saliva, Excretory and Urine Wellness, Vital Hormonal Balance and Wellness, Immuno-Vitality, and Competency Health. This lab data is integrated and combined with the technician administered clinical bio-physiological pulses, body mass index (BMI), standard blood pressures, circulation cardio-efficiency as well as environmental pulmonary wellness and the self-reported customized lifestyle assessments.

The present invention also can accept and integrate verified information/data from special data gathering apps, programs and devices that have been designed for each major category to check the validity of the gathered data before it is transferred into the specific processing areas of the updated, improved and advanced evaluation and quantifying programs. In order to insure the most accurate and meaningful evaluations, correlations and comparisons, each of the data gathering sources and evaluation/quantification programs has been customized to check for validity in order to meet the special needs of objectively quantifying and analyzing the various types of data being processed. The evaluation/quantification programs compare and contrast the improved gathered data methods to all the corresponding gathered updated data areas as well as to the major evaluation and processing areas of the exclusive proprietary Quantifiable Well-Being and Scientific Optimal Wellness Data Bases.

Next, the evaluation programs process the data according to specific updated and improved formuli and algorithms and then create an adjusted updated and weighted data output. The adjusted and weighted data outputs are fed to a series of customized updated output programs which generate special customized Output Reports that include both picturegraphic analyzes, improvement suggestions and specific intervention recommendations on a multiple-page customized output App or a printout of individualized RXs for improving and/or maintaining specific quantifiable well-being and measurable scientific wellness ranking levels on the unique updated 10-Point Quantifiable Well-Being and Scientific Optimal Wellness Scales. The output follow-up programs, also may utilize a more stringent and advanced updated wellness data bank in which is stored a multiplicity of suggestions, recommendations and improvement protocols designed to fit as many comparative combinations as possible of the different circumstances which are likely to be made, referenced to by the gathered evaluated, adjusted and weighted quantifiable well-being and measurable scientific input data. Specific items of information can be highlighted in the participant's individualized Output Report so that each of the important quantifiable well-being and measurable scientific rankings are graphically and easily understood when combined with the participant's multiple-page scientific wellness output app or report with recommendations and summary, and at the same time relate personally to the participant's technician measured, “self-assessed” and objective laboratory analyzed data and information.

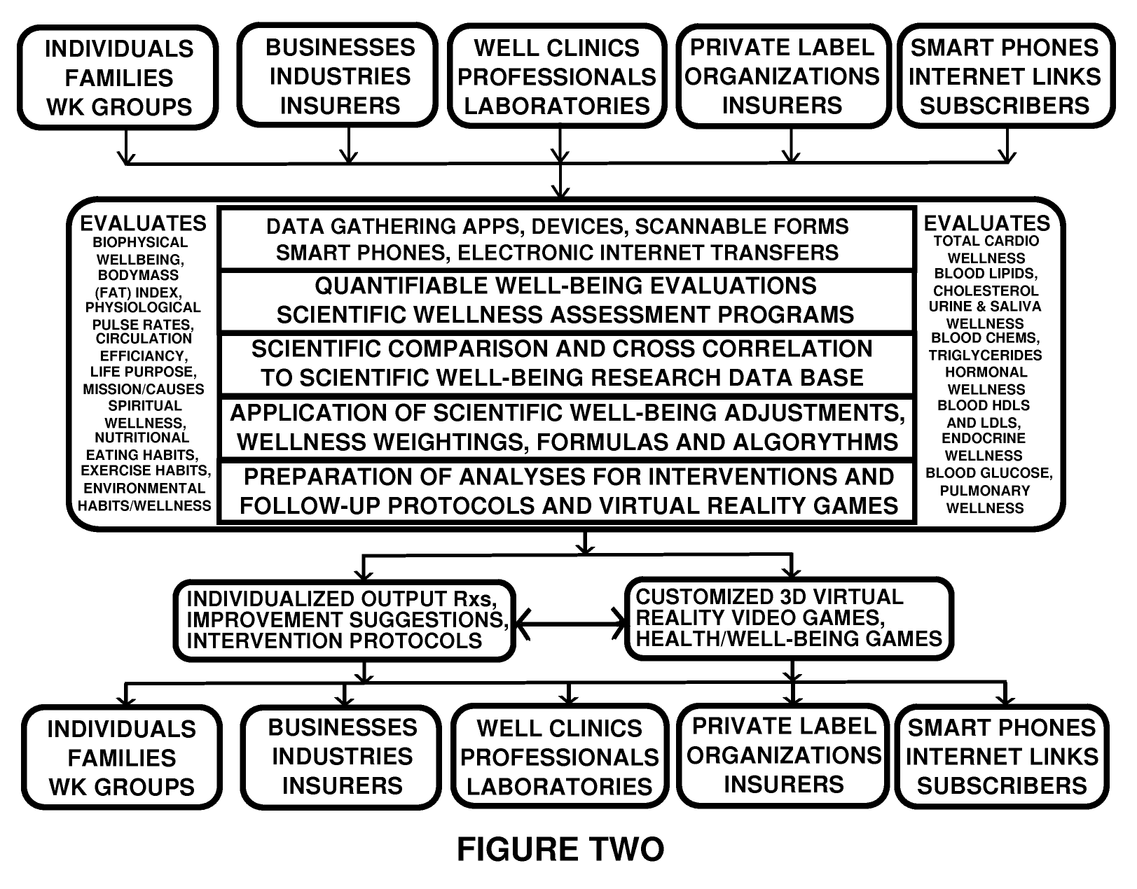

FIG. 2 shows a schematic block diagram illustrating the new updated improved preferred embodiment of the advanced novel unique sophisticated data processing, correlating software systems, apps and programs incorporating many different data gathering devices, apps, forms, questionnaires, documents and sources of both specific quantifiable well-being and measurable scientific wellness ranking levels and risk data. These may include some or all of the following: (1) mathematically and actuarially objective cross-correlated bio-physiological tests and measurements that are scientifically measured and validated wellness and ideal fitness evaluations from various data gathering apps, forms, devices, documents and sources, and recorded by uniquely trained and certified wellness technicians; (2) subjective cross-correlated self-reported assessments of updated improved and more stringent quantifiable well-being parameters, plus the scientifically measured and validated wellness and ideal fitness evaluations as well as any inherited genetic and/or medical risk-related conditions and risk factors (if any) collected from a variety of data gathering apps, Internet downloads, forms, devices, questionnaires, documents and sources; and, (3) the most accurate and objective scientific cross-correlated laboratory state-of-the-art unique, updated, improved and more stringent quantifiable well-being parameters, plus the scientifically measured and validated wellness and ideal fitness laboratory evaluations as well as any inherited genetic and/or medical risk-related conditions and risk factors (if any) of internal quantifiable well-being parameters from a variety of data gathering apps, Internet downloads, forms, devices, documents and sources entered and/or merged with said laboratory electronic data transfer into the Quantifiable Well-Being and Scientific Optimal Wellness Database System of the present invention.

All of the quantifiable well-being and scientific wellness data is compiled; checked for validity; stored as an inventory of quantifiable well-being and total wellness, super-health, ideal fitness and risk-related information and knowledge; and, then evaluated, analyzed and compared to the quantifiable well-being and optimal wellness databases. The software systems and programs are capable of rapid data input of quantifiable well-being, objective wellness and laboratory data entry and processing. The individualized output, quantifiable well-being and scientific wellness reports contain a series of visual depictions each having analysis information categorized on the 10-Point Quantifiable Well-Being and Scientific Optimal Wellness Scales as well as highlighted suggestions, recommendations and improvement protocols that are graphically portrayed and can either be sent to a computer, tablet or phone App, printed on compatible printers or downloaded for processing by a high-speed computerized printing service company. Collecting accurate, validated and verifiable quantifiable well-being data has demonstrated to be of surprising importance, because it often determines whether the participant will make any positive behavior or habit changes to improve their achievable levels of measured quantifiable well-being, optimal wellness, super-health and ideal fitness levels and/or reduce any inherited genetic and/or medical risk-related conditions and risk factors (if any).

Quantifiable Well-Being and Scientific Wellness have 3 Important Major Areas

The “Unique More Stringent Quantifiable Well-Being, Optimal Wellness, Super-Health and Ideal Fitness Parameters” for the 10-Point Quantifiable Well-Being, Scientific Wellness, Optimal Health and Ideal Fitness Scales fall into three major areas which can be tested, correlated, evaluated, updated and improved “actuarially, mathematically, scientifically and objectively.” These Three (3) Major Unique, More Stringent, Quantifiable Well-Being, Optimal Wellness, Super-Health and Ideal Fitness Areas provide sufficient accurate, objective and believable ranking or rating information to assist smart individuals in making optimally healthy informed decisions in all the important areas of Quantifiable Well-Being, Optimal Wellness, Super-Health and Ideal Fitness Parameter choices.

The First (1^{st}) group of 10-Point “Wellness Technician Measured” and updated quantifiable “Bio-Physiological Well-Being Parameters” of Super-Health and Ideal Fitness Levels include: “bio-physical pulse wellness, body mass (fat) index, circulation cardio-efficiency, environmental pulmonary wellness, and cardio-diastolic and systolic well-being.” The assessments of these measured categories are based on the unique, updated, improved and more stringently validated quantifiable well-being, scientific wellness, optimal health and fitness database as well as any genetic and/or medical risk-related conditions and risk factors (if any) of associated data. The Second (2^{nd}) more subjective set of 10-Point “Assessed” Quantifiable Well-Being and Scientific Wellness Parameters are the self-reported “lifestyle, mission, spiritual well-being, attitudes, outlooks, habits and usual behaviors, nutritional and exercise habits, nurturing relationship wellness and commitment to well-being.” The Third (3^{rd}) group of Categories and Parameters are certain more accurate, objective “Laboratory Analyzed, Hidden Inside, Measurements of Comprehensive Biological and Physio-Chemistry Laboratory Tests and Evaluations” of analyzed validated correlated body fluids are even more stringent physiological and biochemical laboratory analyzed data categories as quantifiable parameters comprising: “extremely important blood lipid chemistries, total endocrine health and well-being, vital blood glucose wellness, saliva, excretory and urine wellness, vital hormonal balance and wellness, and immuno-vitality and competency health.

Together, these updated and improved more stringent Parameters comprise the “Three (3) Cross-Correlated Major Groups, Categories and Parameters of Super-Health, Optimal Wellness, Quantifiable Well-Being and Ideal Fitness” which objectively quantifies a person's level of Quantifiable Well-Being, Scientific Optimal Wellness and Ideal Fitness as well as any inherited genetic and/or medical risk-related conditions and risk factors (if any). In addition, these Three (3) Categories also actuarially and mathematically evaluate one's present and potential future of major and minor “Health Risk Factors” and serve as early predictors and/or indicators of the earliest possible detection of potential serious sicknesses and/or diseases.

FIGS. 3A-3E: Bio-Physiological Clinical Measurements of Well-Being

Of equal and perhaps greater importance than all the “Self-Reporting Parameters” herein (with the exception of an “Important Life Purpose/Mission”), are the major important, objective wellness technician assessed Bio-Physiological Well-Being measurements for simply and accurately measuring a person's level of stringent validated quantifiable well-being, scientific wellness, optimal health and fitness as well as any genetic and/or medical risk-related conditions and risk factors (if any). These Bio-Physiological Well-Being tests are designed so that no one can cheat on them. A few people seem to be able to mentally focus and thus lower their systolic cardiovascular measurement and/or their sedentary pulses.

However, most people, even trained athletes, cannot usually maintain a lower number on these tests while being evaluated by a wellness technician. Thus these Bio-Physiological Well-Being Parameters usually provide a reasonable, accurate Updated Stringent Quantifiable Well-Being, Super-Health, Optimal Wellness and Ideal Fitness Evaluation as well as being a good indicator of any Genetic and/or Medical Risk-Related Conditions and Risk Factors (if any). This is not true of the following self-reported “lifestyle, mission, spiritual well-being, attitudes, outlooks, habits and usual behaviors, nutritional and exercise habits, nurturing relationship wellness and commitment to well-being parameters” which are highly dependent upon a person's memory, truthfulness and/or accuracy of remembering details, self-perception and responding to the assessment questionnaire, whether it is on a smart phone App, on a touch screen computer, on a form or questionnaire or document to be filled out. But almost no one can quickly change or cheat on the measurements of these Bio-Physiological Well-Being Parameters, so this type of evaluation can generally be an empirically accurate quantifier of updated, measured quantifiable “Bio-Physiological Well-Being” parameters.

These Bio-Physiological Tests Assure Greater Accuracy of Other Parameters

The most innovative aspect of these updated state-of-the-art improved objective tests (i.e., the Bio-Physiological Well-Being measurements) is that all of them have been cross-correlated over the last four decades of scientific research to the entire panel of the Bio-Physiological Well-Being Parameters. In the process of mathematically evaluating such cross-correlations for actuarial statistical significance, an interesting phenomenon was discovered. When a person entered data on a the computer or filled out a form, questionnaire or document and/or told a technician about their attitudes, outlooks, commitment to wellness, and eating habits, how often they exercised or how vigorously they exercised, their use of substances, etc.; the accuracy of their responses was magically increased to near perfect truth, when telling that person that their Bio-PhysioLabChemistry Well-Being Parameters (cholesterol, HDL, LDL, triglycerides or glucose) would also be measured in the near future. This generally was also true if a body fat measurement, or a stress temperature dot circulation efficiency assessment was going to be taken by a technician within 48 hours. When the individual knew such measurements were certain, they became extremely honest, told the bottom line truth (even if damaging to their fantasy health image) on what their “lifestyle, mission, spiritual well-being, attitudes, outlooks, habits and usual behaviors, nutritional and exercise habits, nurturing relationship wellness and commitment to well-being” were and the truth about whether or not they consistently had some form of exercise, with what intensity, how regular and how much. This was not generally the case if the person responded to the wellness data gathered in verbal assessments, answered the request for information on a computer, or filled out the data needed on forms, devices, questionnaires or documents without the additional evaluations being taken.

No One Can Cheat on These Objective Bio-Physiological Measurements

Regularly utilizing these “Bio-Physiological Well-Being Parameters” is probably the most important part of measuring a person's level of Quantifiable Well-Being, Scientific Optimal Wellness and Ideal Fitness as well as any inherited genetic and/or medical risk-related conditions and risk factors (if any), because almost nobody can successfully “cheat” on these measurements. Most people can't cheat or alter their objective blood pressure assessments, or their Bio-Physical Circulatory Pulse Wellness, stress temperatures, or how fat they are. Because of this, these simple objective lifestyle habits and attitudes guarantee a much greater accuracy on the Quantifiable Well-Being, Scientific Optimal Wellness and Ideal Fitness of both the psychological and the lifestyle Parameters (habits) than was ever achievable before these important new, updated and improved cross-correlations were discovered, documented, verified and validated.

This means that the Bio-Physiological Well-Being tests and measurements are some of the “most important” Parameters for measuring wellness, viz., Bio-Physiological Circulatory Pulse Wellness, Body Mass (FAT) Index, Circulation Cardio-Efficiency, Environmental Pulmonary Wellness, as well as Cardio-Diastolic and Systolic Well-Being which includes the resting and exercise heart rates, the recovery heart rates, the oxygen utilization, the blood pressure measurements, the body fat composition (the percentage of fat to muscle), the circulation efficiency stress temperature measurement (especially at the extremities), the height and weight ratio, the type of frame, urine and saliva (sputum) analyses, blood cell analyses, the vital capacity pulmonary function and the forced expiratory volume (for smokers or vapors).

Objective Bio-Physiological Tests are Useful for Monitoring Total Well-Being

These Bio-Physiological Well-Being Parameters tests and measurements are objective. Saliva is produced from glands in the mouth and is an indicator of the health and wellness of the person. Measurements are vitally important to determine one's level of Bio-Physiological Circulatory Pulse Wellness, Body Mass (FAT) Index, Circulation Cardio-Efficiency, Environmental Pulmonary Wellness, as well as Cardio-Diastolic and Systolic Well-Being at any time. All of these Bio-Physiological Parameters are ranked on a scale from “One” to “Ten.” The combination of these tests and measurements objectively determine a person's true level of Quantifiable Well-Being and Scientific Wellness. Fortunately, these objective measurements can be repeated periodically to determine any small incremental positive “desirable” or negative “unwanted” changes. In this manner, smart people who are committed to quantifying and tracking their own vital improvement(s) now have a user friendly method that is a new, advanced, novel and updated improvement embodiment of the present invention that takes the guesswork out of making informed choices as s/he decides to go for higher levels of Quantifiable Well-Being and Scientific Wellness.

FIG. 3A—Bio-Physiological Circulatory Pulse Wellness Rating Scale & Heart Rates

FIG. 3A is a reproduction of a portion of the new, updated, and improved typical, individualized and personal Quantifiable Well-Being and Scientific Wellness multicolor visual depictions and analysis information showing the participant's ranking on this 10-Point Bio-Physiological Scientific Wellness Parameter categorized and depicted as the “Bio-Physiological Circulatory Pulse Wellness Rating Scale” combined with the highlighted suggestions and recommendations that are correlated to this empirically measured and quantified specific summary evaluation and 10-Point Bio-Physiological Well-Being Scale Rating.

A new and exciting feature that is an integrated part of the follow-up improvement suggestions and intervention protocol strategies of the present invention is the inclusion of customized “Virtual Reality Scientifically Accurate Customized Fun Well-Being and Scientific Wellness Computerized Video (3D) Games, related to this category” that allows a participant to become involved in a series of games that uniquely and graphically demonstrate to the viewing participant the probable and/or guaranteed realistic outcomes and consequences of either self-improvement or self-destructive lifestyle choices specifically related to this parameter. By taking full advantage of the measurements and improvement suggestions and the customized information provided through the “Validated Quantifiable Well-Being and Scientific Wellness Scales,” a truly smart individual can self-educate themselves by experimentation utilizing the various intervention protocols to create new and improved ways to cope with life's many surprises and unprecedented challenges. Additionally, participants can learn from the new, exciting adventurous “Virtual Reality Scientifically Accurate Customized Fun Well-Being and Scientific Wellness Computerized Video (3D) Games” that are a key embodiment of this invention by following the probable scenarios of alternatively choosing apparent positive and/or clearly negative choices in the game's adventures which can then lead to realistic probable outcomes and consequences. Smart people who take full advantage of this brand new high-tech, self-educational system that was researched, designed and developed by scientifically trained well-being/wellness and longevity experts will ultimately result in many personal well-being and scientific wellness rewards. The beauty of the custom virtual reality self-educational games is that a person can explore realistic life experiences and dramas and their probable outcomes and consequences without any serious, painful or devastating personal well-being and/or scientific wellness damages. Over time, one can learn to improve their own personal well-being and scientific wellness scores to the point that they can share their successes with family, friends and business associates.

Resting, Activity and Recovery (Pulse) Heart Rates—FIG. 3A The new, novel, unique and improved method of the present invention fully measures all of the different heart rates of the Bio-Physiological Circulatory Pulse Wellness Rating Scale in order to determine the relative beats per minute, or the number of times per minute that the heart makes a contraction and pumps blood through the arteries of the cardiovascular system. There are three (3) types of Bio-Physiological Circulatory Pulse Wellness/Fitness Rating Scales (i.e., resting, exercise, and recovery) that can be measured. To determine the optimal or best ideal levels of Bio-Physiological Circulatory Pulse Wellness is assessed by a wellness technician measurement. The “resting rate” is the most important number to assess for Bio-Physiological Circulatory Pulse Wellness, because that is the number of pulses per minute when a person is actually sedentary or lying down. The sedentary pulse or resting heart rate generally indicates a person's level of overall total-body cardiovascular efficiency and stress levels.

Beats Per Minute Show Level of Wellness—FIG. 3A

The number of beats per minute in a “resting heart rate” will give an indication of the person's level of optimal Bio-Physiological Circulatory Pulse Wellness. It will also indicate what their level of stamina and condition are. It may be important to also know the “exercise heart rate.” This is often adjusted based on an individual's age and level of condition. If a person is really in good physiological shape, then s/he can raise that exercise heart rate to a higher endurance level than one who has not exercised in many years and is willing to begin exercising. There is an appropriate ultimate target percentage for the “exercise heart rate” (which is generally 80%) that is commonly used as the ideal target rate for everyone whether currently involved in an improvement program or in a maintenance program based on their level of exercise ability and their present age.

Wellness researchers and certified trained technicians have looked with a great deal of interest at the speed (number of minutes or longer) with which a person being evaluated reaches their “exercise heart rate” and then returns to the resting rate after that person has been exercising vigorously for a pre-determined length of time (usually 15 to 20 minutes). This is called a “recovery heart rate.” It indicates the internal, hidden well-being, scientific wellness and fitness level of the person being measured, and how fast the cardiovascular system and the heart are able to return back to the “resting pulse rate” after vigorous exercise. Because the resting pulse is ultimately affected by the average exercise and recovery heart rates, it is the primary, personal Quantifiable Well-Being and Scientific Wellness measurement that is generally measured and tracked to indicate the efficiency of the entire cardiovascular system.

FIG. 3B—Body Mass (Fat) Index or Percentage is more Important than Weight

FIG. 3B is a reproduction of a portion of the new, updated and improved typical, individualized and personal Bio-Physiological Well-Being and Scientific Wellness multicolor visual depictions and analysis information showing the participant's ranking on this 10-Point Bio-Physiological Well-Being and Wellness Parameter categorized as the “ ” combined with the highlighted suggestions and recommendations that are correlated to this specific Body Mass (FAT) Index summary evaluation on the updated/improved 10-Point Bio-Physiological Well-Being Scale Rating.

A new and exciting feature that is an integrated part of the follow-up improvement suggestions and intervention protocol strategies of the present invention is the inclusion of customized “Virtual Reality Scientifically Accurate Customized Fun Well-Being and Scientific Wellness Computerized Video (3D) Games, related to this category” that allows a participant to become involved in a series of games that uniquely and graphically demonstrate to the viewing participant the probable and/or guaranteed realistic outcomes and consequences of either self-improvement or self-destructive lifestyle choices specifically related to this parameter. By taking full advantage of the measurements and improvement suggestions and the customized information provided through the “Validated Quantifiable Well-Being and Scientific Wellness Scales,” a truly smart individual can self-educate themselves by experimentation utilizing the various intervention protocols to create new and improved ways to cope with life's many surprises and unprecedented challenges. Additionally, participants can learn from the new, exciting, adventurous “Virtual Reality Scientifically Accurate Customized Fun Well-Being and Scientific Wellness Computerized Video (3D) Games” that are a key embodiment of this invention by following the probable scenarios of alternatively choosing apparent positive and/or clearly negative choices in the game's adventures which can then lead to realistic probable outcomes and consequences. Smart people who take full advantage of this brand new high-tech, self-educational system that was researched, designed and developed by scientifically trained well-being/wellness and longevity experts will ultimately result in many personal well-being and scientific wellness rewards. The beauty of the custom virtual reality self-educational games is that a person can explore realistic life experiences and dramas and their probable outcomes and consequences without any serious, painful or devastating personal well-being and/or scientific wellness damages. Over time, one can learn to improve their own personal well-being and scientific wellness scores to the point that they can share their successes with family, friends and business associates.

The next really important measurement is the Body Mass (FAT) Index. This is a measurement where a certified wellness technician actually measures the percentage of Body Mass (FAT) Index in the body right under the skin. This is best done (for accuracy) by a trained and certified wellness technician with high-quality calipers. The caliper measurement, if done by a highly qualified technician will generally get as close as 97% accuracy on subcutaneous fat measurements. It is also probably one of the easiest unique, updated, improved and more stringent, validated, quantifiable well-being, scientific wellness, optimal health and fitness measurement as well as any genetic and/or medical risk-related conditions and risk factors (if any) to do. There is one other validated measuring system that is accurate (other than with the calipers) which can be done to measure this body mass (fat) index or composition. It is the hydrostatic or underwater weighing, and is considered to be the most accurate, but it also takes the most time and is the most costly.

Measuring Body Mass (FAT) Index is very important in terms of total wellness because this is an indicator of the level of Quantifiable Well-Being and Scientific Wellness throughout the entire body. It is a measurement to determine the Quantifiable Well-Being and Scientific Wellness of one's body because the greater amount of fat in the body, the less likely an individual will have a long and fulfilling life and the greater the chances of various disorders usually related to obesity and to other health problems. Body Mass (FAT) Index is an extremely important measurement because it measures the relationship and percentage of fat to muscle ratio in the tissues throughout the body.

Continued research has shown that weight alone is not as significant as the ratio of muscle to body fat. The ideal Body Mass (FAT) Index is quite different for women than for men. Wellness ideals are based on many years of research and testing many thousands of people to determine their ideal Body Mass (FAT) Index. For men, it is around 9-11%; but for women, it is between 15-22%. Super-Healthy Women need more body cushioning and fat than men because it is necessary for proper functioning of the delicate balances of their intriguing hormonal systems. These optimal percentages are based on many years of research and are used for determining not only a person's ideal weight but many other conditions that can prevent most sicknesses and diseases and give a much higher quality of life to the individual.

Body Mass (FAT) Index serves another “psychological type of purpose” for some people since the obese person may be able to believe that as they add more body fat it becomes an insulator to keep them from actually feeling things in their life or it may serve to keep others at a distance. For this reason, psychologically speaking, the Body Mass (FAT) Index measurement is a good indicator of a person's level of fear of intimacy or closeness as well as an indicator of their perceived need for protection.

Height and Weight Ratio, an Alternative Body Mass Index Approximation—FIG. 3B

These specific Body Mass (FAT) Index and Wellness summary measurements ultimately determine a person's height and weight ratio. Calculating this may provide a simple, user friendly easy approximate measurement of Body Mass (FAT) Index and Wellness, if wellness trained and certified technicians are not available for accurate assessments of this important “Bio-Physiological Well-Being” parameter. However, the calculation of a person's ideal height to weight ratio may need to be adjusted for different types of body frames, such as: small, medium or large bones and body sizes.

FIG. 3C—Circulation Cardio-Efficiency and Wellness/Stress Dot Temperature Test

FIG. 3C is a reproduction of a portion of the new, updated and improved typical individualized and personal Bio-Physiological Well-Being and Scientific Wellness multicolor visual depictions and analysis information showing the participant's ranking on this 10-Point Bio-Physiological Well-Being and Wellness Parameter categorized as Circulation Cardio-Efficiency and Total Wellness.

A new and exciting feature that is an integrated part of the follow-up improvement suggestions and intervention protocol strategies of the present invention is the inclusion of customized “Virtual Reality Scientifically Accurate Customized Fun Well-Being and Scientific Wellness Computerized Video (3D) Games, related to this category” that allows a participant to become involved in a series of games that uniquely and graphically demonstrate to the viewing participant the probable and/or guaranteed realistic outcomes and consequences of either self-improvement or self-destructive lifestyle choices specifically related to this parameter. By taking full advantage of the measurements and improvement suggestions and the customized information provided through the “Validated Quantifiable Well-Being and Scientific Wellness Scales,” a truly smart individual can self-educate themselves by experimentation utilizing the various intervention protocols to create new and improved ways to cope with life's many surprises and unprecedented challenges. Additionally, participants can learn from the new, exciting, adventurous “Virtual Reality Scientifically Accurate Customized Fun Well-Being and Scientific Wellness Computerized Video (3D) Games” that are a key embodiment of this invention by following the probable scenarios of alternatively choosing apparent positive and/or clearly negative choices in the game's adventures which can then lead to realistic probable outcomes and consequences. Smart people who take full advantage of this brand new high-tech, self-educational system that was researched, designed and developed by scientifically trained well-being/wellness and longevity experts will ultimately result in many personal well-being and scientific wellness rewards. The beauty of the custom virtual reality self-educational games is that a person can explore realistic life experiences and dramas and their probable outcomes and consequences without any serious, painful or devastating personal well-being and/or scientific wellness damages. Over time, one can learn to improve their own personal well-being and scientific wellness scores to the point that they can share their successes with family, friends and business associates.

The next most important new, updated and improved health and fitness category is the Circulation Cardio-Efficiency Assessment Parameter to get an idea of how healthy one's circulatory system is internally. This Circulation Cardio-Efficiency and Total Wellness measurement utilizes a stress dot temperature test at the extremities. This Circulation Cardio-Efficiency and Total Wellness may include things like cold feet, cold hands, or other circulatory indicators of how efficient a person's circulation may be at this moment. The Circulation Cardio-Efficiency and Total Wellness is one way to measure how good a person's cardiovascular system is functioning to bring the blood all the way out to the extremities. This Circulation Cardio-Efficiency and Total Wellness measurement is another important Quantifiable Well-Being and Scientific Wellness Measurement. It generally indicates the tension levels and any cardio blockages within one's body and how “chronic” or how tight certain muscle groups may be, as well as whether or not they can relax sufficiently and let go; and if so, how fast and how extensive throughout the body. This category correlates to this specific summary evaluation on the 10-Point Bio-Physiological Well-Being Scale.

FIG. 3D—Environmental Pulmonary Wellness and Cardio-Respiratory Efficiency

FIG. 3D is a reproduction of a portion of the typical individualized and personal Scientific Wellness multicolor visual depictions and analysis information showing the participant's ranking on this 10-Point Physiological Scientific Wellness Parameter categorized as the “Environmental Pulmonary Wellness” combined with the highlighted suggestions and recommendations that are correlated to this specific updated and improved, advanced empirical summary evaluation of the 10-Point Bio-Physiological Well-Being Scale.

A new and exciting feature that is an integrated part of the follow-up improvement suggestions and intervention protocol strategies of the present invention is the inclusion of customized “Virtual Reality Scientifically Accurate Customized Fun Well-Being and Scientific Wellness Computerized Video (3D) Games, related to this category” that allows a participant to become involved in a series of games that uniquely and graphically demonstrate to the viewing participant the probable and/or guaranteed realistic outcomes and consequences of either self-improvement or self-destructive lifestyle choices specifically related to this parameter. By taking full advantage of the measurements and improvement suggestions and the customized information provided through the “Validated Quantifiable Well-Being and Scientific Wellness Scales,” a truly smart individual can self-educate themselves by experimentation utilizing the various intervention protocols to create new and improved ways to cope with life's many surprises and unprecedented challenges. Additionally, participants can learn from the new, exciting, adventurous “Virtual Reality Scientifically Accurate Customized Fun Well-Being and Scientific Wellness Computerized Video (3D) Games” that are a key embodiment of this invention by following the probable scenarios of alternatively choosing apparent positive and/or clearly negative choices in the game's adventures which can then lead to realistic probable outcomes and consequences. Smart people who take full advantage of this brand new high-tech, self-educational system that was researched, designed and developed by scientifically trained well-being/wellness and longevity experts will ultimately result in many personal well-being and scientific wellness rewards. The beauty of the custom virtual reality self-educational games is that a person can explore realistic life experiences and dramas and their probable outcomes and consequences without any serious, painful or devastating personal well-being and/or scientific wellness damages. Over time, one can learn to improve their own personal well-being and scientific wellness scores to the point that they can share their successes with family, friends and business associates.

Lung Vital Capacity/Forced Volume Evaluation-13 FIG. 3D

Evaluations of a person's Lung Vital Capacity/Forced Volume Tests provide added important information, especially for individuals that work or live in a very smoggy area or have smoked excessively in the past (but quit) or for those that are still smoking or living with a smoker/vaper. The assessment of this Parameter is generally optional for non-smokers or for those who work or live in non-smoggy areas. But for individuals who are smoking or exposed to heavy smoke or smog these need to be evaluated and tracked. The “Environmental Pulmonary Wellness” measured as the vital capacity and forced volume of the lungs are important indicators of the Quantifiable Well-Being and Scientific Wellness of the person. Monitoring this Quantifiable Well-Being and Scientific Wellness Parameter will indicate still another measurement of a person's level of Quantifiable Well-Being and Scientific Wellness. This category correlates to this specific summary evaluation on the 10-Point Bio-Physiological Well-Being Scale.

Smoking/Air or Water Pollution Environmental Wellness Habits—FIG. 3D

As part of the scientific evaluation of the updated and improved “Environmental Pulmonary Wellness Assessment Parameters,” it is important to evaluate a person's smoking/vaping habits and/or exposure to cigarette/cigar/pipe/vaping and/or smoking, including secondary smoke by being around smoke, and/or air or water pollution environmental habits. The purity of both air and water are very important causative factors that can seriously affect achieving and maintaining Quantifiable Well-Being and Scientific Wellness on the 10-Point Total Well-Being Scales. Actuarially, these environmental factors are not as important as the scientifically objective laboratory evaluations or the basic self-reported “lifestyle, mission, spiritual well-being, attitudes, outlooks, habits and usual behaviors, nutritional and exercise habits, nurturing relationship wellness and commitment to well-being parameters” which are highly dependent upon a person's memory, truthfulness and/or accuracy of remembering details and responding to the specific assessment questions honestly, but they are still important enough that they must be considered as a measurement of updated and improved Quantifiable Well-Being and Scientific Wellness on the 10-Point Total Well-Being Scales.

FIG. 3E—Cardio-Diastolic and Systolic Well-Being Scales

FIG. 3E is a reproduction of a portion of the new, updated and improved typical individualized and personal Bio-Physiological Well-Being and Scientific Wellness Scale multicolor visual depictions and updated and improved analysis information showing the participant's ranking on the 10-Point Bio-Physiological Well-Being and Scientific Wellness Parameter which combines both the standard Diastolic and Systolic Blood Pressure Measurements which are then categorized as the “Cardio-Diastolic and Systolic Well-Being” combined with the highlighted suggestions and recommendations that are correlated to this specific summary evaluation on this updated and improved 10-Point Bio-Physiological Well-Being Scale.

A new and exciting feature that is an integrated part of the follow-up improvement suggestions and intervention protocol strategies of the present invention is the inclusion of customized “Virtual Reality Scientifically Accurate Customized Fun Well-Being and Scientific Wellness Computerized Video (3D) Games, related to this category” that allows a participant to become involved in a series of games that uniquely and graphically demonstrate to the viewing participant the probable and/or guaranteed realistic outcomes and consequences of either self-improvement or self-destructive lifestyle choices specifically related to this parameter. By taking full advantage of the measurements and improvement suggestions and the customized information provided through the “Validated Quantifiable Well-Being and Scientific Wellness Scales,” a truly smart individual can self-educate themselves by experimentation utilizing the various intervention protocols to create new and improved ways to cope with life's many surprises and unprecedented challenges. Additionally, participants can learn from the new, exciting, adventurous “Virtual Reality Scientifically Accurate Customized Fun Well-Being and Scientific Wellness Computerized Video (3D) Games” that are a key embodiment of this invention by following the probable scenarios of alternatively choosing apparent positive and/or clearly negative choices in the game's adventures which can then lead to realistic probable outcomes and consequences. Smart people who take full advantage of this brand new high-tech, self-educational system that was researched, designed and developed by scientifically trained well-being/wellness and longevity experts will ultimately result in many personal well-being and scientific wellness rewards. The beauty of the custom virtual reality self-educational games is that a person can explore realistic life experiences and dramas and their probable outcomes and consequences without any serious, painful or devastating personal well-being and/or scientific wellness damages. Over time, one can learn to improve their own personal well-being and scientific wellness scores to the point that they can share their successes with family, friends and business associates.

Blood Pressure(s) Tests for Quantifiable Optimal Well-Being & Wellness-13 FIG. 3E

The Cardio-Diastolic and Systolic Well-Being Evaluations are among the most common tests and measurements in the medical and illness industries. These are a very important evaluator and measurement of the new, updated and improved Bio-Physiological Well-Being and Scientific Wellness Parameters, because they are also indicators of the internal efficiency of the entire cardiovascular system blockages and/or circulatory efficiencies. In these sphygmomanometer blood pressure measurements, two different Parameters, both the diastolic and systolic pressures are measured and tested. Caution is suggested here for obtaining accurate readings on these important updated and improved scientifically objective Bio-Physiological Well-Being and Scientific Wellness Measurements and Parameters, for a variety of important reasons. First and most important, almost all of the recent modern electronic high-tech (hands free) devices used to measure blood pressures (even the most recent ones that are commonly used by the illness professionals in hospitals, medical clinics and doctor's offices) generally are potentially about 20% off the correct traditional sphygmomanometer readings. Secondly, even if a medically trained person uses the older sphygmomanometer or the hand held blood pressure cuff which can be closer to the traditional sphygmomanometer readings; they are frequently much too poorly trained to get any accurate wellness or fitness measurements; because they tend to be in a hurry and are trained to only look for gross approximations that might indicate a serious diseased condition. Thirdly, the newest devices in retail stores (markets, pharmacies, etc.) may be generally about 20% off the correct readings. Finally, the best source for true diastolic and systolic pressure measurements is a certified wellness technician or professional using a blood pressure cuff or the older traditional sphygmomanometer device which is capable of getting the most accurate measurements, if administered by a certified and trained wellness technician or an adequately trained medical technician or professional. Most of the blood pressure tests administered in many clinics, hospitals and doctor's offices are inaccurate and tend to be only approximate blood pressure measurements. As such, they are of little value for getting accurate blood pressure numbers or readings needed for either baseline or small incremental changes in the internal blood pressures (positive or negative) which can be posted on the Cardio-Diastolic and Systolic Well-Being Scales.

The Non-Situational Cardio-Diastolic Blood Pressure—FIG. 3E

The Diastolic is not as situational as the Systolic. The Secondary Cardio-Diastolic Number (which is the pressure measurement within the heart itself, and within the arteries and veins when the heart is between cycles as well as throughout the entire cardiovascular system when the system is at rest or not pumping), is generally determined by a number of factors. Some of these causative Cardio-Diastolic factors include: hypertension, overall stress, the buildup of cholesterol in the blood vessels, arterial sclerotic conditions in the arteries, or in the heart itself, the efficiency and stamina of the heart muscle itself, or any other complicating factors in terms of the complete internal cardiovascular system. All of these Cardio-Diastolic factors affect the new, updated and improved Cardio-Diastolic Well-Being Measurements; so it is the most important measurement in terms of achievable levels ranked on the Cardio-Diastolic and Systolic Well-Being Scales. Because the Cardio-Diastolic Well-Being Measurements are not very situational, it qualifies as the best indicator for revealing the total efficiency of the entire cardiovascular system. The Cardio-Diastolic is primarily determined by the tested person's level of health, fitness and wellness. When wellness scientists and technicians evaluate the risk levels represented in the blood pressure measurement(s), they consider both the second number, the Cardio-Diastolic Number (the in between internal at rest measurement of pressure) and the Cardio-Systolic Score (the pressure measurement). It is important to note, that the secondary Cardio-Diastolic Number is the best indicator for determining an individual's optimal wellness levels. Thus, it is the Cardio-Diastolic Score that is much more important. This is true because it quantifies how a person has really been living their life and the lifestyle habits and choices which they have developed over time.

The Situational Systolic Blood Pressure—FIG. 3E

The Cardio-Systolic Blood Pressure Score, however, is very situational. A person can travel on a freeway the wrong way or have some major stress or have something happen suddenly to frighten them, and their Cardio-Systolic Score will go up noticeably. It can be dramatically affected by a variety of frightening or stressful circumstances. The Cardio-Systolic Score is the pressure that is measured when the heart is contracting and pumping blood throughout the entire cardiovascular system. So it is the first and highest number when a blood pressure reading is taken by a technician.

### FIGS. 4A-4F: The Self-Reported and Self-Assessed Great Exciting Life Purpose and Mission, Nutrition Eating/Drinking Habits, Physical Exercise, Fun Nurturing Relationships, Mental and Emotional Well-Being and Commitment to Optimal Scientific Wellness and Self-Love

The “Self-Reported and Self-Assessed Life Purpose/Mission Nutrition, Exercise, Nurturing Relationships, Quantifiable Mental/Emotional Well-Being and Commitment to Optimal Scientific Wellness Parameters” of Quantifiable Well-Being, Scientific Optimal Wellness and Ideal Fitness include subjective Self-Reported and Self-Assessed Categories that seriously support or limit a person's achievable levels of Quantifiable Optimal Well-Being and Scientific Wellness. Since these categories are determined by an individual's personal Self-Reported and Self-Assessed information/data, the special parameters of Quantifiable Optimal Well-Being and Scientific Wellness associated with these areas are highly dependent upon a person's motivations, memory, truthfulness, accuracy of remembering details, self-perception and responding to the customized lifestyle attitudes and behaviors assessment questions honestly.

FIG. 4A—Self-Reported and Self-Assessed Importance of Having a Great Exciting Life-Purpose and Mission Plus Basic Wellness Attitudes with Self-Love

FIG. 4A is a reproduction of a portion of the typical individualized and personal Super-Health, Optimal Wellness, Quantifiable Well-Being and Ideal Fitness multicolor visual depictions and analysis information showing the participant's ranking on the subjective aspects of the 10-Point Quantifiable Well-Being and Scientific Wellness Parameters categorized as the “Self-Reported and Self-Assessed Exciting Great Life Purpose/Mission and Wellness Attitudes with Self-Love” combined with the highlighted suggestions, recommendations and improvement protocols that are correlated to the specific summary evaluations of the “Self-Assessed” 10-Point Quantifiable Well-Being and Scientific Wellness Rating Scales.

A new and exciting feature that is an integrated part of the follow-up improvement suggestions and intervention protocol strategies of the present invention is the inclusion of customized “Virtual Reality Scientifically Accurate Customized Fun Well-Being and Scientific Wellness Computerized Video (3D) Games, related to this category” that allows a participant to become involved in a series of games that uniquely and graphically demonstrate to the viewing participant the probable and/or guaranteed realistic outcomes and consequences of either self-improvement or self-destructive lifestyle choices specifically related to this parameter. By taking full advantage of the measurements and improvement suggestions and the customized information provided through the “Validated Quantifiable Well-Being and Scientific Wellness Scales,” a truly smart individual can self-educate themselves by experimentation utilizing the various intervention protocols to create new and improved ways to cope with life's many surprises and unprecedented challenges. Additionally, participants can learn from the new, exciting, adventurous “Virtual Reality Scientifically Accurate Customized Fun Well-Being and Scientific Wellness Computerized Video (3D) Games” that are a key embodiment of this invention by following the probable scenarios of alternatively choosing apparent positive and/or clearly negative choices in the game's adventures which can then lead to realistic probable outcomes and consequences. Smart people who take full advantage of this brand new high-tech, self-educational system that was researched, designed and developed by scientifically trained well-being/wellness and longevity experts will ultimately result in many personal well-being and scientific wellness rewards. The beauty of the custom virtual reality self-educational games is that a person can explore realistic life experiences and dramas and their probable outcomes and consequences without any serious, painful or devastating personal well-being and/or scientific wellness damages. Over time, one can learn to improve their own personal well-being and scientific wellness scores to the point that they can share their successes with family, friends and business associates.

Having a Great Exciting Life-Purpose/Mission and Basic Wellness Attitudes and Self-Love—FIG. 4A

This particular area of assessment in this new, updated and improved invention has quantifiably become the most important category of measurement to determine a person's present and future levels of achievable and maintainable Quantifiable Well-Being and Scientific Wellness Ratings. In spite of the inherent limitations and flaws associated with collecting Self-Reported and Self-Assessed Personal Information and Data, the Life Purpose/Mission and Attitudinal Category continues to remain at the very top of the list of evaluative and predictive information or data parameters that ultimately determines a person's achievable levels of Quantifiable Well-Being and Scientific Wellness. As surprising as this may seem, this area of assessment continues to rank as the most important and accurate single category with the greatest determining success of predicting short and long-term future outcomes from dedicated participants who wish to maximize their chances of healthy aging and potential longevity. Over the last 40 years of on-going research, the pattern of this category being the most important of all areas of assessment keeps repeating itself.

The reasons for these surprising phenomena are relatively simple. If an individual has a high level of passion and excitement for a truly exciting life purpose and mission, they will eagerly arise each day to magically overcome any challenges and difficulties in order to complete or fulfill their life purpose and mission. Each day brings much happiness, joy and fulfillment, plus many intangible and tangible rewards. However, people who do not know or have a life purpose or mission have no reason to continue living in this stressful dimension, and often retire to boring or frustrating lifestyles at senior communities where they live in deep mental and emotional pain hoping today could be their last. Because their boring or pain ridden lives have little or no excitement, they constantly wish for death as soon as possible. Each year, the research continues to re-affirm that this area of assessment is the most important of any Quantifiable Well-Being and Scientific Wellness category, even more accurate and valuable than the scientifically assessed laboratory measurements. The assessment of updated and improved “basic attitudes, outlooks and behaviors” continue to rank the highest on all of the 10-Point Bio-Physiological Well-Being and Scientific Wellness Rating Scales as the areas that are foundational to all of the other vital “Parameters of Quantifiable Well-Being, Optimal Wellness, Super-Health and Ideal Fitness.” These have turned out to be the most significant and important Parameters statistically, because out of the Well-Being Parameters, this one determines all of one's lifestyle choices/habits as it becomes the bottom line where behaviors are determined, every last one of them, in fact, from what one does when s/he gets up in the morning to what s/he does before s/he finally retires at night and goes to bed for rejuvenating rest or sleep.

FIG. 4B—Self-Reported and Self-Assessed Spiritual Well-Being, Core Beliefs and Positive Wellness Outlooks

FIG. 4B is a reproduction of a portion of the typical individualized and personal Super-Health, Optimal Wellness, Quantifiable Well-Being and Ideal Fitness multicolor visual depictions and analysis information showing the participant's ranking on subjective aspects of the 10-Point Quantifiable Well-Being and Scientific Wellness Parameters categorized as the “Self-Reported and Self-Assessed Spiritual Well-Being, Core Beliefs and Positive Wellness Outlooks that is combined with the highlighted suggestions and recommendations that are correlated to this specific updated and improved summary and ranking on the “Self-Assessed” 10-Point Quantifiable Well-Being and Scientific Wellness Scales.

A new and exciting feature that is an integrated part of the follow-up improvement suggestions and intervention protocol strategies of the present invention is the inclusion of customized “Virtual Reality Scientifically Accurate Customized Fun Well-Being and Scientific Wellness Computerized Video (3D) Games, related to this category” that allows a participant to become involved in a series of games that uniquely and graphically demonstrate to the viewing participant the probable and/or guaranteed realistic outcomes and consequences of either self-improvement or self-destructive lifestyle choices specifically related to this parameter. By taking full advantage of the measurements and improvement suggestions and the customized information provided through the “Validated Quantifiable Well-Being and Scientific Wellness Scales,” a truly smart individual can self-educate themselves by experimentation utilizing the various intervention protocols to create new and improved ways to cope with life's many surprises and unprecedented challenges. Additionally, participants can learn from the new, exciting, adventurous “Virtual Reality Scientifically Accurate Customized Fun Well-Being and Scientific Wellness Computerized Video (3D) Games” that are a key embodiment of this invention by following the probable scenarios of alternatively choosing apparent positive and/or clearly negative choices in the game's adventures which can then lead to realistic probable outcomes and consequences. Smart people who take full advantage of this brand new high-tech, self-educational system that was researched, designed and developed by scientifically trained well-being/wellness and longevity experts will ultimately result in many personal well-being and scientific wellness rewards. The beauty of the custom virtual reality self-educational games is that a person can explore realistic life experiences and dramas and their probable outcomes and consequences without any serious, painful or devastating personal well-being and/or scientific wellness damages. Over time, one can learn to improve their own personal well-being and scientific wellness scores to the point that they can share their successes with family, friends and business associates.

A Predictor of Spiritual Well-Being, Core Beliefs and Wellness Outlooks—FIG. 4B

This category of the present updated and improved invention ranks second in importance to the previous Life Purpose and Mission area of measurement in determining a participant's present and future levels of achievable and maintainable Quantifiable Well-Being and Scientific Wellness Ratings. The Life Purpose/Mission and Attitudinal Category plus the Spiritual Well-Being plus Loving Core Beliefs and Wellness Outlooks Parameter continue to remain at the highest level of importance in second position near the very top of the list of evaluative and predictive information or data parameters that ultimately determine a person's achievable levels of Quantifiable Well-Being and Scientific Wellness.

While many dummies are limited and completely “Self-Serving or Self-Absorbed” and totally “Focused” on “What Do I Really Want!” or “It's All About ME,” the truly advanced smarter and “Super-Healthy Person” has become aware of the bigger picture, knowing, connecting and communicating with greater and wiser pure loving Spirits that provide nurturing energy throughout the universe to aware and loving beings. While living in this dimension, it is very wise to be committed to becoming spiritually well with dynamic choices of Loving Core Beliefs and Wellness Outlooks.

FIG. 4C—Self-Reported and Self-Assessed Nutritional Eating and Drinking Habits

FIG. 4C is a reproduction of a portion of the typical individualized and personal Super-Health, Optimal Wellness, Quantifiable Well-Being and Ideal Fitness multicolor visual depictions and analysis information showing the participant's ranking on subjective aspects of the 10-Point Quantifiable Well-Being and Scientific Wellness Parameters categorized as the “Self-Reported and Self-Assessed Nutritional Eating and Drinking Habits” that is combined with the highlighted suggestions and recommendations that are correlated to this specific updated and improved summary and ranking on the “Self-Assessed” 10-Point Quantifiable Well-Being and Scientific Wellness Scales.”

A new and exciting feature that is an integrated part of the follow-up improvement suggestions and intervention protocol strategies of the present invention is the inclusion of customized “Virtual Reality Scientifically Accurate Customized Fun Well-Being and Scientific Wellness Computerized Video (3D) Games, related to this category” that allows a participant to become involved in a series of games that uniquely and graphically demonstrate to the viewing participant the probable and/or guaranteed realistic outcomes and consequences of either self-improvement or self-destructive lifestyle choices specifically related to this parameter. By taking full advantage of the measurements and improvement suggestions and the customized information provided through the “Validated Quantifiable Well-Being and Scientific Wellness Scales,” a truly smart individual can self-educate themselves by experimentation utilizing the various intervention protocols to create new and improved ways to cope with life's many surprises and unprecedented challenges. Additionally, participants can learn from the new, exciting, adventurous “Virtual Reality Scientifically Accurate Customized Fun Well-Being and Scientific Wellness Computerized Video (3D) Games” that are a key embodiment of this invention by following the probable scenarios of alternatively choosing apparent positive and/or clearly negative choices in the game's adventures which can then lead to realistic probable outcomes and consequences. Smart people who take full advantage of this brand new high-tech, self-educational system that was researched, designed and developed by scientifically trained well-being/wellness and longevity experts will ultimately result in many personal well-being and scientific wellness rewards. The beauty of the custom virtual reality self-educational games is that a person can explore realistic life experiences and dramas and their probable outcomes and consequences without any serious, painful or devastating personal well-being and/or scientific wellness damages. Over time, one can learn to improve their own personal well-being and scientific wellness scores to the point that they can share their successes with family, friends and business associates.

Self-Reported and Self-Assessed Nutritional Eating and Drinking Habits—FIG. 4C

Throughout the world, most health and medical researchers, professionals and practitioners of numerous health care modalities, consider nutritional eating and drinking habits to be the most important predictor of Quantifiable Well-Being and Scientific Wellness. However, the decades of actuarial and mathematically based research behind this new, novel, updated and improved invention have discovered unique and special additional information and data that statistically lessens the importance of this category of achievable well-being and wellness in contrast and comparison to Life Purpose/Mission, Attitudinal, Spiritual Well Being, Healthy Core Beliefs, and Positive Outlooks. Even though it is true that one ultimately becomes what s/he eats and drinks, there are many challenging modern factors that complicate this ancient axiom. Basic quantifiable and trackable scientific nutrition researchers still recommend consuming mostly natural organic home prepared optimally nutritious foods/drinks instead of frequent restaurant cooked meals (i.e., seriously avoiding foods that have been processed, or contain a long list of toxic chemicals/preservatives, including any with GMO/MSG ingredients, hormones, pesticides, artificial sweeteners, etc.), so you can be sure of the purest natural qualities of the ingredients. Continued hidden agenda free research has found out that most if not all of the highly processed, fast and junk foods contain many unnatural toxic ingredients and additives that ultimately lead to many modern illnesses, such as: obesity, endocrine and cardiovascular disorders, autism, cancers, hypertension, diabetes, chronic digestive illnesses, emotional and mental diseases, adrenal disorders, brain dysfunction, to name just a few. However, optimally natural and healthy nutrition and natural supplements continue to be vitally important in achieving and/or maintaining a functional body and mind, a healthy vital and competent immune system plus achieving and maintaining optimal well-being, total wellness and ideal fitness. This is because these natural high quality nutritional foods provide the necessary basic building blocks for both optimal wellness and sustainable super-healthy longevity. Another increasingly important dietary ingredient that is becoming more critical every day is the purity or dangerous pathogens and toxic substances of potable drinking and cooking water. Today, many urban and rural sources of tap water are often too extremely dangerous to drink due to toxic spills, fracking and other blatant contamination of ground waters.

Mathematically, the nutrition and diet supplement Parameters are quite important ones because they are foundational categories for understanding what foods, drinks and natural supplements are serving as valuable replacement ingredients to keep the body and mental cells healthy, vibrant and functioning optimally. If utilized wisely, this unique, novel, updated and improved invention can help many intelligent people determine the ideal quantities of fat needed in a person's ideal customized diet, the optimal amounts of cholesterol sources of nutritionally healthy food types needed to keep the cardiovascular system in super-healthy condition, as well as the amount of natural healthy salts and sweeteners (raw) sugar/honeys and other ingredients which can either bring a person to optimal health and wellness or cause them potential sickness and serious diseases or other complications. This is the smartest way to utilize the objective scientific evaluations to personalize one's dietary nutritional needs to easily determine the best diet for each person's unique DNA, inherited genetics, metabolism, physiology and environmental or substance sensitivities.

FIG. 4D—Self-Reported and Self-Assessed Natural Health Improving Supplements

FIG. 4D is a reproduction of a portion of the typical individualized and personal Super-Health, Optimal Wellness, Quantifiable Well-Being and Ideal Fitness multicolor visual depictions and analysis information showing the participant's ranking on subjective aspects of the 10-Point Quantifiable Well-Being and Scientific Wellness Parameters categorized as the “Self-Reported and Self-Assessed Natural Health Improving Supplements” that is combined with the highlighted suggestions and recommendations that are correlated to this specific updated and improved summary and ranking on the “Self-Assessed” 10-Point Quantifiable Well-Being and Scientific Wellness Scales.”

A new and exciting feature that is an integrated part of the follow-up improvement suggestions and intervention protocol strategies of the present invention is the inclusion of customized “Virtual Reality Scientifically Accurate Customized Fun Well-Being and Scientific Wellness Computerized Video (3D) Games, related to this category” that allows a participant to become involved in a series of games that uniquely and graphically demonstrate to the viewing participant the probable and/or guaranteed realistic outcomes and consequences of either self-improvement or self-destructive lifestyle choices specifically related to this parameter. By taking full advantage of the measurements and improvement suggestions and the customized information provided through the “Validated Quantifiable Well-Being and Scientific Wellness Scales,” a truly smart individual can self-educate themselves by experimentation utilizing the various intervention protocols to create new and improved ways to cope with life's many surprises and unprecedented challenges. Additionally, participants can learn from the new, exciting, adventurous “Virtual Reality Scientifically Accurate Customized Fun Well-Being and Scientific Wellness Computerized Video (3D) Games” that are a key embodiment of this invention by following the probable scenarios of alternatively choosing apparent positive and/or clearly negative choices in the game's adventures which can then lead to realistic probable outcomes and consequences. Smart people who take full advantage of this brand new high-tech, self-educational system that was researched, designed and developed by scientifically trained well-being/wellness and longevity experts will ultimately result in many personal well-being and scientific wellness rewards. The beauty of the custom virtual reality self-educational games is that a person can explore realistic life experiences and dramas and their probable outcomes and consequences without any serious, painful or devastating personal well-being and/or scientific wellness damages. Over time, one can learn to improve their own personal well-being and scientific wellness scores to the point that they can share their successes with family, friends and business associates.

Self-Reported and Self-Assessed Natural Health Improving Supplements—FIG. 4D

In an ideal world without ever increasing pandemic conditions with dangerous medicine resistant super-bugs, environmental or dietary toxic disease causing substances and giant industries profiting from minimal treatment of preventable illnesses, natural supplements might not be needed. But none of us live in such an ideal balanced sustainable eco-friendly safe green non-toxic environment or world. Consequently, many people who are committed to quantifiable well-being and scientific wellness have found it both wise and necessary to carefully research the ethical values of companies distributing high quality natural food based supplements, since there can be an ever increasing number of unsafe, hidden or dangerous toxic ingredients not listed on the ingredients. This area of need and concern is uniquely addressed in this new, novel, advanced, continually updated and improved invention by providing informational links for smart people who want to know what they are consuming and who are passionate participants in the quantification, assessing, measuring, evaluating, comparing and correlating of the many integrated parameters of optimal well-being, scientific wellness and ideal fitness. This updated and improved invention utilizes a validated and scientifically/mathematically sophisticated method for taking the fear, guesswork and mystery out of continually staying super-well by simply monitoring and tracking all of the vital and important well-being and scientific wellness parameters that provide accurate, easy to understand valuable data and information links/resources not available from any one source or professional in the self-serving supplement businesses or the unethical illness and food industries. Smart people who truly care about their sustainable futures will welcome the sophisticated small incremental changes that can be measured and tracked by the present invention on up to more than 40 optimal well-being and scientifically validated super-health and ideal fitness related categories that are based on decades of ethical private research in helping people determine the best diet for each person's unique DNA, inherited genetic weaknesses and challenges, metabolism differences, environmental and/or substance sensitivities (including outgassing of new carpets, glues and building materials, nuclear or EMF radiation concerns and other emerging problems) as well as any bio-physiological distinctive reactions that may have never been adequately researched.

Using Natural Herbs/Minerals/Vitamins/Nutritional/Food Supplements—FIG. 4D

This is a new, updated and improved category of the present invention that has become more and more important as the nutritional quality and purity of the ingredients in mass produced and processed super-market foods and produce have dramatically deteriorated, causing more and more smart people with legitimate health concerns. In some cases, these foods and drinks contain so many toxic ingredients that they should be banned as disease causing items. Sound healthy natural organic foods high in nutritional content supported by natural healthy dietary supplements and natural foods (non-processed or fast foods) can provide most people with the important ingredients needed for achieving and/or maintaining optimal wellness, especially if a person takes repeated advantage of the scientific evaluations and objective information from the lab data analyzing important body chemistries and fluids.

FIG. 4E—Gentle Non-Stressful Movement/Exercise & Relaxational Responsiveness

FIG. 4E is a reproduction of a portion of the typical individualized and personal Super-Health, Optimal Wellness, Quantifiable Well-Being and Ideal Fitness multicolor visual depictions and analysis information showing the participant's ranking on subjective aspects of the 10-Point Quantifiable Well-Being and Scientific Wellness Parameters categorized as the “Self-Reported and Self-Assessed Gentle Cardiovascular Movement and Exercise Activities that is combined with the highlighted suggestions and recommendations that are correlated to this specific updated and improved summary and ranking on the “Self-Assessed” 10-Point Regular Gentle Non-Stressful Movement and Physical Exercises, Fun Movement Activities Scales and Natural Relaxational Responsiveness.”

A new and exciting feature that is an integrated part of the follow-up improvement suggestions and intervention protocol strategies of the present invention is the inclusion of customized “Virtual Reality Scientifically Accurate Customized Fun Well-Being and Scientific Wellness Computerized Video (3D) Games, related to this category” that allows a participant to become involved in a series of games that uniquely and graphically demonstrate to the viewing participant the probable and/or guaranteed realistic outcomes and consequences of either self-improvement or self-destructive lifestyle choices specifically related to this parameter. By taking full advantage of the measurements and improvement suggestions and the customized information provided through the “Validated Quantifiable Well-Being and Scientific Wellness Scales,” a truly smart individual can self-educate themselves by experimentation utilizing the various intervention protocols to create new and improved ways to cope with life's many surprises and unprecedented challenges. Additionally, participants can learn from the new, exciting, adventurous “Virtual Reality Scientifically Accurate Customized Fun Well-Being and Scientific Wellness Computerized Video (3D) Games” that are a key embodiment of this invention by following the probable scenarios of alternatively choosing apparent positive and/or clearly negative choices in the game's adventures which can then lead to realistic probable outcomes and consequences. Smart people who take full advantage of this brand new high-tech, self-educational system that was researched, designed and developed by scientifically trained well-being/wellness and longevity experts will ultimately result in many personal well-being and scientific wellness rewards. The beauty of the custom virtual reality self-educational games is that a person can explore realistic life experiences and dramas and their probable outcomes and consequences without any serious, painful or devastating personal well-being and/or scientific wellness damages. Over time, one can learn to improve their own personal well-being and scientific wellness scores to the point that they can share their successes with family, friends and business associates.

Fun, Gentle Non-Stressful Movement and Physical Exercise/Activities—FIG. 4E

After decades of scientific research on the importance of fun, gentle non-stressful physical movement and exercise activities, the following important and valuable information has been integrated in this new, novel, updated, advanced and improved Self-Assessed” 10-Point Regular Gentle Non-Stressful Movement and Physical Exercises and Fun Movement Activities Scales of this invention. As important as cardiovascular exercise to achieving/maintaining Super-Health, Optimal Wellness, Quantifiable Well-Being and Ideal Fitness, it has been over rated and abused by the sports and fitness industries. The reclusive longevity societies of native indigenous peoples in several parts of the world have learned how to get healthier and more relaxed while running or moving as a person ages. Thus the 50 year olds can move and run for many miles longer than the 30 year olds. But the 70 year olds have downsized and perfected their movement stressors to the point that they can out run and perform better than the 50 year olds. As they continue to age, the 70 year olds cannot keep up or last as long as the 90 and hundred year olds who have been known to run up to 100 miles without stopping for a rest period. The point of all this news is that gentle, only slightly aerobic non-stressful movement and exercise that increases cardiovascular efficiency and flexibility is far more beneficial for longevity than strenuous activities. This is often the most neglected in achievable levels of health and fitness, due to people using their vehicles, skate board or a bicycle to go a short distance rather than walking. Additionally, most people in our modern society live a very sedentary lifestyle (watching TV for many hours per week), including sitting on the job more than moving around. Consequently, many people have a need for adding gentle movement or exercise into their daily and weekly lifestyles because they are not very active. Watching the changes in the ranking numbers on this Self-Assessed” 10-Point Regular Gentle Non-Stressful Movement and Physical Exercises and Fun Movement Activities Category can aid each person in finding enjoyable movement activities that lower resting heart rates, improve levels of stamina and lower Cardio-Diastolic Blood Pressure Scores where an ideal target pulse rate would be to get the sedentary heart rate below 50 pulses per minute.

Enjoyable Dynamic Rejuvinating Activities & Relaxational Responsiveness—FIG. 4E

Since high levels of stress are often the results or consequences of numerous modern lifestyle choices, the new, updated, advanced and improved present invention with its “Self-Reported and Self-Assessed Quantifiable Well-Being and Scientific Wellness Parameters and 10-Point Well-Being/Wellness Scales” is a unique, updated, simple “self-improvement tool” with ever increasingly stringent validated quantifiable rankings of well-being, scientific wellness, optimal health and fitness as well as any genetic and/or medical risk-related conditions and risk factors (if any) that can be changed by experimenting and testing various intervention protocols to discover what improvement programs work the best to create the most positive changes in the Well-Being/Wellness Scales. Though no objective system of determining total inner stress apparently exists at this time, an evaluation of the key areas and types of stressors and risks in a person's life can be very important. Even though stress still has a lot of unknown components and factors, its effects will still dramatically correlate to certain quantifiable physiological and laboratory tested Parameters of well-being and wellness. Stress may affect many important lifestyle well-being and wellness factors, physiological and laboratory evaluated categories and their resultant scores, such as: stress tested temperatures, mental and emotional well-being and wellness, blood pressures, resting/exercise/recovery heart pulse rates, BMI, digestion and eating habits, commitment to well-being and wellness, endocrine well-being and wellness, hormone balances, immuno-vitality, liver and adrenal functions, and especially one's blood lipids. It can also affect and/or change some of the internal numbers, including: major blood lipids, immunocompetancy of white blood cells, etc.

FIG. 4F—Mental/Emotional/Nurturing Relationships Well-Being

FIG. 4F is a reproduction of a portion of the typical individualized and personal Super-Health, Optimal Wellness, Quantifiable Well-Being and Ideal Fitness multicolor visual depictions and analysis information showing the participant's ranking on subjective aspects of the 10-Point Quantifiable Well-Being and Scientific Wellness Parameters categorized as the “Self-Reported and Self-Assessed Mental/Emotional Optimal Health and Nurturing Relationships Well-Being that is combined with the highlighted suggestions and recommendations that are correlated to this specific updated and improved summary and ranking on the “Self-Assessed” 10-Point Mental/Emotional Optimal Health and Nurturing Relationships Well-Being Scales.” This category includes intellectual, emotional, and mental factors. These are often the most elusive factors to quantify and frequently the most difficult to assess or evaluate from a scientific perspective. The reason for this is that there are no mathematically or actuarially standardized evaluations, instruments, methods, systems or devices to determine what are the most reasonable, acceptable, socially proper, appropriate, or “healthy” feelings or emotions. Generally, the professionals in the fields of medical psychiatry and/or counseling psychology and/or marriage and family educationally oriented counselors feel or believe that “any emotion” is proper, so long as it is a true emotion and not a contrived or cover up emotion. But this theory or opinion of counseling professionals is flawed because it has never been tested to any objective degree.

A new and exciting feature that is an integrated part of the follow-up improvement suggestions and intervention protocol strategies of the present invention is the inclusion of customized “Virtual Reality Scientifically Accurate Customized Fun Well-Being and Scientific Wellness Computerized Video (3D) Games, related to this category” that allows a participant to become involved in a series of games that uniquely and graphically demonstrate to the viewing participant the probable and/or guaranteed realistic outcomes and consequences of either self-improvement or self-destructive lifestyle choices specifically related to this parameter. By taking full advantage of the measurements and improvement suggestions and the customized information provided through the “Validated Quantifiable Well-Being and Scientific Wellness Scales,” a truly smart individual can self-educate themselves by experimentation utilizing the various intervention protocols to create new and improved ways to cope with life's many surprises and unprecedented challenges. Additionally, participants can learn from the new, exciting, adventurous “Virtual Reality Scientifically Accurate Customized Fun Well-Being and Scientific Wellness Computerized Video (3D) Games” that are a key embodiment of this invention by following the probable scenarios of alternatively choosing apparent positive and/or clearly negative choices in the game's adventures which can then lead to realistic probable outcomes and consequences. Smart people who take full advantage of this brand new high-tech, self-educational system that was researched, designed and developed by scientifically trained well-being/wellness and longevity experts will ultimately result in many personal well-being and scientific wellness rewards. The beauty of the custom virtual reality self-educational games is that a person can explore realistic life experiences and dramas and their probable outcomes and consequences without any serious, painful or devastating personal well-being and/or scientific wellness damages. Over time, one can learn to improve their own personal well-being and scientific wellness scores to the point that they can share their successes with family, friends and business associates.

Exciting, Fun, Loving Nurturing Relationships & Social Bonding Activities—FIG. 4F

All too often in the present highly stressed pressures of the fast paced lifestyles of the current economically challenged modern society (whether one lives in a polluted urban small or large city or in a slightly less toxic rural environment), nurturing relationships often get lost, replaced or sacrificed by survival issues and challenges. Regardless of the family, work or social setting, it is often nearly impossible to find any one or more persons that exemplifies a truly exciting, fun, loving and nurturing relationship. Even the most popular TV shows, soap operas and most movies are seriously deficient in healthy examples of nurturing relationships. Why is there such a paucity and lack of famous exemplary heroes of ideal truly loving social bonding couples or groups? Too often, the only answer to this query is that no one cares enough to commit to the time it takes to create and nurture any super-healthy relationships. Another contributing factor is the reality that most people have very little training or information of how to develop, foster and maintain a nurturing relationship. Thus a person generally depends on pure but rare blind luck in the hopes that some kind of divine fortune will mysteriously happen (like winning the lottery) that connects them magically to one or more persons capable of choosing, contributing to and maintaining a dream type of ongoing truly exciting, fun, happy, loving and nurturing relationships that will make positive contributions to optimal mental and emotional balances. Since everyone's internal emotional terrain is frequently and sometimes silently (mysteriously) affected by highly charged, dramatic, painful and/or sad feelings (whether the feelings have been unconsciously self-generated or reactively created in response to a drama orchestrated or initiated by another, such as: provoked or unprovoked angry/hostile outbursts of others), one's “Personal Emotional “IQ” and Self-Developed Nurturing Relationship's Quotient” will largely determine how a super-healthy person is able to cope with and/or diffuse the highly charged immediate situation. This is where the value of the present invention skyrockets. By taking full advantage of the measuring and improvement suggestions and customized information provided through the “Validated Quantifiable Well-Being and Scientific Wellness Scales a smart individual can self-educate themselves by experimentation utilizing the various intervention protocols to create new and improved ways to cope with life's many surprises and unprecedented challenges.

FIG. 4G—Personal Commitment to Optimal Wellness and Quantified Well-Being

FIG. 4G is a reproduction of a portion of the typical individualized and personal Super-Health, Optimal Wellness, Quantifiable Well-Being and Ideal Fitness multicolor visual depictions and analysis information showing the participant's ranking on subjective aspects of the 10-Point Quantifiable Well-Being and Scientific Wellness Parameters categorized as the “Self-Reported and Self-Assessed Commitment to Optimal Wellness, Health and Well-Being that is combined with the highlighted suggestions and recommendations that are correlated to this specific updated and improved summary and ranking on the “Self-Assessed” 10-Point Commitment to Optimal Wellness, Health and Well-Being Scales.”

A new and exciting feature that is an integrated part of the follow-up improvement suggestions and intervention protocol strategies of the present invention is the inclusion of customized “Virtual Reality Scientifically Accurate Customized Fun Well-Being and Scientific Wellness Computerized Video (3D) Games that are related to this category” that will allow a participant to become involved in a series of games that uniquely and graphically demonstrate to the viewing participant the probable and/or guaranteed realistic outcomes and the consequences of either self-improvement or self-destructive lifestyle choices specifically related to this parameter. By taking full advantage of the measurements and improvement suggestions and the customized information provided through the “Validated Quantifiable Well-Being and Scientific Wellness Scales” a truly smart individual can self-educate themselves by experimentation utilizing the various intervention protocols to create new and improved ways to cope with life's many surprises and unprecedented challenges. Additionally, participants can learn from the new, exciting, adventurous “Virtual Reality Scientifically Accurate Customized Fun Well-Being and Scientific Wellness Computerized Video (3D) Games” that are a key embodiment of this invention by following the probable scenarios of alternatively choosing apparent positive and/or clearly negative choices in the game's adventures and dramas which then can lead to realistic probable outcomes and consequences. Smart people who take full advantage of this brand new high-tech, self-educational system that was researched, designed and developed by scientifically trained well-being/wellness and longevity experts will ultimately result in many personal well-being and scientific wellness rewards. The beauty of the custom virtual reality self-educational games is that a person can explore realistic life experiences and dramas and their probable outcomes and consequences without any serious, painful or devastating personal well-being and/or scientific wellness damages. Over time, one can learn to improve their own personal well-being and scientific wellness scores to the point that they can share their successes with family, friends and business associates.

Personal Commitment to Optimal Wellness/Health and Well-Being—FIG. 4G

In order to consistently improve your personal 10-Point Quantifiable Well-Being and Scientific Wellness Parameters and achieve your dreams of becoming a super-healthy peak performing human being, you will need to continually monitor and evaluate your commitment to yourself. As you move towards your ideal goals, you may become surprised at the number of excuses that will magically appear in your mind to sabotage your dedication and commitment to the challenging task of improving any of your personal Quantifiable Well-Being and Scientific Wellness Parameters. You may also be shocked at the many negative friends who will attempt to influence you to cheat on your list of things to avoid that can increase your risks and lower your Quantifiable Well-Being and Scientific Wellness Rankings. Then there are the powerful media ads on screens everywhere attempting to sell you their super-processed foods and drinks so you can be socially acceptable in a society full of dumb, ignorant, uninformed addicts, who have little or no concern about their well-being or scientific wellness rankings.

FIGS. 5A-5F—Biological and Physio-Chemistry Lab Tests and Evaluations

### Lab Analyzed Hidden Measurements of Comprehensive Biological and Physio-Chemistry Laboratory Tests and Evaluations Bio-PhysioLabChemistry Well-Being Parameters

FIG. 5A—Biological Physio-Chemistry of Important Blood Lipids Wellness

FIG. 5A is a reproduction of a portion of the typical individualized and personal Super-Health, Optimal Wellness, Quantifiable Well-Being and Ideal Fitness multicolor visual depictions and analysis information showing the participant's ranking on subjective aspects of the 10-Point Quantifiable Well-Being and Scientific Wellness Parameters categorized as the Extremely Important Biological Physio-Chemistry Laboratory Tests and Evaluations Optimal Wellness, Health and Well-Being that is combined with the highlighted recommendations and simple suggestions that are correlated to this specific updated and improved summary and ranking on the “10-Point Regular Extremely Important Biological Physio-Chemistry Laboratory Tests and Evaluations Optimal Wellness, Health and Well-Being.”

A new and exciting feature that is an integrated part of the follow-up improvement suggestions and intervention protocol strategies of the present invention is the inclusion of customized “Virtual Reality Scientifically Accurate Customized Fun Well-Being and Scientific Wellness Computerized Video (3D) Games, related to this category” that allows a participant to become involved in a series of games that uniquely and graphically demonstrate to the viewing participant the probable and/or guaranteed realistic outcomes and consequences of either self-improvement or self-destructive lifestyle choices specifically related to this parameter. By taking full advantage of the measurements and improvement suggestions and the customized information provided through the “Validated Quantifiable Well-Being and Scientific Wellness Scales,” a truly smart individual can self-educate themselves by experimentation utilizing the various intervention protocols to create new and improved ways to cope with life's many surprises and unprecedented challenges. Additionally, participants can learn from the new, exciting, adventurous “Virtual Reality Scientifically Accurate Customized Fun Well-Being and Scientific Wellness Computerized Video (3D) Games” that are a key embodiment of this invention by following the probable scenarios of alternatively choosing apparent positive and/or clearly negative choices in the game's adventures which can then lead to realistic probable outcomes and consequences. Smart people who take full advantage of this brand new high-tech, self-educational system that was researched, designed and developed by scientifically trained well-being/wellness and longevity experts will ultimately result in many personal well-being and scientific wellness rewards. The beauty of the custom virtual reality self-educational games is that a person can explore realistic life experiences and dramas and their probable outcomes and consequences without any serious, painful or devastating personal well-being and/or scientific wellness damages. Over time, one can learn to improve their own personal well-being and scientific wellness scores to the point that they can share their successes with family, friends and business associates.

Biological Physio-Chemistry of Important Blood Lipids for Wellness—FIG. 5A

Simple but accurate one drop lab blood lipid evaluations will measure and track a number of significant indicators of Super-Health, Optimal Wellness, Quantifiable Well-Being and Ideal Fitness. This information is very important data that needs to be monitored and tracked for many improvement protocols, since blood lipid ranges provide quantifiable well-being and scientific wellness experts with valuable information of how healthy a person really is, plus they are accurate indicators of many hidden biological/physio-chemistry indicators of cardiovascular conditions that may lead to certain risk factors. Blood is a very vital fluid that circulates throughout the entire body. A careful observation of lab analyzed ingredients may provide objective indicators of the optimal well-being, super-health and scientific wellness levels of a person as well as any indicators of risk factors. If serious risk factors are present in the lab data, the Quantifiable Well-Being and Scientific Wellness System will alert the individual about the potential risks and suggest some realistic intervention protocols and suggestions to seek care from a competent medical practitioner. The smart people using this Quantifiable Well-Being and Scientific Wellness System will be grateful for the valuable scientifically accurate optimal well-being, super-health and scientific wellness information that is at their fingertips through the “Quantifiable Well-Being Output Reports, Computerized Print Outs, Customized Intervention Protocols, Virtual Reality Scientifically Customized Fun Well-Being and Scientific Wellness Computerized Video (3D) Games and the Suggestions for Improvement that can be accessed via the their smart phones or the Internet. The biological/physio-chemistry of optimal wellness is even more important than the Bio-Physiological Well-Being Assessment Information. The actual one drop samples for the blood tests can be taken anywhere.

Blood Lipids Determine Internal Hidden Levels of Optimal Wellness/Risks—FIG. 5A

In this Blood Lipid Parameter, a careful evaluation is performed on the following: total cholesterol, high density lipoproteins (HDL), low density lipoproteins (LDL), triglycerides, glucose and sugars, proteins, and other ingredients as needed. It is primarily the Cholesterol, Triglycerides, LDLs and the HDLs and their ratios or relationships that determine one's optimal health or risk levels. In an analysis of these ingredients, the primary concern is with the ones which relate to the most important areas of wellness, such as: High-Density Lipoproteins (HDLs), Low-Density Lipoproteins (LDLs), Total Cholesterol, and Triglycerides. The Quantifiable Well-Being and Scientific Wellness System does not ignore high risk levels in these blood lipids, but its main purposes and objectives are (not to identify illness) designed to assist smart people who wish to explore the optimal well-being, super-health and scientific wellness data and related valuable information in order to improve their personal levels of optimal well-being, super-health and scientific wellness. Other Biological Blood Physio-Chemistry Ingredients can be important, but they are not usually related to achieving and maintaining the most important areas of optimal well-being, super-health and scientific wellness, because they do not relate to the number one and two major diseases or mortality factors. Scientific research has shown that “Cholesterol” alone is not a very significant number. Many people are aware of the risks and potential dangers of ultrahigh levels of Cholesterol. Thus this “Cholesterol” Score is vital in objectively measuring levels of stress and tracking achievable levels of optimal wellness, health and fitness. If a person experiences a deep and serious emotional loss of a loved one, their total “Cholesterol” has been known to go over 600 (where the average healthy range is generally between 170 to 180).

Much more important than one's level of Total Cholesterol Measurement are the lab evaluated ratios of Cholesterol to HDL as well as LDL to HDL, because these can significantly correlate to cardiovascular health or disease. Thus, one of the most important laboratory measurements is the Cholesterol to HDL ratio, and the LDL Score, which is healthiest if it is kept under 120 to maintain a Low-Risk Level. The LDL to HDL Ratio is also a very important indicator of either wellness or risk.

The Triglycerides, too, are important because as lipids they are especially important for evaluating and calculating the amount of low density lipids (LDLs) in the blood stream and in monitoring achievable levels of Quantifiable Well-Being and Scientific Wellness, Optimal Health and Ideal Fitness. Triglycerides determine a major portion of the overall risks of cardiovascular dysfunction since they contribute to higher levels of the LDLs. They may also indicate a significant consumption of alcohol and/or sweets. The ratios of total Blood Cholesterol Lipid's in relation to other lipids (LDLs and HDLs) are important to assess for risk or wellness determinations. LDLs, the unwanted lipids, are the dangerous low-density lipids (LDLs) in the blood stream that can cause serious and sudden blockages (occlusions) in the arteries or veins. The “Total Cholesterol to HDL Ratio Scale” is one of the most important numbers to know in predicting and preventing cardiovascular diseases because it reveals the hidden level of risk or wellness in the circulatory system. Often high levels of LDLs and Cholesterol go unnoticed because most people cannot feel escalated levels of these lipids.

FIG. 5B—Optimal Endocrine Health and Total Wellness

FIG. 5B is a reproduction of a portion of the typical individualized and personal Super-Health, Optimal Wellness, Quantifiable Well-Being and Ideal Fitness multicolor visual depictions and analysis information showing the participant's ranking on subjective aspects of the 10-Point Quantifiable Well-Being and Scientific Wellness Parameters categorized as the Optimal Endocrine Health/Wellness and Well-Being that is combined with the highlighted recommendations and simple suggestions that are correlated to this specific updated and improved summary and ranking on the “10-Point Optimal Endocrine Health/Wellness and Well-Being Scales.”

A new and exciting feature that is an integrated part of the follow-up improvement suggestions and intervention protocol strategies of the present invention is the inclusion of customized “Virtual Reality Scientifically Accurate Customized Fun Well-Being and Scientific Wellness Computerized Video (3D) Games, related to this category” that allows a participant to become involved in a series of games that uniquely and graphically demonstrate to the viewing participant the probable and/or guaranteed realistic outcomes and consequences of either self-improvement or self-destructive lifestyle choices specifically related to this parameter. By taking full advantage of the measurements and improvement suggestions and the customized information provided through the “Validated Quantifiable Well-Being and Scientific Wellness Scales,” a truly smart individual can self-educate themselves by experimentation utilizing the various intervention protocols to create new and improved ways to cope with life's many surprises and unprecedented challenges. Additionally, participants can learn from the new, exciting, adventurous “Virtual Reality Scientifically Accurate Customized Fun Well-Being and Scientific Wellness Computerized Video (3D) Games” that are a key embodiment of this invention by following the probable scenarios of alternatively choosing apparent positive and/or clearly negative choices in the game's adventures which can then lead to realistic probable outcomes and consequences. Smart people who take full advantage of this brand new high-tech, self-educational system that was researched, designed and developed by scientifically trained well-being/wellness and longevity experts will ultimately result in many personal well-being and scientific wellness rewards. The beauty of the custom virtual reality self-educational games is that a person can explore realistic life experiences and dramas and their probable outcomes and consequences without any serious, painful or devastating personal well-being and/or scientific wellness damages. Over time, one can learn to improve their own personal well-being and scientific wellness scores to the point that they can share their successes with family, friends and business associates.

Optimal Endocrine Health and Total Wellness—FIG. 5B

Since the turn of the century, wellness researchers have been evaluating the importance, roles and contributions of the human body's Endocrine System to Optimal Health, Wellness and Well-Being. The entire Endocrine System is seriously and negatively affected by many common toxic substances that are now known to be ecological pollutants as “Endocrine Disruptors,” because they are causing unwanted changes to the worlds ecosystem as evidenced by certain forms of DNA mutations of wildlife animals being born with an inability to reproduce, due to missing or inadequate body parts needed for reproduction. DNA disruptors contain toxins that scramble the chromosomes and cause genetic defects in humans, for future generations as well. Another endocrine lab test can identify a genetic defect called CBS or MTFHR. If there are endocrine imbalances, it may be wise to check for ammonia in the blood and have a full panel of genetic tests. There are other important lab tests, like the provocative challenge test for heavy metals (linked to ADD). These are one of the biggest factors for the rising rates in autism, cancers, decreased brain function, autoimmune diseases, chronic inflammation, sterility, behavior problems and all chronic disease states. Unfortunately, these endocrine disrupters can be found as standard ingredients in many personal care products that are widely used by millions of uninformed consumers. Similar endocrine disrupters contribute to air pollution and can be found as ordinary ingredients in many soy products, household and cooking oils, food coloring, pasteurized dairy products, numerous plastics and Teflon cookware. Most people buying these products (made in China and laced with these endocrine disrupter ingredients) are unaware of their negative and disease causing affects in the human body. Over 30 common additives (in highly processed food products) have tested positive as endocrine disrupters.

Anyone interested in reducing future risks from innocent or naive exposure to these subtle endocrine disrupters needs to become more aware of their negative consequences. And for smart individuals wanting to improve their personal levels of Optimal Health, Wellness and Well-Being, it will be necessary to become more aware of the increasing endocrine disrupter problems by increasing one's personal Endocrine Ecology Substance IQ by seriously reading more labels and becoming more alert and self-educated about the risks of blindly consuming or using any foods, household or personal care products containing these toxic endocrine disrupters that cause disease conditions in humans, such as: earlier ages of puberty, breast cancers, low sperm counts, interference with fetus development, severe hormone imbalances, neurotransmitter diseases and/or other negative consequences to the internal terrain. Smart people dedicated to well-being/wellness and longevity will probably want to remove most plastics from their home and not eat any foods which have touched plastic (especially things in plastic bags or containers that have been in a hot car).

An even better but time consuming solution to this nightmare of escalating health risks and associated problems is to eat only organic unprocessed whole foods without any food additives (from a reliable ethical source). It is wise to avoid any cookware with Teflon. Food and cooking oils need to be limited to only coconut oil that is cold processed and organic. All cooking pots need to be of the highest quality, and ones that will not leach any toxins. Other positive suggestions are to make your own natural cleaning products, and store all others in an unattached garage. Adding house plants in your home to get more life enhancing oxygen will improve your air quality and help with detoxification.

FIG. 5C—Vital Blood Glucose Health and Total Wellness

FIG. 5C is a reproduction of a portion of the typical individualized and personal Super-Health, Optimal Wellness, Quantifiable Well-Being and Ideal Fitness multicolor visual depictions and analysis information showing the participant's ranking on subjective aspects of the 10-Point Quantifiable Well-Being and Scientific Wellness Parameters categorized as the Vital Blood Glucose Health and Total Wellness that is combined with the highlighted recommendations and simple suggestions that are correlated to this specific updated and improved summary and ranking on the “10-Point Vital Blood Glucose Health and Total Wellness Scales.”

A new and exciting feature that is an integrated part of the follow-up improvement suggestions and intervention protocol strategies of the present invention is the inclusion of customized “Virtual Reality Scientifically Accurate Customized Fun Well-Being and Scientific Wellness Computerized Video (3D) Games, related to this category” that allows a participant to become involved in a series of games that uniquely and graphically demonstrate to the viewing participant the probable and/or guaranteed realistic outcomes and consequences of either self-improvement or self-destructive lifestyle choices specifically related to this parameter. By taking full advantage of the measurements and improvement suggestions and the customized information provided through the “Validated Quantifiable Well-Being and Scientific Wellness Scales,” a truly smart individual can self-educate themselves by experimentation utilizing the various intervention protocols to create new and improved ways to cope with life's many surprises and unprecedented challenges. Additionally, participants can learn from the new, exciting, adventurous “Virtual Reality Scientifically Accurate Customized Fun Well-Being and Scientific Wellness Computerized Video (3D) Games” that are a key embodiment of this invention by following the probable scenarios of alternatively choosing apparent positive and/or clearly negative choices in the game's adventures which can then lead to realistic probable outcomes and consequences. Smart people who take full advantage of this brand new high-tech, self-educational system that was researched, designed and developed by scientifically trained well-being/wellness and longevity experts will ultimately result in many personal well-being and scientific wellness rewards. The beauty of the custom virtual reality self-educational games is that a person can explore realistic life experiences and dramas and their probable outcomes and consequences without any serious, painful or devastating personal well-being and/or scientific wellness damages. Over time, one can learn to improve their own personal well-being and scientific wellness scores to the point that they can share their successes with family, friends and business associates.

Vital Blood Glucose Health and Total Wellness—FIG. 5C

The demands and pressures of the active modern lifestyles of most functional human beings require enormous amounts of energy (fuel) for optimal functioning. Vital Blood Glucose is one the most important fuels for the body. Due to the high demands for energy needed to perform on a job, many individuals have developed unhealthy eating and drinking habits consuming highly sweetened sodas, gourmet coffees, energy sweets or snacks, and fast or processed foods that are high in sugars or artificial sweeteners. Unfortunately, these survival behaviors have led to increased incidents of hypoglycemic or diabetic conditions. Eating out or consuming standard super-market processed consumables will generally expose even a super-healthy person to increased levels of unwanted blood glucose. One creative solution to this growing challenge is to bring one's own home prepared meals and snacks, so that all the ingredients are known to be organic and non-toxic.

FIG. 5D—Excretory Health and Urine Wellness

FIG. 5D is a reproduction of a portion of the typical individualized and personal Super-Health, Optimal Wellness, Quantifiable Well-Being and Ideal Fitness multicolor visual depictions and analysis information showing the participant's ranking on subjective aspects of the 10-Point Quantifiable Well-Being and Scientific Wellness Parameters categorized as the Saliva and Excretory Health and Urine Wellness that is combined with the highlighted recommendations and simple suggestions that are correlated to this specific updated and improved summary and ranking on the “10-Point Saliva and Excretory Health and Urine Wellness Scales.”

A new and exciting feature that is an integrated part of the follow-up improvement suggestions and intervention protocol strategies of the present invention is the inclusion of customized “Virtual Reality Scientifically Accurate Customized Fun Well-Being and Scientific Wellness Computerized Video (3D) Games, related to this category” that allows a participant to become involved in a series of games that uniquely and graphically demonstrate to the viewing participant the probable and/or guaranteed realistic outcomes and consequences of either self-improvement or self-destructive lifestyle choices specifically related to this parameter. By taking full advantage of the measurements and improvement suggestions and the customized information provided through the “Validated Quantifiable Well-Being and Scientific Wellness Scales,” a truly smart individual can self-educate themselves by experimentation utilizing the various intervention protocols to create new and improved ways to cope with life's many surprises and unprecedented challenges. Additionally, participants can learn from the new, exciting, adventurous “Virtual Reality Scientifically Accurate Customized Fun Well-Being and Scientific Wellness Computerized Video (3D) Games” that are a key embodiment of this invention by following the probable scenarios of alternatively choosing apparent positive and/or clearly negative choices in the game's adventures which can then lead to realistic probable outcomes and consequences. Smart people who take full advantage of this brand new high-tech, self-educational system that was researched, designed and developed by scientifically trained well-being/wellness and longevity experts will ultimately result in many personal well-being and scientific wellness rewards. The beauty of the custom virtual reality self-educational games is that a person can explore realistic life experiences and dramas and their probable outcomes and consequences without any serious, painful or devastating personal well-being and/or scientific wellness damages. Over time, one can learn to improve their own personal well-being and scientific wellness scores to the point that they can share their successes with family, friends and business associates.

Excretory Optimal Health and Urine Wellness—FIG. 5D

Eliminating waste products, heavy metals, toxins, parasites, pathogens and other unwanted substances from the human body is the challenging task of the excretory systems. This is not an easy job, even for a super-healthy individual. Consequently, the super-smart person who is passionately dedicated to achieving and maintaining quantifiable well-being, optimal wellness and longevity will occasionally want to have their urine analyzed by a quality laboratory in order to check for parasites, the presence of infectious pathogens, pesticides, other toxic chemicals or substances, excessive amounts of sugars, unbalanced pH, etc. Urine comes from the excretory system, and its pH, sugars and color reflect the overall health and wellness of the person. Lab evaluations of the pH, sugars and color of a person's urine provide additional important optimal wellness that need to be periodically measured and tracked for a person's level of wellness. For optimal well-being and ideal fitness, the urine should be lab analyzed periodically for sulfites, other sulfur compounds and pesticides.

FIG. 5E—Saliva Hormonal Balances and Total Wellness

FIG. 5E is a reproduction of a portion of the typical individualized and personal Super-Health, Optimal Wellness, Quantifiable Well-Being and Ideal Fitness multicolor visual depictions and analysis information showing the participant's ranking on subjective aspects of the 10-Point Quantifiable Well-Being and Scientific Wellness Parameters categorized as the Hormonal Balances and Total Wellness that is combined with the highlighted recommendations and simple suggestions that are correlated to this specific updated and improved summary and ranking on the “10-Point Hormonal Balances and Total Wellness Scales.”

A new and exciting feature that is an integrated part of the follow-up improvement suggestions and intervention protocol strategies of the present invention is the inclusion of customized “Virtual Reality Scientifically Accurate Customized Fun Well-Being and Scientific Wellness Computerized Video (3D) Games, related to this category” that allows a participant to become involved in a series of games that uniquely and graphically demonstrate to the viewing participant the probable and/or guaranteed realistic outcomes and consequences of either self-improvement or self-destructive lifestyle choices specifically related to this parameter. By taking full advantage of the measurements and improvement suggestions and the customized information provided through the “Validated Quantifiable Well-Being and Scientific Wellness Scales,” a truly smart individual can self-educate themselves by experimentation utilizing the various intervention protocols to create new and improved ways to cope with life's many surprises and unprecedented challenges. Additionally, participants can learn from the new, exciting, adventurous “Virtual Reality Scientifically Accurate Customized Fun Well-Being and Scientific Wellness Computerized Video (3D) Games” that are a key embodiment of this invention by following the probable scenarios of alternatively choosing apparent positive and/or clearly negative choices in the game's adventures which can then lead to realistic probable outcomes and consequences. Smart people who take full advantage of this brand new high-tech, self-educational system that was researched, designed and developed by scientifically trained well-being/wellness and longevity experts will ultimately result in many personal well-being and scientific wellness rewards. The beauty of the custom virtual reality self-educational games is that a person can explore realistic life experiences and dramas and their probable outcomes and consequences without any serious, painful or devastating personal well-being and/or scientific wellness damages. Over time, one can learn to improve their own personal well-being and scientific wellness scores to the point that they can share their successes with family, friends and business associates.

Saliva Hormonal Balances and Total Wellness—FIG. 5E

It is usually difficult for most people to understand the subtle energy indicators of small or minor variations in their hormone levels or to feel significant changes and differences in one's ability to function when the hormones are out of balance. Evaluations of saliva generally offer the best source of information for evaluating hormonal balances. Individuals wishing to optimize their hormonal balances can take advantage of the customized information available through the “Validated Quantifiable Well-Being and Scientific Wellness Scales.” Healthy saliva is also one of the best defense systems in the human organism. When compared to popular (even expensive) commercial antibacterial mouth washes available everywhere, none of them come even close to being a safe non-toxic biocidal (germ killing agent) substance. Many decades ago, longevity experts conducted unpublished (for obvious reasons) ethical research studies comparing the most popular mouth rinses to healthy saliva (Sputum) as bacterial anti-microbial substances. Saliva is produced from glands in the mouth and is an indicator of the optimal health and wellness of the person. There was a significant difference in the speed or kill ratios between the best commercial germ killing products and the healthy saliva. It has been known for a long time, that one of the major normal functions of the “good” bacteria and probiotic organisms includes their feeding on the pathogenic bacteria to slow down and control their population growth. Surprising as it may be, the healthy sputum eliminated all of the pathogenic organisms more than twice as fast as the commercial mouth washes. But there was a significant surprise to the researchers between the two germ killing agents. The mouth rinse killed both good (probiotic organisms) and bad pathogens. This complete genocide (killing) of all micro-organisms left the mouth very vulnerable to the rapid astronomical growth of unwanted bacteria (which can replicate or grow over one million pathogenic organisms in a single day) if there are no “good” bacteria (like healthy saliva, nature's best anti-bacterial agent) present to control their population explosion. Repeated use of the mouth rinses only made the unwanted germ problems worse, because the “good” bacteria in the saliva did not replicate as fast as the pathogenic organisms. In all cases researched, the genocidal actions of the saliva was only targeted at pathogenic organisms. The same research revealed another unexpected surprise. The healthy saliva exhibited unique properties that came to be known as “selective genocide.” None of the “good” or probiotic bacteria when exposed to the healthy sputum were harmed or killed. This phenomenon had some beneficial anti-germ effects for the super-healthy human's mouth ecology. Avoiding the popular commercial germ killing mouth washes, breath fresheners and popular tooth pastes dramatically reduced the super-healthy person's chances of ever experiencing a common cold or flu symptoms.

FIG. 5F—Immuno-vitality and Competency Wellness

FIG. 5F is a reproduction of a portion of the typical individualized and personal Super-Health, Optimal Wellness, Quantifiable Well-Being and Ideal Fitness multicolor visual depictions and analysis information showing the participant's ranking on subjective aspects of the 10-Point Quantifiable Well-Being and Scientific Wellness Parameters categorized as the Immuno-Vitality and Competency Wellness that is combined with the highlighted recommendations and simple suggestions that are correlated to this specific updated and improved summary and ranking on the “10-Point Immuno-Vitality and Competency Wellness Scales.”

A new and exciting feature that is an integrated part of the follow-up improvement suggestions and intervention protocol strategies of the present invention is the inclusion of customized “Virtual Reality Scientifically Accurate Customized Fun Well-Being and Scientific Wellness Computerized Video (3D) Games, related to this category” that allows a participant to become involved in a series of games that uniquely and graphically demonstrate to the viewing participant the probable and/or guaranteed realistic outcomes and consequences of either self-improvement or self-destructive lifestyle choices specifically related to this parameter. By taking full advantage of the measurements and improvement suggestions and the customized information provided through the “Validated Quantifiable Well-Being and Scientific Wellness Scales,” a truly smart individual can self-educate themselves by experimentation utilizing the various intervention protocols to create new and improved ways to cope with life's many surprises and unprecedented challenges. Additionally, participants can learn from the new, exciting, adventurous “Virtual Reality Scientifically Accurate Customized Fun Well-Being and Scientific Wellness Computerized Video (3D) Games” that are a key embodiment of this invention by following the probable scenarios of alternatively choosing apparent positive and/or clearly negative choices in the game's adventures which can then lead to realistic probable outcomes and consequences. Smart people who take full advantage of this brand new high-tech, self-educational system that was researched, designed and developed by scientifically trained well-being/wellness and longevity experts will ultimately result in many personal well-being and scientific wellness rewards. The beauty of the custom virtual reality self-educational games is that a person can explore realistic life experiences and dramas and their probable outcomes and consequences without any serious, painful or devastating personal well-being and/or scientific wellness damages. Over time, one can learn to improve their own personal well-being and scientific wellness scores to the point that they can share their successes with family, friends and business associates.

Total Immune System Vitality, Immunocompetency & NKHT3% Evaluation—FIG. 5F

Around the world, there is a steady increase in modern immune disorders, plus a serious reduction in many individual's “Total Immunocompetency.” This has resulted in an escalation of major risk levels of immune disorders/diseases, cancers, tumors or AIDS. Smart people will appreciate the lab blood analyzes available to them as part of the Super-Health, Optimal Wellness, Quantifiable Well-Being and Ideal Fitness Measurements.

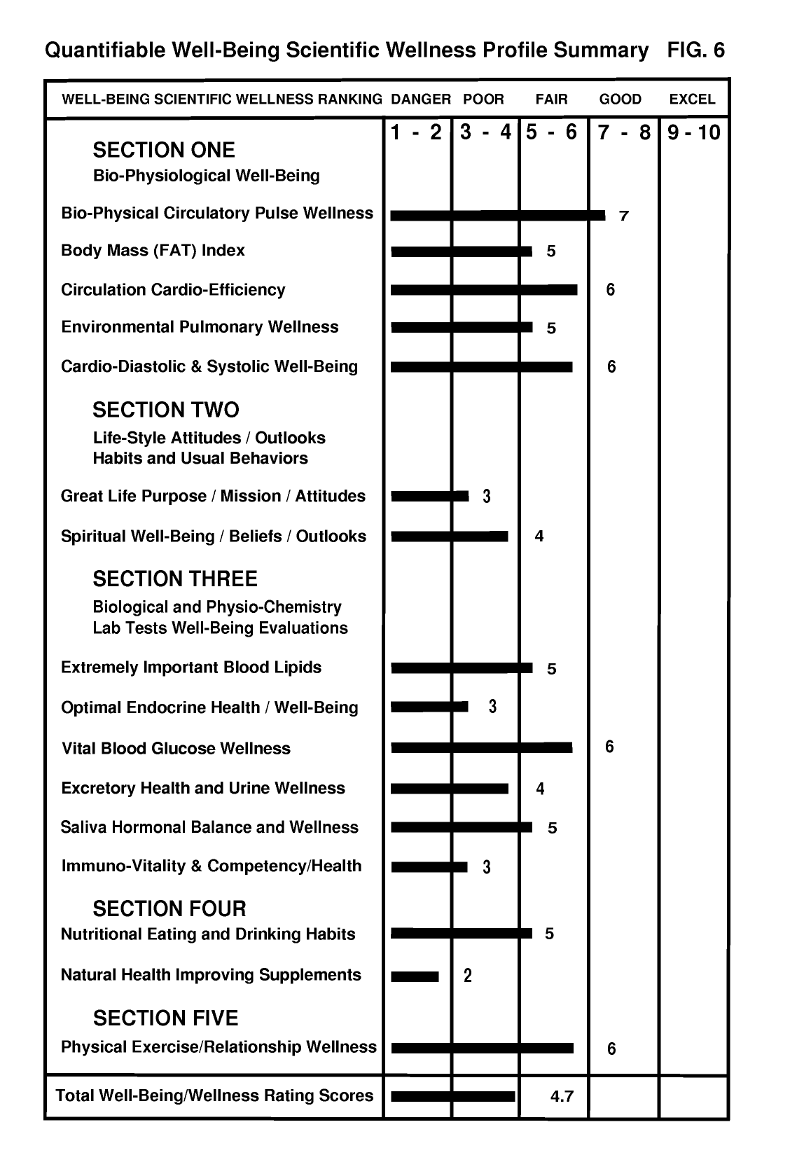

FIG. 6 is a reproduction of an example and portion of the individualized personal 10-Point Quantifiable Well-Being and Scientific Wellness Scales and multicolor summary evaluation and rating chart that graphically depicts on one page all of the ranking of the validated specified ranking 10-Point Scales included in a report. This chart gives participants a summary view of their entire report. It provides the participating person a graphically depicted overview of all the results of the tests and measurements included in the “Output Report and Follow-Up Improvement Suggestions and Intervention Protocols plus Customized Fun Well-Being and Scientific Wellness Computerized Video (3D) Games.”

The invention thus sets forth a comprehensive total well-being and scientific wellness scheme which, if followed by an individual, should result in a longer, optimally healthy and more fulfilling life. Various changes can be made to the invention without departing from the spirit thereof or scope of the following claims.

### BACKGROUND OF THE INVENTION

1. Technical Field

It is a well-known fact that traditional or allopathic medicine is based on a sickness model rather than a wellness paradigm. Most individuals visit their doctor only when they are in desperate need of help. For that reason, health care is generally crisis-oriented. Causative factors are rarely if ever researched or considered important. Symptoms of pain or dysfunction are an indication that something is wrong. Thus doctors are limited and poorly trained to only treat the symptoms, prescribe toxic pills, cut rather than heal or “make whole,” and fix rather than prevent. Too often, major dysfunctions and diseases leading to catastrophic conditions, early aging, serious illness and even death could have been prevented had they been identified before the appearance of devastating symptoms.

The modern fast paced hi-tech lifestyle is riddled by business and environmental stressors, dysfunction, early aging and compromised health. All of the recent politically motivated attempts to fix the escalating costs of the healthcare crises have only increased the problems and the number of ER visits and catastrophic conditions. It is time to confront alarming national health statistics by addressing them scientifically. The first question asked by a reasonable scientist would be, “What caused this symptom or poor health situation?” Translated into terms of wellness, Scientific Wellness professionals ask, “What are the causal factors leading to cardio-vascular diseases, cancers, arteriosclerosis, eating disorders, obesity, diabetes” etc. It seems logical that problems could be solved by exploring their origins. Then and only then can guidelines be established for optimal well-being, scientific wellness and possible prevention. Science has demonstrated, for example, a strong correlation between lung cancer and smoking. Scientific Wellness professionals also explore the reasons why, for example, people wish to continue smoking even when fully aware of the risks and hazards of nicotine poisoning. By addressing causal factors on all levels (mental, spiritual, emotional, physical, attitudinal, etc.) Quantifiable Well-Being and Scientific Wellness Methods can assist individuals in achieving and maintaining optimal health and thus, potentially provide for themselves a more energetic and productive lifestyle. Quantifiable Well-Being, Optimal Scientific Wellness combined with proven prevention systems can provide much earlier detection of diseases.

Today, rapidly increasing health care costs are a serious priority for every business, large or small. It is essential that smart employer's seek a cost effective health care plan. Common tools such as gauges in cars and daily planners are used for managing time, but virtually no tools exist for helping one determine how healthy he or she really is. Many businesses utilize management concepts to control risks in keeping their businesses financially healthy but often ignore the risk management of their most important asset, the optimal health of their key employees.

The current popular “Wellness Movement” dates back to the early 1960s, when America's charismatic president, the honorable John F. Kennedy, spearheaded a global interest and attention on physical and mental fitness. Millions of people around the world became involved in personal and group exercise activities, university sports programs, health food businesses and sports clubs and the international Olympics due to the intrinsic benefits, enhanced physical energy and improved mental functioning that resulted from participating in a variety of fitness and wellness activities. Since then, the focus on wellness and optimal health has steadily increased until recently when it was politically eliminated from most government and private insurance plans.

As a result of many pioneers contributing to the Wellness Movement of the past three decades, today millions are involved in some type of wellness or health improvement program at work, home, the fitness club or elsewhere in their community. The true founders of the Wellness Movement are the numerous health scientists and medical researchers of the past who have searched the world for the keys to quantifiable well-being, optimal wellness, fitness, longevity and healthy-aging. Many of these pioneers spent their lives in search of information and data that would unlock the secrets of achieving and maintaining individual wellness, longevity and an exciting quality life beyond the average life spans.

Some traveled to distant lands to research and experience firsthand the eating and lifestyle habits of native peoples whose average life expectancy was at least 50% longer (with longevity 120 years or more) than the average urban citizen of industrialized communities. In their quest for the modern “Fountain of Youth,” these pioneers have left a legacy of data and information. The advent of the compact personal computer has made it possible to use this data to address many of the questions concerning optimal health and longevity at a much more sophisticated level. Careful examination of this scientifically processed data has created the potential for establishing personal health and fitness guidelines. Thus, for the first time in history, smart people have a scientific method for seeking the Fountain of Youth.

One noteworthy group of optimal health scientists and wellness researchers managed to collectively gather a sizable body of scientifically objective data on the general population beginning in the mid-1970s and continuing into the early 1980s. This group of wellness scientists/researchers consisted of more than 1,000 health care professionals and research scientists (mostly longevity doctors, dentists and university professors) throughout the United States. This research study's first goal was to collectively gather a sizable body of objective physical chemistry data from millions of supportive individuals (looking for super-healthy people totaling over 12,000 measured participants) of all ages who had at least a minimum of ten years or more “completely free” from any form of disease or sickness, including severe headaches, the “Flu” and/or the “Common Cold”. The data from this measured group of optimally healthy living individuals formed the first identifiable markers for measuring optimal wellness and quantifiable well-being.

When an individual was found by any one of the 1,000+ researching team of professionals who met the study's “stringent criteria” for the initial sampling of super-healthy individuals, that person was invited to participate in a series of physiological and laboratory tests and measurements that were carefully designed to measure the physical, mental, emotional and internal parameters of optimal health and body chemistry. This series included a battery of laboratory tests, including: comprehensive blood, sputum (saliva) and urine chemistries, hair analyses, plus a basic set of physiological measurements, viz., blood pressure, height, weight and posture as well as some standard psychological tests. The raw data from this initial group of optimally healthy and well people was collected, collated and entered into the first “Scientific Wellness and Optimal Body Chemistry Data Base” on a large computer by a dedicated team of health professionals, computer scientists and electronic engineers. This monumental wellness study contributed to the first known attempt at the scientific measurement or quantification of “Scientific Wellness and Optimal Health and Body Chemistries.”

Because of the almost impossible base line criteria for this initial “Optimal Health and Body Chemistry” study, it took several years before the first population sampling added up to the target goal of 10,000+ individuals who met the research criteria. Once the initial group of subjects were tested, a carefully selected team of wellness scientists and computer professionals analyzed the raw data and created numerous charts and graphs that established the first hypothetical ranges for optimal body chemistry measurements. The initial set of optimal body chemistry ranges were determined by the statistical means and average deviations from such means of the entire study group of over 10,000 participants.

This team of wellness researchers, health care professionals, computer scientists and electronic engineers next used this set of the optimal body chemistry ranges as the basis of a widespread research project that attempted to improve the less than optimal numbers on millions of eager participants wanting to improve their measured wellness levels. This research continued for almost a decade. Over the years, data was collected on body chemistry measurements of millions of Americans (over 3,115,700). This body of computerized data became known as the “Scientific Wellness and Optimal Body Chemistry Data Base.” Because of the size of the computers needed to study this data and the number of pieces of data collected, only a few professional health or wellness researchers ever had access to this large data base for any type of wellness research studies.

Throughout the 1970s and early 1980s, these wellness researchers, health care professionals, computer scientists and electronic engineers added others to their team with expertise in such fields as: medical research, fitness, biochemistry, nutrition, exercise physiology, psychology, sports physicians and educators. By the early 1980s, this expanded team searched the world for other studies in optimal body chemistry or wellness and was surprised to discover that as yet no one had designed a scientific measuring or quantifying system that could evaluate wellness mathematically or quantify optimal health and body chemistry or fitness against any type of optimal ranking set of scales.

The first known “Measurements of Sports Fitness” had its beginnings in the early 1970′s at the University of California, San Diego (UCSD). At first, a small research team of exercise fitness professionals and physiologists started collecting data on students, faculty, staff and other community sources of adults in order to determine the key physiological parameters and dimensions of fitness. The people in this research study included athletes, sports minded people, fitness fans and individuals seeking a healthier way of life. During these years the physiological and laboratory data collected included such factors as: age, height, weight, smoking, sex, family health history, personal medical history, activity/exercise levels, blood pressures, body (fat) composition, diet, psychological and mental health parameters (MMPI and CPI Categories) factors, other lifestyle habits, exercise (aerobic) heart rates, oxygen utilization, recovery heart rates, pulmonary vital capacity and forced volume, resting and stress (exercise tolerance) ECGs. In addition, a high percentage (over 59% of the participants) had their blood sugars and toxins, blood cholesterol and triglycerides and other lipid chemistries, proteins and liver function measured. Over the years, thousands were tested for their levels of fitness and cardiac risk with these measurements.

At UCSD alone (by 1980), more than 12,400 people were given this battery of comprehensive tests and measurements to determine their cardiovascular fitness and wellness levels as well as major risks factors (if any). Surprisingly, most of these individuals tested (over 63%) were later determined to be “above average to excellent” examples of “optimal physiologically determined health and fitness.” The gender balance for this group was nearly equal. Their demographic data included a wide range of ages, ethnic origins, socioeconomic and educational levels. Many (over 37%) received annual evaluations from four to twelve times during the first decade of this UCSD study so that some comparative trends were possible once the data had been entered into the computer for statistical analyses. The size of the raw data collected at UCSD and elsewhere for more than a decade had grown into the tens of thousands, but it was never evaluated or analyzed for possible correlations of any type until the early 1980s when this data was discovered gathering dust in one of the archival storage lockers on the UCSD campus. Many of the participants in this UCSD fitness study were from other parts of the world and new to the area, having been attracted to the healthier beach and “fitness” lifestyles available along the coasts of California. These population demographic factors meant that the individuals being sampled for this study generally represented a reasonable cross-section of those Americans who were above average in their healthy habits and fitness lifestyles.

This research also included the largest comparative study on body (fat) composition in the U.S. (over 11,000+). Subcutaneous fat tissue was first quantified using the gold standard, viz., the underwater hydrostatic measurements. The same people were then tested by the four-point skinfold caliper measurement system. In both cases, in order to achieve the smallest margins of error, it was important to have all of the tests/measurements taken by well-trained exercise physiologists or health technicians. The results of these two body (fat) composition measuring methods were compared and contrasted for accuracy. In order to establish baseline standards for the comparative study, it was decided that the hydrostatic evaluations would be considered the most accurate of the two measurements, viz., as a base line number for a comparative analysis of the four-point skinfold caliper measurement's relative accuracy to the hydrostatic measurement. When the results of the study were tabulated, the researchers found the four point skin caliper measurements averaged about a 97% accuracy throughout the entire group, but only if these measurements were taken by well trained technicians. This substantially demonstrated that the four fold skin caliper measurement when done by well trained technicians was a reasonably accurate scientific assessment of a person's body (fat) composition. The only exception to this was experienced when measuring the serious obese person who had an excess of 20% over the ideal body fat) composition range. In these cases, the skin fold tests had a slightly higher percent of error.

Another study at UCSD focused on cardiac risk assessment of people who exhibited a wide range of fitness levels. In this study, the following fitness/risk evaluations were included in the original battery of tests and measurements that were administered by the UCSD cardiac researchers. A short cardiac risk questionnaire assessed: (1) both personal and family medical histories, (2) a few personality and psychological factors, (3) dietary habits, (4) exercise levels, (5) smoking, and (6) working and living environment. Technicians took specific physical tests and measurements which included: blood pressures (systolic/diastolic), body (fat) composition, pulmonary forced volume and forced vital capacity, resting heart rate, exercise heart rate, recovery heart rate, oxygen utilization, flexibility and strength, resting ECG, stress ECG (exercise tolerance type), strength test (eliminated after 5 years), in addition to important blood chemical laboratory analyses, which included: total blood cholesterol and triglycerides, HDL, LDL, glucose, proteins and liver function.

The Challenges of Measuring “Quantifiable Well-Being and Scientific Wellness” plus any pending “Health Risks” in the 20th Century

Until the advent of the personal computer and data base management systems for “PCs” in the late 1970s and early 1980s, every attempt to discover, field test, evaluate, quantify and/or predict wellness and/or future health risk factors failed actuarially or mathematically for at least four major reasons.
First. The measurement of such risk factors was extremely limited because they were not measured, correlated, compared or tracked against any optimal health and fitness scales. The absence of identifiable health risks or symptoms never equaled optimal well-being.
Second. All of the HPSs and HRAs were exclusively based on the generally accepted assumption that the absence of most major risks (or their associated risk factors) meant that an individual could be generally classified as low risk or labeled in “EXCELLENT HEALTH.” This proved to be a complete fallacy.
This assumption, however, was initially faulty for two reasons: (a) it was much too simplistic, and, (b) it turned out to be too good to be true. Extensive research later found that many erroneous statements by doctors doing annual physicals and telling people they were in “EXCELLENT HEALTH” occurred when the tests showed an absence of major risk factors or symptoms at that precise moment, where in fact, that person might be a walking time bomb of poor health, (with no apparent symptoms or active conditions requiting immediate medical attention). Since the conventional doctor had only been trained to diagnose and treat illnesses, he or she would never be able to quantify a person based on super-healthy/optimal well-being indicators. It became a sick joke in much of the medical industry, because many of the individuals that had just had a physical exam and were pronounced in “excellent health,” ended up in ER with a major or serious catastrophic disease only a few days or weeks later. A true scientist would likely ask, what could have gone wrong so fast?
Third. All of the risk and medical diagnosing systems and procedures used as background for these annual physicals, HPSs and HRAs were limited to assessing only major SYMPTOMS or active CONDITIONS, but none were designed to discover root causative factors associated with serious sickness, disease or death. The medical health care delivery systems attempted (though unsuccessfully) to correlate these major risk factors to the CDC indexes and the major insurance morbidity and mortality tables. Unfortunately, without a mathematical model of optimal health and wellness, such a correlation would never be possible.
Fourth. In the final analysis, ALL of the standard medical physicals, HPSs and HRAs failed to statistically predict even minor future risk(s) factors and/or claims because they had been correlated only to the CDC data and/or to the insurance “morbidity and mortality tables.” Throughout these years, medical researchers did not attempt to measure optimal health or fitness, since it was assumed that these were equivalent to the absence of active symptoms or diseased conditions.

When the team of wellness and longevity researchers, health care professionals, computer scientists and electronic engineers realized the valuable ideal body chemistry data that had been collected in the 1970s on super-healthy individuals and the raw data on super-fit people collected at UCSD, they decided it was time to combine these sets of data into the first and only Scientific Wellness Data Base. The next step was to design and field test a battery of optimal wellness, quantifiable well-being and ideal fitness measurements that could mathematically and actuarially identify optimally healthy people. Ultimately, these Scientific Wellness tests were designed to measure: (1) achievable wellness, (2) present optimal health and fitness levels, (3) presenting major risk factors, and (4) certain medical precursors to catastrophic types of sickness and/or disease. The original instruments were designed and developed from extensive scientific research coupled with extensive field tests. The scores from the entire battery of Scientific Wellness tests and measurements were also compared with existing health and medical norms, peak performance, optimal levels of total health and fitness, precursors of illness or disease and known risk factors. At first, the battery of tests and measurements were extremely comprehensive, complex (over 68 different types of testing procedures) and expensive to administer. The original purpose behind these tests was to monitor all known factors believed to indicate a high level of health and fitness and peak performance. The tests were first aimed at determining prime cardiovascular fitness and/or potential diseases, thereby predicting one's statistical chances of future heart attacks and/or strokes. Scientific information from state-of-the-art exercise and fitness physiology and cardiac rehabilitation technologies was combined with considerable research in conjunction with these wellness testing systems in order to determine the specific factors that objectively indicate levels of “optimal health and fitness.” Other population groups were measured for their physiological and psychological health and were added to this early collection of data.

2. Descriptions of Prior Art

There are still numerous ineffective health risk potential studies and summaries (HPSs) and health risk appraisal systems (HRAs) that can only quantify up to an “average” numerical score of “5” on the unique well-being and scientific wellness ranking 10-Point Scales. Most of these risk evaluation data bases are based on the standard but very limited 2-Point Evaluation Scales (“Normal” or “Abnormal”) of the conventional “illness industry,” which is completely limited to comparing only the latest risk statistics on death and disease (the standard mortality and morbidity indices) of the government controlled CDC or the updated actuarial tables of the illness oriented insurance industry. These risk only analyzing methods and systems are flawed and extremely poor predictors of catastrophic illnesses because they do not have any comparative data or measurements from “super-healthy living humans” to compare or contrast their data against. By lacking any quantified or validated Well-Being or Scientific Wellness and Optimal Health and Fitness Data, they can only mathematically identify average health and functional individuals who are not in the hospital at this time. By contrast, they rely only on limited risk data (which ignores causative factors and only focuses on active symptom diagnosis and treatment), for their interpretation of pending risks. Consequently, the medical evaluations (such as an illness doctor's physical exam) plus all of the HPSs and HRAs are useless in measuring the ideal high-end parameters of quantifiable well-being, optimal scientific wellness, super-health and/or total fitness. Thus, most medical evaluations are extremely poor at predicting future minor or major health crises, because they cannot measure or track any of the small incremental indicators, changes or deteriorations in a person's potential health risks. Many years ago, one health potential summary (HPS) filed for a patent (invented by Fuller et at., U.S. Pat. No. 4,464,122). However, this invention cannot be compared to the new and improved Quantifiable Well-Being and Scientific Optimal Wellness Method of the present invention. Fuller assesses only a limited number of subjective lifestyle health risk factors and does not include any objective physiological or laboratory health risk factors. Thus Fuller's HPS cannot objectively or scientifically measure, quantify or evaluate the most important optimal well-being, spiritual, psychological, physiological or laboratory wellness parameters, because it has no evaluative abilities, methods or systems, or questionnaires, or data gathering forms, devices, documents, or comparative scientifically validated wellness parameters or data bases. Perhaps this is why this instrument has not been widely used during the last three decades in this technical field.

Related Prior Art and Technologies

The original patented Scientific Wellness Assessment Method, with ranking 10-Point Scales, U.S. Pat. No. 5,692,501 (which has now become prior art to the present invention) alone enables a person with ordinary skills in the art to fully and objectively explore their achievable levels of wellness and optimal health. Consequently, there exists an urgent need for another updated invention that builds on the prior art's successes with new novel innovative unique improved methods for quantifying optimal well-being “mathematically” that utilizes actuarially designed and based scientific wellness apps, evaluations, scales, algorithms and specialized unique customized improvement and intervention protocols. The present invention answers this urgent need. This application and the appended new invention is an updated improvement and continuation of the advanced research and quantification measurements of U.S. Pat. No. 5,692,501, filed Jun. 6, 1995, which is soon to expire. The new revised wellness paradigm, technologies, actuarial algorithms, usefulness and beneficial contributions of the prior art (including the ranking wellness factors of individuals on a series of (10-Point Scales in U.S. Pat. No. 5,692,501) are hereby incorporated by reference in this new, novel, updated, non-obvious, improved, innovative and advanced application.

What is claimed is:

1. A new, improved, updated and more stringent method of preparing a personal validated quantifiable well-being analyzes for an individual using the empirical data and information collected by certified wellness technicians, plus the subjective self-reported information from the individual, both sets of data are then combined with the scientifically objective impartial and unbiased data from a clinically certified laboratory correlated with previously created mathematically and actuarially validated, improved, adjusted and weighted analyzes of data information based on quantifiable well-being, scientific wellness, optimal health and ideal fitness as well as any verified risk-related genetic and/or medical conditions and risk factors (if any) which are integral parts of the continuously and automatically updated databases, the method comprising the steps of:
a. establishing a continually updated list of measurable, quantifiable, correlatable, comparable, validatable, and trackable categories of improved and ever increasingly stringent validated quantifiable well-being parameters and variables of said levels of scientific wellness scales, optimal health and ideal fitness rankings as well as any overall associated and verified medical or preventable health risk-related genetic and/or medical indicators and pertinent information;
b. creating data gathering schemes, quantification criteria and updating procedures, including obtaining testing data from individuals and groups corresponding to specific analyzed levels of validated quantifiable personal well-being, total wellness, optimal health and ideal fitness, and overall associated and verified genetic, medical and/or health related-risks of pre-determined sets or groups of pertinent, validated and correlatable categories, parameters and variables for each said category;
c. utilizing the schemes to gather, combine, analyze, compare and rank the empirical data and tests collected by a certified wellness technician, plus the subjective self-reported information submitted by the individual and the scientifically objective unbiased impartial analyzed lab data, adjusted and weighted mathematically and actuarially validated data including verified laboratory analyzes for each said category, parameter, and variable, and combination of said categories, parameters, and variables;
d. quantifying and compiling the combined empirical technician measurements, the subjective self-reported information from the individual, and the objective impartial scientifically analyzed, adjusted, weighted and verifiable lab data, checking the data for validity, correlating, comparing, updating and storing the quantified, compiled, validated, correlated, compared, updated and stored data as an inventory of validated quantifiable well-being, scientific wellness, optimal health and ideal fitness as well as any associated and verified genetic or medical risk-related knowledge;
e. locally weighting, adjusting and updating the pre-determined optimal ranges of validated quantifiable well-being, scientific wellness, optimal health and ideal fitness, and/or any associated and verified genetic and/or medical risk-related knowledge as well as the standard mean and the standard deviation values of said method; and,
f. preparing simple easy to understand evaluations of said knowledge by comparing, correlating and contrasting the collected knowledge with: (1) ideal pre-determined rankings and optimal ranges of validated quantifiable well-being, scientific wellness, optimal health and ideal fitness, and/or any associated verified genetic and/or medical risk-related knowledge; (2) said validated quantifiable well-being, scientific wellness, optimal health and ideal fitness, and/or any associated and verified genetic and/or medical risk-related knowledge database; and, (3) any previously validated quantifiable well-being, scientific wellness, optimal health and ideal fitness, and/or any associated genetic and/or medical health risk-related knowledge empirically assessed and measured, including any laboratory scientifically objectively analyzed individuals and groups in said database to create a unique series of individualized detailed output reports and visually accented graphs with graduated ranking numerical scales based on actuarially, mathematically, scientifically objective, improved, updated and adjusted data analyzed that continuously and automatically updates the ever increasingly improved and stringent well-being algorithms and scientific wellness research over the past several decades on living super-healthy humans (as defined herein) in order to create the newest customized automatically updated 10-Point Quantifiable Well-Being and Scientific Wellness Scaling and Factoring Formuli which also includes quantifiable evaluations, suggestions for improvement, recommendations and proven protocols for interventions, said reports and follow-up programs having three parts, the first part having a series of visual depictions and rankings each having new and updated increasingly stringent analyzes information (based on updated and revised well-being algorithms and scientific wellness research over the past several decades on “super-healthy individuals”) categorized as:
i. excellent quantifiable well-being and wellness, also known as extremely low-risk;
ii. good quantifiable well-being and wellness, also known as low-risk;
iii. average quantifiable well-being and average health, also known as average risk;
iv. poor quantifiable well-being and poor health, also known as high-risk;
v. dangerous quantifiable well-being and very poor health, also known as extremely high-risk;
g. and, a second part contrasting said knowledge with said database to create a unique series of individualized detailed output reports, improvement educational programs and visually accented graphs with graduated ranking numerical scales based on actuarially, mathematically, scientifically objective, improved, updated and adjusted data analyzes that is used to continuously update the ever increasing stringent well-being algorithms and scientific wellness research over the past several decades on living super-healthy humans (as defined herein), in order to update and revise the unique 10-Point Quantifiable Well-Being and Scientific Wellness Scaling and Factoring Formuli including quantifiable evaluations, complete with suggestions for improvement, recommendations and protocols for interventions, and customized follow-up user friendly educational programs specifically created for each individual's quantifiable personal well-being needs and potentially achievable outcomes and benefits; and,
h. and, a third part comprising of an “Individualized Customized Computer Generated and Updated Fun Enjoyable Challenging Stimulating Virtual Reality Video Game” that allows the individual the opportunity to virtually explore via the customized game with various positive and negative options and choices based upon the individual's own expressed goals and objectives for their life purpose or mission, said game relating directly to the specifically evaluated and analyzed levels of the individual's own unique individualized scientifically measured and quantified “Bio-Physiological Well-Being” parameters including the validated quantifiable personal well-being, total wellness, optimal health and ideal fitness, and overall associated and verified genetic, medical and/or health related-risks.

2. The method according to claim 1 including establishing certain categories for the combined empirical technician measurements, the subjective self-reported information from the individual, and the objective impartial scientifically analyzed, adjusted, weighted and verifiable lab data as scientifically measured and quantified according to the specialized categories of the “Bio-Physiological Well-Being” parameters comprising:
i. “Bio-Physical Circulatory Pulse Wellness,”
ii. “Body Mass (FAT) Index,”
iii. “Circulation Cardio-Efficiency Wellness,”
iv. “Environmental Pulmonary Wellness,” and
v. “Cardio-Diastolic and Systolic Well-Being;”
said categories comprising empirical Bio-Physiological Well-Being measurements of validated quantifiable well-being, scientific wellness, optimal health and ideal fitness as well as any verified genetic and/or medical risk-related conditions and risk factors (if any).

3. The method according to claim 1 including establishing certain certified wellness technician assessed empirical data, plus the individual's self-reported information and the scientifically objective evaluation of body fluids data analyzed by a lab relating to the “Lifestyle Purpose/Mission, Spiritual Well-Being, Attitudes, Outlooks, Habits and Usual Behaviors, Nutritional and Exercise Habits, Plus Nurturing Relationship Wellness and Commitment to Well-Being” categories as mathematically and actuarially assessed, correlated, adjusted quantifiable parameters comprising:
i. “Great Exciting Life Purpose/Mission, Basic Attitudes and Self-Love,”
ii. “Spiritual Well-Being, Core Beliefs and Positive Outlooks,”
iii. “Nutritional Eating and Drinking Habits,”
iv. “Natural Health Improving Supplements,”
v. “Physical Exercise and Relaxational Responsiveness Wellness,”
vii. “Mental/Emotional/Relationships Well-Being,” and
vi. “Commitment to Optimal Well-Being;”
said categories comprising empirical assessed data, self-reported subjective information, and scientifically objective evaluated lab data for associated parameters of validated quantifiable well-being, scientific wellness, optimal health and ideal fitness as well as any verified genetic and/or medical risk-related conditions and risk factors (if any).

4. The method according to claim 1 including establishing empirical technician measurements, the subjective self-reported information from the individual, and the objective impartial scientifically analyzed bio-physiological chemistries of the human organism analyzed by certain laboratory evaluations of the “Biological and Physio-Chemistry Laboratory Tests and Evaluations” of the individual's body fluids objectively, impartially and unbiasedly scientifically assessed, adjusted, weighted and verifiable lab data categories as lab analyzed quantifiable parameters comprising:
i. “Extremely Important Blood Lipid Chemistries,”
ii. “Optimal Endocrine Health and Total Well-Being,”
iii. “Vital Blood Glucose Health and Total Wellness,”
iv. “Excretory Health and Urine Wellness,”
v. “Saliva N Hormonal Balance and Total Wellness,” and
vi. “Immuno-Vitality, Competency Health;”
said categories comprising scientifically objective laboratory information and parameters of quantifiable well-being, scientific wellness, optimal health and ideal fitness as well as any verified genetic and/or medical risk-related conditions or risk factors (if any).

5. The method according to claim 1 including in method step “f” preparing said evaluation in the form of a series of individualized detailed output reports and visually accented graphs (each graph having an associated report) with graduated ranking numerical scales based on the actuarially, mathematically, scientifically objective, improved, updated and adjusted data analyzes that results in continuously updated ever increasingly stringent well-being algorithms and scientific wellness research over the past several decades on living super-healthy humans (as defined herein) which ultimately determines the rankings on the adjusted unique 10-Point Quantifiable Well-Being and Scientific Wellness Scaling and Factoring Formuli in the charts, graphs, customized output programs and reports, individualized follow-up improvement programs and the new “Individualized Customized Computer Generated and Updated Fun Enjoyable Challenging Stimulating Virtual Reality Video Game” which allows the individual an opportunity to safely and realistically explore and experiment in a virtual reality setting the likely outcomes and probable consequences of both positive and negative choices that are related to his/her Quantifiable Well-Being Lifestyle Patterns.

6. The method according to claim 5 for utilizing the series of assessing, measuring, evaluating, quantifying and laboratory analyzing various scientific sets or groups of pertinent, validated, correlated and pre-determined categories, parameters and variables of laboratory information and parameters of validated quantifiable well-being, scientific wellness, optimal health and ideal fitness as well as any verified genetic and/or medical risk-related conditions and risk factors (if any) in order to create individualized detailed output reports, visually accented graphs (each graph having an associated report) with graduated ranking numerical scales based on at least two of a series of assessing, measuring, evaluating and laboratory analyzing of scientific sets or groups of pertinent, validated, correlations and pre-determined categories, parameters and variables of actuarially, mathematically, scientifically objective, improved, updated and adjusted data analyzes which then results in the continual updating and constantly increasing the criteria and stringent algorithms that determine the ranges of the quantifiable well-being and scientific wellness ratings on living super-healthy humans (as defined herein) which ultimately determines the newest rankings on the adjusted unique 10-Point Quantifiable Well-Being and Scientific Wellness Scaling and Factoring Formuli including quantifiable evaluations, plus special follow-up programs with suggestions for improvement, recommendations and protocols for interventions, and unique follow-up user friendly educational programs specifically customized for each individual's quantifiable special personal well-being needs and potentially achievable outcomes and benefits, total wellness, optimal health and ideal fitness, and overall any associated and verified genetic and/or medical risks of at least one of the individuals and/or groups, as well as the new “Individualized Customized Computer Generated and Updated Fun Enjoyable Challenging Stimulating Virtual Reality Video Games,” that allows the individual the opportunity to virtually explore via the customized game a variety of positive and negative options and choices based upon the individual's own expressed goals and objectives for their optimal health, wellness, ideal fitness, life purpose or mission, the method comprising of a:
a. data input means receptive of various testing data (empirical, subjective and scientifically objective) that was collected from a given person corresponding to specific pre-determined sets or groups of pertinent, validated and correlatable categories, parameters and variables of validated quantifiable well-being, scientific wellness, optimal health, ideal fitness as well as any verified genetic and/or medical risk-related bio-physiological conditions and risk factors (if any) for tracking small incremental changes, predicting information and parameters of validated quantifiable well-being, scientific wellness, optimal health and ideal fitness as well as any verified genetic and/or medical risk-related conditions and risk factors (if any);
b. pragmatic means for utilizing the latest high-tech devices for collecting pertinent (empirical, subjective and scientifically objective) data and transmitting it to a processing computer data management center for the invention's computerized analyses. quantifications, interpretations, correlations, rankings, trackings and appropriate improvement suggestions, intervention protocols, follow-up educational programs, and a new customized computer generated virtual reality series of video games, which are then presented back to the participant electronically via the Internet, displayed on a computer screen, smart phone apps, tablet, on printed forms or via a wide variety of other means for the respective categories;
c. scientifically accurate actuarially based means for transforming the empirically measured data, self-reported subjective info and the scientifically objective lab analyzed testing data from each pertinent, validated and correlatable category, parameter and variable to produce transformed data for each category, parameter and variable;
d. realistic means for storing collected data and combining it with transformed data from previous or other reliable sources of data regarding predicting information and parameters of validated quantifiable well-being, scientific wellness, optimal health and ideal fitness as well as any verified genetic and/or medical risk-related conditions and risk factors (if any), and any overall associated medical risks assessment systems for previously measured, assessed, and laboratory analyzed individuals and/or groups;
e. formulated means for determining the optimal ranges (based on the on-going evaluations and objective quantifications of qualifying “Super-Healthy People,” as defined herein) of the rankings and predicting information and the most important and realistic parameters of validated quantifiable well-being, scientific wellness, optimal health and ideal fitness as well as any verified genetic and/or medical risk-related conditions and risk factors (if any), according to standard mean and standard deviation values from the customized computer database in accordance with an actual occurrence of the given outcome for previously measured, assessed and laboratory analyzed individuals and/or groups;
f. custom means for comparing the transformed (empirical, subjective and scientifically objective) data with any pertinent, validated and correlatable categories, parameters and variables of predicting rankings, information and parameters of validated quantifiable well-being, scientific wellness, optimal health and ideal fitness as well as any verified genetic and/or medical risk-related conditions or risk factors (if any), according to the standard mean and the standard deviation values to assess, and measure, and laboratory analyze the likelihood of given outcomes for individuals and/or groups;
g. correlatable means for comparing and correlating the transformed (empirical, subjective and scientifically objective) data with any pertinent, validated and correlatable optimal ranges as well as the standard mean and standard deviation values to measure, assess and laboratory analyze the likelihood of given outcomes for individuals and/or groups; and,
h. practical means for locally updating the (empirical, subjective and scientifically objective) database of said evaluating computer systems with the actual occurrence for the given individuals and/or groups;
i. wherein the means for determining the optimal ranges of predicting information and parameters of validated quantifiable well-being, scientific wellness, optimal health and ideal fitness as well as any verified genetic and/or medical risk-related conditions and risk factors (if any); according to the standard mean and the standard deviation values includes a formulated means for locally weighting, adjusting and ranking (based on the ongoing evaluations of qualifying “Super-Healthy People,” as defined herein) including any of the pre-determined optimal ranges of predicting information and parameters of validated quantifiable well-being, scientific wellness, optimal health and ideal fitness as well as any verified genetic and/or medical risk-related conditions and risk factors (if any); according to the standard mean and the standard deviation values of said customized and computerized data management system for the locally updated (empirical, subjective and scientifically objective) database information, whereby the weighted and adjusted means and the standard deviation values for said system are weighted and adjusted for at least one of a particular individual's and/or a group's set of measured, assessed and laboratory analyzed parameters by said computerized system relative to the pre-determined optimal ranges of predicting well-being rankings and scientific wellness information and parameters of validated quantifiable well-being, scientific wellness, optimal health and ideal fitness as well as any verified genetic and/or medical well as risk-related conditions and risk factors (if any); according to the standard mean and the standard deviation values determined from the database from previous assessments, and/or evaluation methods or systems or other sources of validated quantifiable well-being, scientific wellness, optimal health and ideal fitness as well as any verified genetic and/or medical risk-related conditions and risk factors (if any);
j. and including a means for preparing an evaluation of said (empirical, subjective and scientifically objective) data and knowledge by correlating and comparing said knowledge with (1) ideal pre-determined rankings of validated quantifiable well-being, scientific wellness, optimal health and ideal fitness as well as any verified genetic and/or medical risk-related conditions and risk factors (if any); (2) said scientific wellness validated quantifiable well-being, optimal health and ideal fitness as well as any verified genetic and/or medical risk-related conditions and risk factors (if any) databases; and, (3) any previously scientific validated quantifiable well-being, scientific wellness, optimal health and ideal fitness data as well as any verified genetic and/or associated health or medical risks measured, assessed and laboratory analyzed individuals and groups to create a report which includes (empirical, subjective and scientifically objective) knowledge as well as quantifiable evaluations, suggestions for improvement, recommendations and proven protocols for interventions, said reports and follow-up programs having three parts, the first part having a series of visual depictions and rankings each having new and updated increasingly stringent analyzes information (based on well-being algorithms and scientific wellness research over the past several decades on “super-healthy individuals”) categorized as:
i. excellent quantifiable well-being and wellness, also known as extremely low-risk;
ii. good quantifiable well-being and wellness, also known as low-risk;
iii. average quantifiable well-being and average health, also known as average risk;
iv. poor quantifiable well-being and poor health, also known as high-risk;
v. dangerous quantifiable well-being and very poor health, also known as extremely high-risk;
k. and a second part contrasting said knowledge according to claim 6, further comprising a means for storing pre-determined requirements for scientific validated quantifiable well-being, scientific wellness, optimal health and ideal fitness as well as any verified genetic and/or medical risk-related conditions and risk factors (if any) data comprising the (empirical, subjective and scientifically objective) testing data; all measured, assessed and laboratory analyzed sets or groups of pertinent, validated and correlatable categories, parameters and variables of scientific validated quantifiable well-being, scientific wellness, optimal health and ideal fitness as well as any verified genetic and/or medical risk-related conditions and risk factors (if any); the transformed (empirical, subjective and scientifically objective) data; the weighted and adjusted data; the determined standard mean; the determined standard deviations; and the means for validating and correlating the (empirical, subjective and scientifically objective) data when received, transformed and determined with regard to the pre-determined requirements, rankings and ranges including the means for indicating when the (empirical, subjective and scientifically objective) data does not meet the requirements; and,
l. a third part comprising of an “Individualized Customized Computer Generated and Updated Fun Enjoyable Challenging Stimulating Virtual Reality Video Game” that allows the individual the opportunity to virtually explore via the customized game with various positive and negative options and choices based upon the individual's own expressed goals and objectives for their life purpose or mission, said game relating directly to the specifically evaluated and analyzed levels of the individual's own unique individualized scientifically measured and quantified “Bio-Physiological Well-Being” parameters including the validated quantifiable personal well-being, total wellness, optimal health and ideal fitness, and overall associated and verified genetic, medical and/or health related-risks.

7. The method according to claim 6, further comprising a means for storing pre-determined requirements for scientific validated quantifiable well-being, scientific wellness, optimal health and fitness as well as any verified genetic and/or medical risk-related conditions and risk factors (if any) data comprising the testing data; all assessed, and measured, and laboratory analyzed sets or groups of pertinent, validated and correlatable categories, parameters and variables of scientific validated quantifiable well-being, scientific wellness, optimal health and fitness as well as any verified genetic and/or medical risk-related conditions and risk factors (if any); the transformed data; the weighted and adjusted data; the determined standard means; the determined standard deviations; and the means for validating and correlating the data when received, transformed and determined with regard to the pre-determined requirements, rankings and ranges including the means for indicating when the data does not meet the requirements.

8. The method according to claim 6, including a means for assessing specific sets or groups of pertinent, validated and correlatable categories, parameters and variables of scientific validated quantifiable well-being, scientific wellness, optimal health and total ideal fitness as well as any verified genetic and/or medical risk-related conditions and risk factors (if any), wherein said at least five bio-physiological categories, parameters and variables are selected from the “Bio-Physiological Well-Being” categories, parameters and variables consisting of:
i. “Bio-Physical Circulatory Pulse Wellness,”
ii. “Body Mass (FAT) Index,”
iii. “Circulation Cardio-Efficiency Wellness,”
iv. “Environmental Pulmonary Wellness,” and
v. “Cardio-Diastolic and Systolic Well-Being.”

9. The method according to claim 6, including a means for measuring, assessing and analyzing specific sets or groups of certain pertinent, validated and correlatable “Lifestyle Purpose/Mission, Spiritual Well-Being, Attitudes, Outlooks, Habits and Usual Behaviors, Nutritional and Exercise Habits, Nurturing Relationship Wellness as well as Commitment to Well-Being” categories as mathematically and actuarially assessed categories, parameters and variables of validated quantifiable well-being, scientific wellness, optimal health and ideal fitness as well as any verified genetic and/or medical risk-related conditions and risk factors (if any), wherein said at least seven questionnaire categories, parameters and variables that are selected from a group of self-reporting testing categories, parameters and variables consisting of:
i. “Great Exciting Life Purpose/Mission, Basic Attitudes and Self-Love,”
ii. “Spiritual Well-Being, Core Beliefs and Positive Outlooks,”
iii. “Nutritional Eating and Drinking Habits,”
iv. “Natural Health Improving Supplements,”
v. “Physical Exercise and Relaxational Responsiveness Wellness,”
vi. “Mental/Emotional/Relationships Well-Being,” and
vii. “Commitment to Optimal Well-Being;”

10. The method according to claim 6, including means for objectively analyzing laboratory biochemical body fluids for specific sets or groups of pertinent, validated and correlatable categories, parameters and variables of validated quantifiable well-being, scientific wellness, optimal health and ideal fitness as well as any verified genetic and/or medical risk-related conditions and risk factors (if any), wherein said at least six categories, parameters and variables are selected from the objective laboratory “Biological and Physio-Chemistry Lab Tests and Evaluations” of body fluids lab analyzed categories, parameters and variables consisting of:
i. “Extremely Important Blood Lipid Chemistries,”
ii. “Optimal Endocrine Health and Total Well-Being,”
iii. “Vital Blood Glucose Health and Total Wellness,”
iv. “Excretory Health and Urine Wellness,”
v. “Saliva N Hormonal Balance and Total Wellness,” and
vi. “Immuno-Vitality, Competency Health.”

11. The method according to claim 6, wherein at least two (empirical, subjective and scientifically objective) pertinent, validated and correlatable categories, parameters and variables of quantifiable well-being, scientific wellness, optimal health and ideal fitness as well as any verified genetic and/or medical risk-related conditions and risk factors (if any) are used and further comprising means for correlating the comparisons and correlations of the transformed data for at least two (empirical, subjective and scientifically objective) pertinent, validated and correlatable categories, parameters and variables of validated quantifiable well-being, scientific wellness, optimal health and ideal fitness as well as any verified genetic and/or medical risk-related conditions and risk factors (if any).
